(19) United States
(12) Patent Application Publication
(10) Pub. No.: US 2024/0131477 A1
(43) Pub. Date: Apr. 25, 2024

(54) OXIDATION RESISTANT POLYMERS FOR USE AS ANION EXCHANGE MEMBRANES AND IONOMERS

(71) Applicants: University of Delaware, Newark, DE (US); Versogen, Inc., Wilmington, DE (US)

(72) Inventors: Yushan Yan, Hockessin, DE (US); Keda Hu, Newark, DE (US); Lan Wang, Newark, DE (US); Brian Setzler, Newark, DE (US); Wenjuan Shi, Newark, DE (US); Junhua Wang, Newark, DE (US)

(21) Appl. No.: 18/276,019

(22) PCT Filed: Feb. 4, 2022
(86) PCT No.: PCT/US2022/015189

§ 371 Date: Aug. 4, 2023

Related U.S. Application Data
(60) Provisional application No. 63/145,518, filed on Feb. 4, 2021.

(51) Int. Cl. B01D 71/60; B01D 61/48; C08G 73/02

(52) U.S. Cl. CPC B01D 71/60; B01D 61/48; C08G 73/0273

(57) ABSTRACT

Hydroxide-exchange membranes (HEMs) and hydroxide-exchange ionomers (HEIs) are provided which include polymers with oxidation resistant groups. The attachment of the oxidation resistant groups to the polymer backbone allows fine-tuning of the mechanical properties of the membrane and incorporation of alkaline stable cations, such as imidazoliums, phosphoniums and ammoniums, and provides enhanced stability to the polymer. HEMs/HEIs formed from these polymers exhibit superior chemical stability, anion conductivity, decreased water uptake, good solubility in selected solvents, and improved mechanical properties in an ambient dry state as compared to conventional HEM/HEIs. The HEMs exhibit enhanced stability in a highly oxidative environment.

### GOVERNMENT LICENSE RIGHTS

This invention was partly made with Government support under grant DE-EE0008438 awarded by Office of Energy Efficiency and Renewable Energy of the United States Department of Energy. The Government has certain rights in the invention.

### FIELD OF THE INVENTION

Anion exchange membranes (AEMs) and ionomers (AEIs), possessing excellent oxidation stability are provided for use in anion exchange membrane electrochemical devices including anion exchange membrane fuel cells (AEMFCs), anion exchange membrane electrolyzers (AEMELs) as well as flow batteries. More specifically, hydroxide exchange polymers are provided which are capable of forming hydroxide-exchange membranes (HEMs) and ionomers (HEIs) for use in hydroxide exchange membrane fuel cells (HEMFCs), hydroxide exchange membrane electrolyzer (HEMEL) and hydroxide exchange membrane flow batteries.

### BACKGROUND OF THE INVENTION

Proton exchange membrane fuel cells (PEMFCs) are considered to be clean and efficient power sources. Steele et al., Nature 2001, 414, 345. However, the high cost and unsatisfactory durability of catalysts are major barriers for large-scale commercialization of PEMFCs. Borup et al., Chem Rev 2007, 107, 3904. By switching the polymer electrolyte from an “acidic” condition to a “basic” one, HEMFCs are able to work with non-precious metal catalysts and the catalysts are expected to be more durable. Other cheaper fuel cell components are also possible such as metal bipolar plates. Varcoe, et al., Fuel Cells 2005, 5, 187; Gu et al., Angew Chem Int Edit 2009, 48, 6499; Gu et al., Chem Commun 2013, 49, 131. However, currently available HEMs and HEIs exhibit low alkaline/chemical stability, low hydroxide conductivity, high water uptake, and low mechanical integrity under dry conditions, especially after wet-dry cycles.

The targeted durability for commercial automotive and stationary FC system is 5000 h and 40000 h, and the premature membrane failure are primarily originated from physical and chemical degradation (Walter Merida et al, Journal of Power Sources 2008, 184, 104; Borup et al. Chemical Reviews, 2007, 107, 3904). The chemical degradation, more specifically, the oxidative degradation, involving the hydroxyl and hydroperoxyl radicals is the most challenging problem to FCs and ELs, as these oxidative radicals, generated during the operation of the FCs and ELs, can cause the degradation of the polymers that are believed to be immune to oxidations (M. E. Tisack, et al, J. Power Sources, 2004, 131, 41; R. C. McDonald, et al, ECS Trans. 2006, 1, 199.) It was found that the perfluorinated PEM have much higher oxidative stability comparing with the hydrocarbon-based analogs. (R. C. McDonald, et al, In Handbook of Fuel Cells-Fundamentals, Technology and Application; John Wiley & Sons: New York, 2003; Vol. 3). As a consequence, hydrocarbon-based HEMs/HEIs are more prone to oxidation degradation and new chemistry is highly needed to enhance the oxidation resistance of HEMs/HEIs.

Another concern regarding current HEMs/HEIs is their hydroxide conductivity. In comparison to Nafion, HEMs have intrinsically lower ionic conductivities under similar conditions, because the mobility of OH— is lower than that of H+. Hibbs et al., Chem Mater 2008, 20, 2566. Greater ion-exchange capacity (IEC) is needed for HEMs/HEIs to achieve greater hydroxide conductivity. However, high IEC usually leads to a membrane having high water uptake (i.e., a high swelling ratio), decreasing the morphological stability and mechanical strength of the membrane, especially after repeated wet-dry cycles. This highly swollen state when wet is a major reason for decreased flexibility and brittleness of HEMs when dry. The removal of the trade-off between high hydroxide conductivity and low water uptake has been a major setback in designing high-performance HEMs/HEIs. Pan et al., Energ Environ Sci 2013, 6, 2912. Chemical cross-linking, physical reinforcement, side-chain polymerization, and block-copolymer architecture have been tried to reduce water uptake while maintaining acceptable hydroxide conductivity, but these techniques bring challenging problems, e.g., reduced mechanical flexibility, decreased alkaline stability, and/or increased cost. Gu et al., Chem Commun 2011, 47, 2856; Park et al., Electrochem Solid St 2012, 15, B27; Wang et al., Chemsuschem 2015, 8, 4229; Ran et al., Sci Rep-Uk 2014, 4; Tanaka et al., J Am Chem Soc 2011, 133, 10646. Additionally, almost all side-chain or block-copolymer HEMs are based on flexible aliphatic polymer chains due to limited available synthesis methods. As a result, the membranes still cannot provide morphological stability (low swell ratio) at high IECs and high temperature. Wang et al., Chemsuschem 2015, 8, 4229; Ran et al., Sci Rep-Uk 2014, 4; Marino et al., Chemsuschem 2015, 8, 513; Li et al, M. Macromolecules 2015, 48, 6523.

An additional obstacle to using HEMs is achievement of mechanical flexibility and strength in an ambient dry state. Most HEMs exhibit low mechanical strength and are very brittle in a completely dry state especially after being completely swollen. It is difficult to obtain and handle thin membranes that are large in size as needed for commercial use of HEMs. Without good mechanical properties, the ionomers cannot form and keep an adequate triple phase structure in the fuel cell electrode at high temperature, such as at or above 80° C. Li et al., J Am Chem Soc 2013, 135, 10124.

Another highly desirable feature of an HEI is that the polymer be soluble in a mixture of lower boiling alcohol and water but insoluble in pure alcohol or water so that the HEIs can be readily incorporated into an electrode catalyst layer yet not be dissolved away by water or alcohol.

PEMFCs have recently been deployed as zero-emission power sources in commercially sold automobiles, with demonstrated long driving range and short refueling time, which are two features preferred for customer acceptance. However, PEMFCs use platinum electrocatalysts and are not yet cost competitive with gasoline engines. Major approaches to PEMFC cost reduction include development of low-platinum-loading, high power density membrane electrode assemblies (MEAs), and platinum-group-metal-free (PGM-free) cathode catalysts. A fundamentally different pathway to low-cost fuel cells is to switch from PEMFCs to hydroxide exchange membrane fuel cells (HEMFCs) that, due to their basic operating environment, can work with PGM-free anode and cathode catalysts, and thus are potentially economically viable. To replace PEMFCs, however, HEMFCs have to provide a performance that matches PEMFC's, performance which in turn requires highly active anode and cathode catalysts as well as the highly chemically stable, ionically conductive, and mechanically robust hydroxide exchange membranes (HEMs)/hydroxide exchange ionomers (HEIs) to build an efficient triple phase boundary and thus drastically improve the utilization of the catalyst particles and reduce the internal resistance.

HEMs/HEIs are typically composed of organic cations tethered on a polymer backbone, with OH— being the balancing anion. So far, almost all of HEMs/HEIs are non-fluorinated, bearing hydrocarbon-based cation groups (such as benzyl trimethyl ammonium) and polymer backbones (such as polysulfones), which are of low alkaline/oxidation stability, and as a result HEMFC and HEMEL has durability less than 1000 h (John Varcoe et al, J. Mater. Chem. A, 2018, 6, 15404; B. S. Pivovar, et al. J Electrochem Soc, 2019, 166, 637). Fluorinated HEMs/HEIs are not available so far due to the difficulty and high cost of the synthesis. Herein, a novel approach is provided by tethering oxidation resistant groups (ORGs) covalently to the HEMs/HEIs, which take advantages of the existing HEM/HEIs platforms and allows preservation of the pristine membrane properties to the largest extent. Radical scavengers, such as organic nitroxides are ORGs, known to capture and quench radicals. (Hanns Fischer et al, J Am Chem Soc 2001, 123, 2849; S. R. Powell et al, Proc. Natl. Acad. Sci. U.S.A. 1991, 88, 4680). Once HEM/HEIs are covalently tethered with such radical scavengers, they will be immune to hydroxyl and hydroperoxyl generated in the FCs and ELs to promise a durable HEMFC and HEMEL. Unlike the cerium oxide that are physical mixed and blended in PEMFCs the radical scavengers chemically bonded to the HEMs/HEIs will not be washed out/dissolved during the operation of devices and provide HEMs/HEIs with permanent oxidation resistance. (Vijay Ramani et al, Electrochem. Solid-State Lett, 2008, 11, B113; Fernando H Garzon et al, J. Electrochem. Soc. 2011, 158, B1175). Another approach to enhance the oxidation resistant of HEM/HEI is to physically blend HEM/HEI with ORGs containing small molecules, oligomers and polymers, and optionally the ORGs containing molecules can covalently linked to the HEM/HEIs backbones after blending.

### SUMMARY OF THE INVENTION

A polymer is provided for enhanced oxidative resistance in a first aspect of the invention. The polymer comprises structural units of Formulae (1A_{ORG}) and/or (2A_{ORG}), and at least one structural unit of Formulae (3A), (4A_{ORG}) and (5A_{ORG}), wherein the structural units of Formulae (1A_{ORG}), (2A_{ORG}), (3A), (4A_{ORG}) and (5A_{ORG}) have the structures:

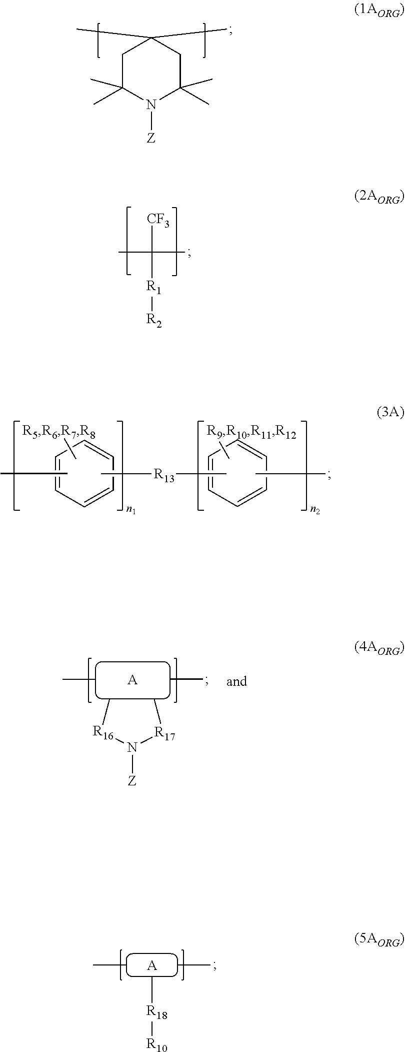

wherein:
A is aryl;
n₁ is 1, 2, 3, or 4;
n₂ is 0, 1, 2, 3 or 4;
R₁, R₁₃, and R₁₈ are each independently alkylene, alkenylene, alkynylene, or arylene, and the alkylene, alkenylene, alkynylene, or arylene are optionally substituted with halide, or R₁₃ is absent;
R₂ and R₁₉ are each independently —NH₂, —NHR₃, —NR₃R₄, —N—O, —N—S or a nitrogen-containing heterocycle wherein a nitrogen of the heterocycle has an oxygen, sulfur or hydrogen substituent;
R₃ and R₄ are each independently alkyl, alkenyl, alkynyl or aryl, and the alkyl, alkenyl, alkynyl or aryl are optionally substituted with halide;
R₅, R₆, R₇, R₈, R₉, R₁₀, R₁₁, and R₁₂ are each independently hydrogen, halide, alkyl, alkenyl, alkynyl or aryl, and the alkyl, alkenyl, alkynyl or aryl are optionally substituted with halide, and wherein R₆ and R₉ are optionally linked to form a five membered ring optionally substituted with halide or alkyl;
R₁₆ and R₁₇ are independently alkylene optionally substituted with halide or alkyl; and
Z is independently hydrogen, hydroxyl, oxygen or sulfur.

Another polymer exhibiting enhanced oxidative resistance is also provided in a second aspect of the invention. The polymer comprises a reaction product of a polymerization mixture comprising:
(i) a piperidone monomer having the formula (1_{ORG}):

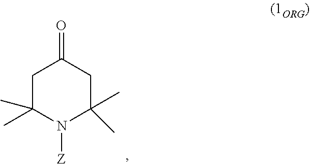

and/or
a trifluoromethyl ketone monomer having the formula (2_{ORG}):

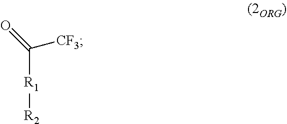

and
(ii) at least one aromatic monomer comprising:
a phenyl-based monomer having the formula (3):

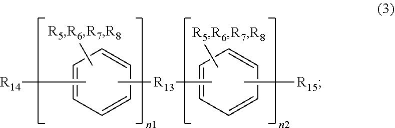

or
a nitrogen heterocycle-aryl monomer having the formula (4_{ORG}):

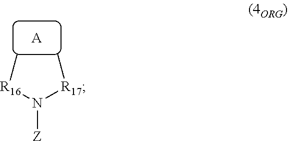

or
an aryl monomer having a nitrogen-containing substituent and having the formula (5_{ORG})

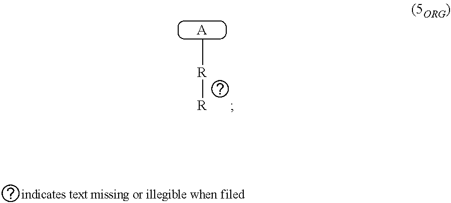

wherein:
A, n₁, n₂, R₁-R₁₃, R₁₆-R₁₉ and Z are as defined above; and
R₁₄ and R₁₅ are each independently hydrogen, halide, alkyl, alkenyl, alkynyl or aryl, and the alkyl, alkenyl, alkynyl or aryl are optionally substituted with halide.

Yet another polymer for providing enhanced oxidative resistance is provided as a third aspect of the invention. The polymer comprises structural units of Formulae (4A_{ORG}) and/or (5A_{ORG}), and at least one of Formulae (1A_{ORG}), (2A_{ORG}), (6A), (7A), (8A) and (9A), wherein the structural units of Formulae (1A_{ORG}), (2A_{ORG}), (4A_{ORG}), (5A_{ORG}), are as described above, and the structural units of Formulae (6A), (7A), (8A) and (9A) have the structures:

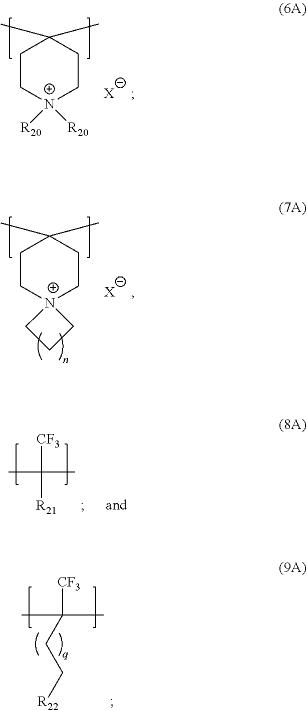

wherein:
A, R₁-R₄, R₁₆-R₁₉ and Z are as defined above;
m is 0, 1, 2, 3, 4, 5, 6, 7, 8, 9, or 10;
n is 1, 2, 3, 4, 5, 6, 7 or 8;
q is 0, 1, 2, 3, 4, 5, 6, 7, 8, 9, 10, 11, 12, 13, 14, 15, 16, 17, 18, 19, or 20;
Q is N or P;
each R₂₀ is independently hydrogen, hydroxyl, halide, alkyl, alkenyl, alkynyl or aryl, and the alkyl, alkenyl, alkynyl or aryl are optionally substituted with halide;
each R₂₁ is independently alkyl, alkenyl, or alkynyl, or a substituent of formula (8A-1):

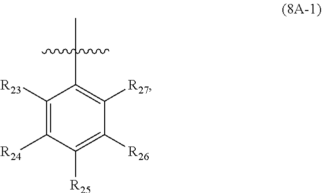

and the alkyl, alkenyl, or alkynyl are optionally substituted with halide;
R₂₂ is a halide, or a quaternary ammonium or phosphonium group or a nitrogen-containing heterocyclic group or a salt thereof, the quaternary ammonium or phosphonium group having the formula (9A-1):

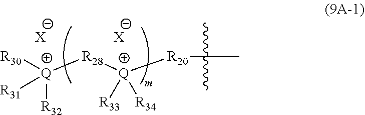

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₃, R₂₄, R₂₅, R₂₆, and R₂₇ are each independently hydrogen, halide, alkyl, alkenyl, alkynyl or aryl, and the alkyl, alkenyl, alkynyl or aryl are optionally substituted with halide;
R₂₈ and R₂₉ are each independently alkylene;
R₃₀, R₃₁, R₃₂, R₃₃, and R₃₄ are each independently alkyl, alkenyl, or alkynyl; and
X⁻ is an anion.

Yet another polymer is provided for enhanced oxidative resistance as a fourth aspect of the invention. The polymer comprises a reaction product of a polymerization mixture comprising:
(i) a nitrogen heterocycle-aryl monomer having the formula (4_{ORG}); and/or
an aryl monomer having a nitrogen-containing substituent and having the formula (5_{ORG}); and
(ii) at least one of the following monomers:
a piperidone monomer having the formula (1_{ORG}) as described above;
a trifluoromethyl ketone monomer having the formula (2_{ORG}) as described above;
a piperidone monomer or salt or hydrate thereof having the formula (6):

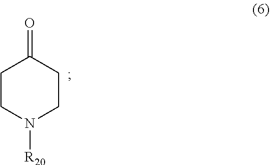

an azoniaspiro salt monomer having the formula (7):

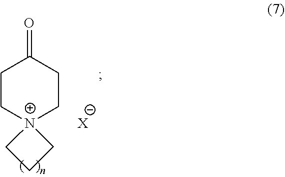

a trifluoromethyl ketone monomer having the formula (8):

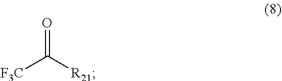

a halogenated trifluoromethyl ketone monomer having the formula (9):

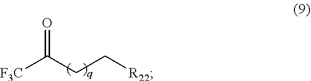

wherein A, m, n, q, Q, R₁-R₄, R₁₆-R₃₄, X⁻ and Z are as defined above.

Another polymer is provided for enhancing oxidative resistance as a fifth aspect of the invention. The polymer comprises structural units of Formulae (6A_{ORG}) and (3A):

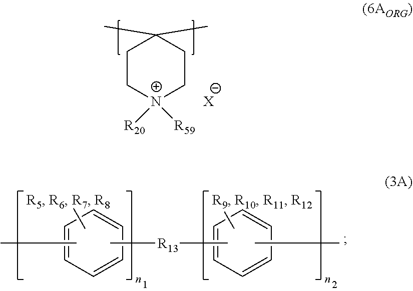

wherein:
n₁, n₂, Q, R₅-R₁₃, R₂₀ and X⁻ are as defined above;
n3 and n5 are each independently 1, 2, 3, 4, 5, 6, 7, 8, 9, or 10;
n4 is 0, 1, 2, 3, 4, 5, 6, 7, 8, 9 or 10;
R₅₉ is —(CH₂)ₙ₃-[Q(R₆₀)(R₆₁)—(CH₂)ₙ₄]ₙ₅-R₆₂ or —[(CH₂)ₙ₃—O]ₙ₅-R₆₂;
R₆₀ and R₆₁ are each independently alkyl, alkenyl or alkynyl; and
R₆₂ is a nitrogen-containing heterocycle wherein a nitrogen of the heterocycle has an oxygen, sulfur or hydrogen substituent.

Another polymer is provided for enhancing oxidative resistance as an eighth aspect of the invention. The polymer comprises a reaction product of a mixture comprising:
(i) a polymer having the formula (10):

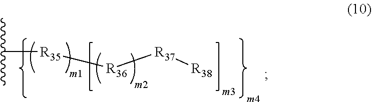

(ii) an oxidation resistant group (ORG)-containing compound having the formula (11_{ORG}).

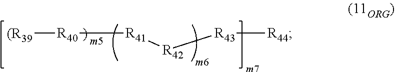

wherein:
[symbol] represents a polymer backbone comprising at least one polyaryletherketone (PAEK) derivative, polysulfone (PSU) derivative, polystyrene (PS) derivative, poly(p-phenylene oxide) derivative, styrene-ethylene-butylene-styrene(SEBS) derivative, polyethylene derivative, poly(norbornene) derivative, or poly(aryl alkylene) derivative structural unit;
m1, m2, and m6 are each independently 0, 1, 2, 3, 4, 5, 6, 7, 8, 9, 10, 11 or 12;
m3, m4, m5, and m7 are each independently 0, 1, 2, 3, or 4;
R₃₅, R₃₆, R₃₇, R₄₀, R₄₁, R₄₂, and R₄₃ are each independently alkylene, arylene, alkenylene, alkynylene, ether, thioether, keto, amino, ammonium, or piperidinyl, and the alkylene, arylene, alkenylene or alkynylene are optionally substituted with halide;
R₃₈ is halide, mesylate, tosylate, azide, alkenyl, alkynyl and R₃₉ is an amine, a phosphine, thiol, hydroxyl, alkenyl or alkynyl; or R₃₈ is an amine, a phosphine, thiol, hydroxyl, alkenyl or alkynyl and R₃₉ is halide, mesylate, tosylate, azide, alkenyl, or alkynyl;
R₄₄ is —NH₂, —NHR₄₅, —NR₄₅R₄₆, —N—O, —N—S or a nitrogen-containing heterocycle wherein a nitrogen of the heterocycle has an oxygen, sulfur or hydrogen substituent;
R₄₅ and R₄₆ are each independently alkyl, alkenyl, alkynyl or aryl, and the alkyl, alkenyl, alkynyl or aryl are optionally substituted with halide; and
the PAEK derivative structural unit has the formula:

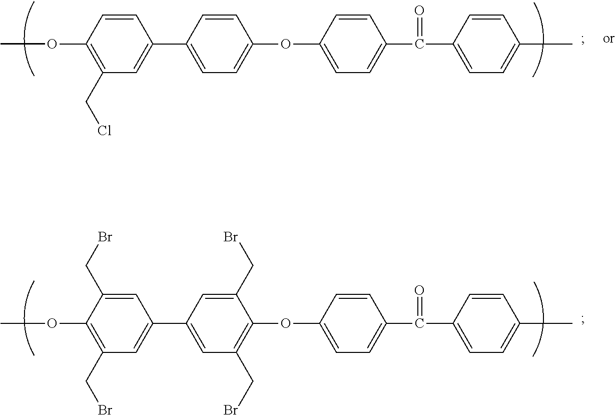

the PSU derivative structural unit has the formula:

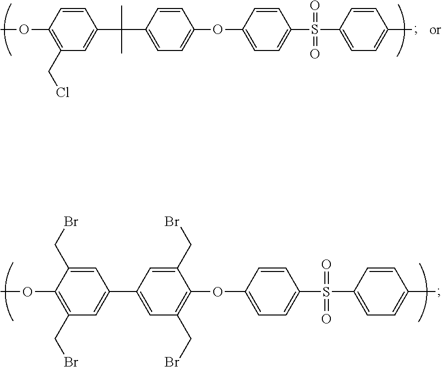

the PS derivative structural unit has the formula:

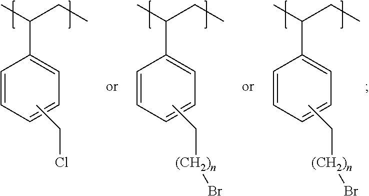

the poly(p-phenylene oxide) derivative structural unit has the formula:

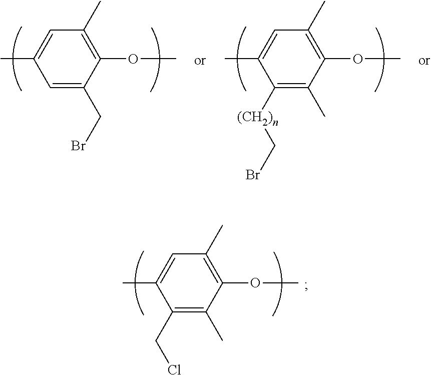

the SEBS derivative structural unit has the formula:

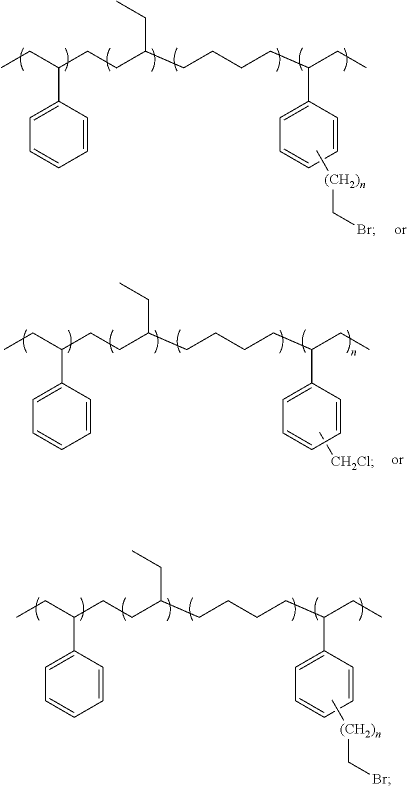

the polyethylene derivative structural unit has the formula:

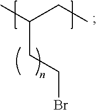

the poly(norbornene) derivative structural unit has the formula:

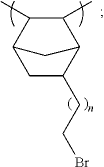

and
the poly(aryl alkylene) structural unit has the formula:

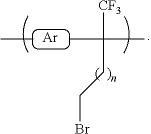

Yet another polymer is provided for enhancing oxidative resistance as a ninth aspect of the invention. The polymer comprises a product of a mixture comprising:
(i) a polymer having a backbone including a nitrogen-containing heterocyclic ring or a nitrogen-containing heterocyclic ring attached to aryl or a heterocycle; or
   a polymer comprising at least two of the structural units of Formulae (3A), (6A), (7A), (8A) and (9A) as described above wherein m, n, n1, n2, n3, n4, n5, q, Q, R₅-R₁₃, R₂₀-R₃₄, and X⁻ are as defined above; and
(ii) an ORG-containing compound having the formula (12_{ORG}):

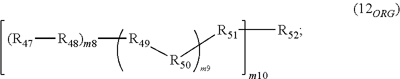

wherein
m8 and m10 are each independently 0, 1, 2, 3, or 4;
m9 is each independently 0, 1, 2, 3, 4, 5, 6, 7, 8, 9, 10, 11 or 12;
R₄₇ is halide, mesylate, tosylate, azide, alkenyl, or alkynyl;
R₄₈, R₄₉, R₅₀, and R₅₁ are each independently alkylene, arylene, alkenylene, alkynylene, ether, thioether, keto, amino, ammonium, or piperidinyl, and the alkylene, arylene, alkenylene or alkynylene are optionally substituted with halide;
R₅₂ is —NH₂, —NHR₅₃, —NR₅₃R₅₄, —N—O, —N—S or a nitrogen-containing heterocycle wherein a nitrogen of the heterocycle has an oxygen, sulfur or hydrogen substituent; and
R₅₃ and R₅₄ are each independently alkyl, alkenyl, alkynyl or aryl, and the alkyl, alkenyl, alkynyl or aryl are optionally substituted with halide.

Other objects and features will be in part apparent and in part pointed out hereinafter.

### BRIEF DESCRIPTION OF THE DRAWINGS

FIG. 1A illustrates an exemplary hydroxide exchange membrane fuel cell.

FIG. 1B illustrates an exemplary hydroxide exchange membrane electrolyzer.

FIG. 2 depicts a 1H NMR spectrum of MQN-TMPH in CDCl₃.

FIG. 3 depicts a 1H NMR spectrum of PAP-MQN-TMPH in DMSO-d6.

FIG. 4 depicts PAP-MQN-TMPH water up-take comparing to PAP-TP-85 and PAP-MQN.

FIG. 5 depicts PAP-MQN-TMPH swelling ratio comparing to PAP-TP-85 and PAP-MQN.

FIG. 6 depicts DMA of PAP-MQN-TMPH.

FIG. 7A depicts PAP-MQN-TMPH through plane conductivity in HCO3- form and Cl— form.

FIG. 7B depicts HNMR of PAP-MQN after soaking for 72 h in Fenton's reagent.

FIG. 7C depicts HNMR of PAP-MQN-TMPH before test and after soaking for 72 h in Fenton's reagent.

FIG. 7D depicts H NMR of TP85 after soaking in Fenton's reagent.

FIGS. 8 and 9 depict H NMR of S6 in CDCl₃ and PFu-BP-C2-50 in DMSO, respectively.

FIG. 10A depicts membranes PPO-C2-TEMPO and PPO-TMA after soaking for 65 h in Fenton's reagent.

FIG. 10B depicts water uptake of PFu-TEMPO-40 and PFu-TEMPO-50 after soaking in Fenton's reagent.

FIG. 10C depicts conductivity of PFu-TEMPO-40 and PFu-TEMPO-50 after soaking in Fenton's reagent.

FIGS. 10D, 11 and 12 depict H NMR of PPO-C2-TEMPO, PATF-TP-Br in CDCl₃, and PATF-TP-C2-TEMPO-0.9 in DMSO-d6, respectively.

### DESCRIPTION OF THE PREFERRED EMBODIMENTS

HEMs/HEIs polymers with ORGs and having intrinsic hydroxide conduction channels have been discovered which simultaneously provide improved chemical stability, conductivity, water uptake, good solubility in selected solvents, mechanical properties, and other attributes relevant to HEM/HEI performance. The attachment of the ORGs to the polymer backbone allows fine tuning of the mechanical properties of the membrane and incorporation of alkaline stable cations, such as imidazoliums, phosphoniums and ammoniums, and provides enhanced stability to the polymer.

HEMs/HEIs formed from these polymers exhibit superior chemical stability, anion conductivity, decreased water uptake, good solubility in selected solvents, and improved mechanical properties in an ambient dry state as compared to conventional HEM/HEIs.

The inventive HEMs exhibit enhanced stability in a highly oxidative environment.

As a first aspect of the invention, a polymer is provided for enhanced oxidative resistance. The polymer comprises structural units of Formulae (1A_{ORG}) and/or (2A_{ORG}), and at least one structural unit of Formulae (3A), (4A_{ORG}) and (5A_{ORG}), wherein the structural units of Formulae (1A_{ORG}), (2A_{ORG}), (3A), (4A_{ORG}) and (5A_{ORG}) have the structures as described above wherein A, n₁, n₂, R₁-R₁₃, R₁₆-R₁₉ and Z are as defined above.

The sum of the mole fractions of the structural units of Formulae (1A_{ORG}) and (2A_{ORG}) in the polymer can be about equal to the sum of the mole fractions of structural units of Formulae (3A), (4A_{ORG}), and (5A_{ORG}) in the polymer, and the sum of the mole fractions of the structural units of Formulae (1A_{ORG}) and (2A_{ORG}) in the polymer to the sum of the mole fractions of the structural units of Formulae (3A), (4A_{ORG}) and (5A_{ORG}) in the polymer can be from about 0.01 to 1.

The mole ratio of a sum of mole fractions of the structural units of Formulae (1A_{ORG}) and (2A_{ORG}) to the sum of mole fractions of the structural units of Formulae (3A), (4A_{ORG}), and (5A_{ORG}) in the polymer can be from about 0.95:1 to about 1.4:1, and the ratio of the sum of the mole fractions of the structural unit of Formulae (1A_{ORG}) and (2A_{ORG}) to the sum of the mole fractions of the structural unit of Formulae (3A), (4A_{ORG}), and (5A_{ORG}) can be from about 0.01 to 1.

The mole ratio of a sum of mole fractions of the structural units of Formulae (1A_{ORG}) and (2A_{ORG}) to the sum of mole fractions of the structural units of Formulae (3A), (4A_{ORG}), and (5A_{ORG}) in the polymer can be from about 1:1 to about 1.2:1.

The structural unit (2A_{ORG}) can have the formula:

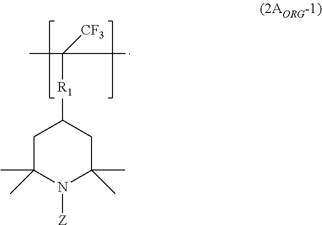

For example, (2A_{ORG}) can be any of the structural units:

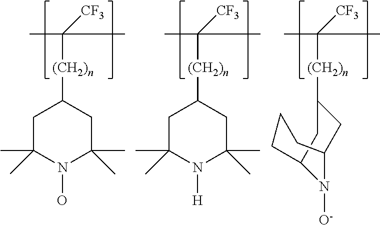

wherein n is 1-12.

In structural unit (3A) when R₁₃ is an alkyl, examples of representative structural units include:

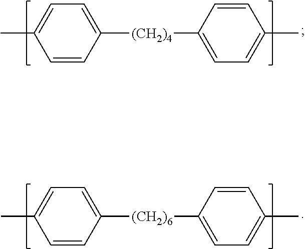

The structural unit (4A_{ORG}) can comprise a structural unit having the formula (4A_{ORG}-1) and/or (4A_{ORG}-2) and/or (4A_{ORG}-3)

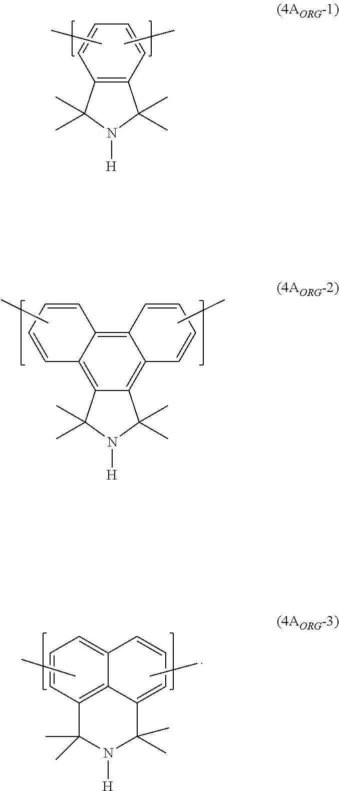

Below are examples of (4A_{ORG}) structural units

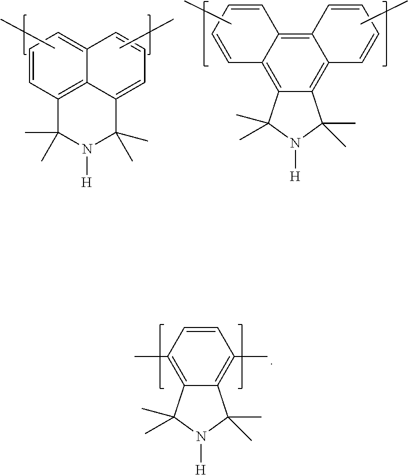

The polymer can further comprise at least one of the structural units (6A), (7A), (8A) or (9A) as described above wherein: m, n, q, Q, R₂₀-R₃₄ and X⁻ are as defined above.

One example of structural unit (7A) is:

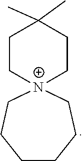

As a further aspect of the invention, any structural unit (3A), (6A), (7A), (8A) and/or (9A) as described above can be modified with any ORG group as described herein. Example 19 is an example of such modification of structural unit (9A).

Below is an example of a (3A) structural unit that has been modified to include an ORG substituent:

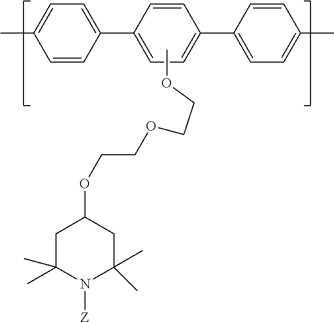

wherein Z is hydrogen, oxygen or sulfur.

Preferably, X⁻ anion in any of the structural units, monomers, or polymers described herein comprises a halide, BF₄⁻, PF₆⁻, CO₃²⁻ or HCO₃.

The nitrogen-containing heterocyclic group or nitrogen-containing heterocycle in any of the structural units, monomers, or polymers described herein can be an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl.

The nitrogen-containing heterocyclic group can be unsaturated such as pyrrole, pyrroline, pyrazole, pyrazoline, imidazole, imidazoline, triazole, pyridine, triazine, pyrazine, pyridazine, pyrimidine, azepine, or quinoline, and any substitutable position of the heterocycle can be substituted independently with alkyl (e.g., methyl, ethyl, propyl, n-butyl) or aryl groups (e.g., phenyl with alkyl substituents).

Alternatively, the nitrogen-containing heterocycle can be saturated. For example, the nitrogen-containing heterocycle can be 2, 2, 6, 6-tetramethylpiperidine.

The nitrogen-containing heterocyclic group can comprise an imidazolium having the formula (9A-2):

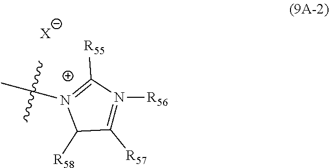

wherein: R₅₅, R₅₆, R₅₇ and R₅₈ are each independently hydrogen, halide, alkyl, alkenyl, alkynyl or aryl, and the alkyl, alkenyl, alkynyl or aryl are optionally substituted with halide and X⁻ is as described above. Preferably, R₅₅ is 2, 4, 6-alkylphenyl, and R₅₆, R₅₇ and R₅₈ are each independently C₁-C₆ alkyl. An example of an imidazole as the nitrogen-containing heterocycle is 1-butyl-2-mesityl-4, 5-dimethyl-1H-imidazole-imidazole which has the formula:

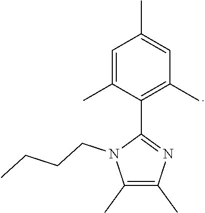 [SMILES: CCCCn1c(-c2c(C)cc(C)cc2C)nc(C)c1C]

As a second aspect of the invention, a polymer exhibiting enhanced oxidative resistance is also provided. Whereas the polymer of the first aspect of the invention is defined in terms of structural units within the polymer, the polymer of the second aspect of the invention defines the polymer in terms of the monomers used in making the polymer. The polymer comprises a reaction product of a polymerization mixture comprising:
(i) a piperidone monomer having the formula (1_{ORG}) as described above; and/or
a trifluoromethyl ketone monomer having the formula (2_{ORG}); and
(ii) at least one aromatic monomer comprising: a phenyl-based monomer having the formula (3); a nitrogen heterocycle-aryl monomer having the formula (4_{ORG}); or an aryl monomer having a nitrogen-containing substituent and having the formula (5_{ORG}) wherein A, n₁, n₂, R₁-R₁₉ and Z are as defined above.

The trifluoromethyl ketone monomer (2_{ORG}) can have the formula (2_{ORG}-1):

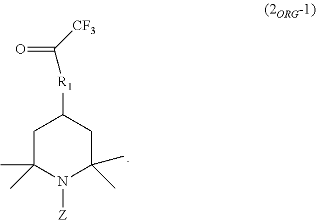

The nitrogen heterocycle-aryl monomer (4_{ORG}) can comprise an isoindoline monomer having the formula (4_{ORG}-1).

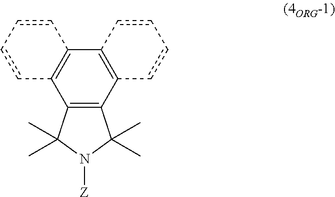

wherein the dibenzo rings are optionally present and Z is as described above.

The nitrogen heterocycle-aryl monomer (4_{ORG}) can comprise a benzo[de]isoquinoline monomer having the formula (4_{ORG}-2).

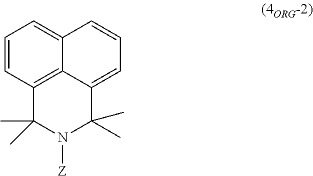

wherein Z is as described above.

Examples of (4_{ORG}) monomers are provided below:

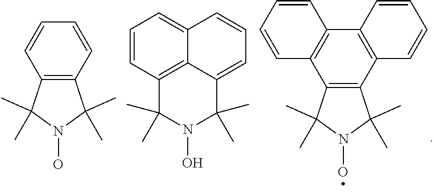

The polymerization mixture can further comprise at least one of the following monomers: a piperidone monomer or salt or hydrate thereof having the formula (6); an azoniaspiro salt monomer having the formula (7); a trifluoromethyl ketone monomer having the formula (8); or a halogenated trifluoromethyl ketone monomer having the formula (9), all as described above.

Any structural unit (3), (6), (7), (8) and/or (9) can be modified with any ORG group as described herein.

An example of a (3) monomer modified to be a (3_{ORG}) monomer is provided

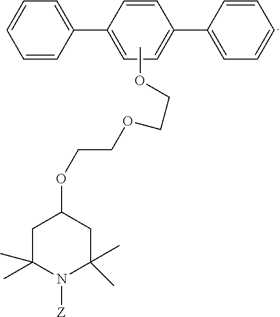

As a third aspect of the invention, a polymer for providing enhanced oxidative resistance is provided. The polymer comprises structural units of Formulae (4A_{ORG}) and/or (5A_{ORG}), and at least one of Formulae (1A_{ORG}), (2A_{ORG}), (6A), (7A), (8A) and (9A), wherein the structural units of Formulae (1A_{ORG}), (2A_{ORG}), (4A_{ORG}), (5A_{ORG}), (6A), (7A), (8A) and (9A) have the structures as described above wherein A, m, n, q, Q, R₁-R₄, R₁₆-R₃₄, X⁻ and Z are as defined above.

The sum of the mole fractions of the structural units of Formulae (1A_{ORG}), (2A_{ORG}), (6A), (7A), (8A) and (9A) in the polymer can be about equal to the sum of the mole fractions of structural units of Formulae (4A_{ORG}) and (5A_{ORG}) in the polymer, and the sum of the mole fractions of the structural units of Formulae (1A_{ORG}), (2A_{ORG}), (6A), (7A), (8A) and (9A) in the polymer to the sum of the mole fractions of the structural units of Formulae (4A_{ORG}) and (5A_{ORG}) in the polymer can be from about 0.01 to 1.

The mole ratio of a sum of mole fractions of the structural units of Formulae (1A_{ORG}), (2A_{ORG}), (6A), (7A), (8A) and (9A) to the sum of mole fractions of the structural units of Formulae (4A_{ORG}) and (5A_{ORG}) in the polymer can be from about 0.95:1 to about 1.4:1, and the ratio of the sum of the mole fractions of the structural unit of Formulae (1A_{ORG}), (2A_{ORG}), (6A), (7A), (8A) and (9A) to the sum of the mole fractions of the structural unit of Formulae (4A_{ORG}) and (5A_{ORG}) can be from about 0.01 to 1.

The mole ratio of a sum of mole fractions of the structural units of Formulae (1A_{ORG}), (2A_{ORG}), (6A), (7A), (8A) and (9A) to the sum of mole fractions of the structural units of Formulae (4A_{ORG}) and (5A_{ORG}) in the polymer can be from about 1:1 to about 1.2:1.

The structural unit (2A_{ORG}) can have the formula (2A_{ORG}-1) as described above.

The structural unit (4A_{ORG}) can comprise a structural unit having the formula (4A_{ORG}-1), (4A_{ORG}-2) or (4A_{ORG}-3) as described above.

The polymer can further comprise structural units of Formula (3A) as described above. Example of (3) monomers are:

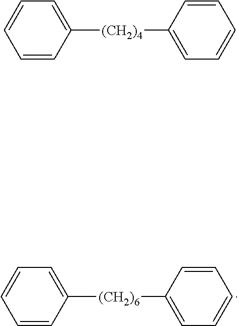

As a fourth aspect of the invention, a polymer is provided for enhanced oxidative resistance. Whereas the polymer of the third aspect of the invention is defined in terms of structural units within the polymer, the polymer of the fourth aspect of the invention defines the polymer in terms of the monomers used in making the polymer. The polymer comprises a reaction product of a polymerization mixture comprising:
(i) a nitrogen heterocycle-aryl monomer having the formula (4_{ORG}); and/or
an aryl monomer having a nitrogen-containing substituent and having the formula (5_{ORG}); and
(ii) at least one of the following monomers:
a piperidone monomer having the formula (1_{ORG});
a trifluoromethyl ketone monomer having the formula (2_{ORG});
a piperidone monomer or salt or hydrate thereof having the formula (6);
an azoniaspiro salt monomer having the formula (7);
a trifluoromethyl ketone monomer having the formula (8); or
a halogenated trifluoromethyl ketone monomer having the formula (9);
   wherein A, m, n, q, Q, R₁-R₄, R₁₆-R₃₄, X⁻ and Z are as defined above.

The trifluoromethyl ketone monomer (2_{ORG}) can have the formula (2_{ORG}-1) as shown above.

The nitrogen heterocycle-aryl monomer (4_{ORG}) can comprise an isoindoline monomer having the formula (4_{ORG}-1) or a benzo[de]isoquinoline monomer having the formula (4_{ORG}-2) or the monomer having the formula (4_{ORG}-3) as shown above.

The polymer can further comprise a phenyl-based monomer having the formula (3) as described above wherein n₁, n₂, and R₅-R₁₅ are as defined above.

As a fifth aspect of the invention, a polymer is provided for enhanced oxidative resistance. The polymer comprises a structural unit of Formula (6A_{ORG}), which is Formula (6A) that has been further modified to include an ORG substituent, and a structural unit of Formulae (3A) as described above wherein n₁, n₂, n3, n4, n5, Q, R₅-R₁₃, R₂₀, R₅₉-R₆₂ and X⁻ are as defined above. Examples 1 and 13-15 include polymers of the fifth aspect of the invention.

R₅₉ can be an ORG substituent such as a hexenyl TMPH ether, MQN-TMPH, or MQN-TMPH-C2 group.

The polymer of the fifth aspect of the invention can further comprise at least one of the structural units having the formula (1A_{ORG}), (2A_{ORG}), (4A_{ORG}), (5A_{ORG}), (6A), (7A), (8A) or (9A).

A sixth aspect of the invention is a polymer which comprises a reaction product of any one of the polymers as described above in the first, second, third, fourth, or fifth aspects of the invention which includes a structural unit (6A) and/or (9A) (or a monomer (6) and/or (9) as a starting material) and a quaternizing agent.

The quaternizing agent can comprise a trialkylamine such as trimethylamine, or an MQN compound such as MQN-TMPH or MQN-TMPH-C2 which have the formulae:

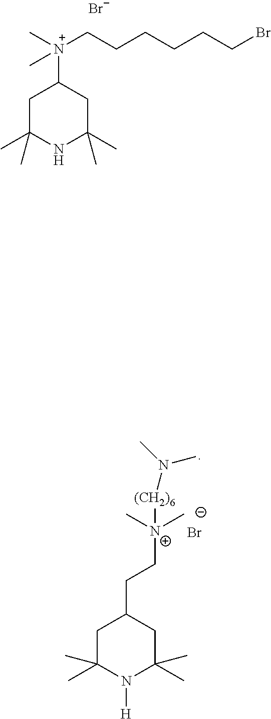

Examples 2, 4, 6, 8, 10 and 12 include polymers of the sixth aspect of the invention.

A seventh aspect of the invention is an anion exchange polymer which comprises a reaction product of the quaternized polymer of the sixth aspect of the invention and a base. Examples 2, 4, 6, 8, 10 and 12 include polymers of the seventh aspect of the invention.

Preferably, the base comprises an hydroxide-containing base such as sodium hydroxide or potassium hydroxide; a bicarbonate-containing base such as sodium bicarbonate or potassium bicarbonate; or a carbonate-containing base such as sodium carbonate or potassium carbonate.

Representative anion exchange polymers of the seventh aspect of the invention include the following wherein x is 0.01 to 1, y is 0.01 to 1:

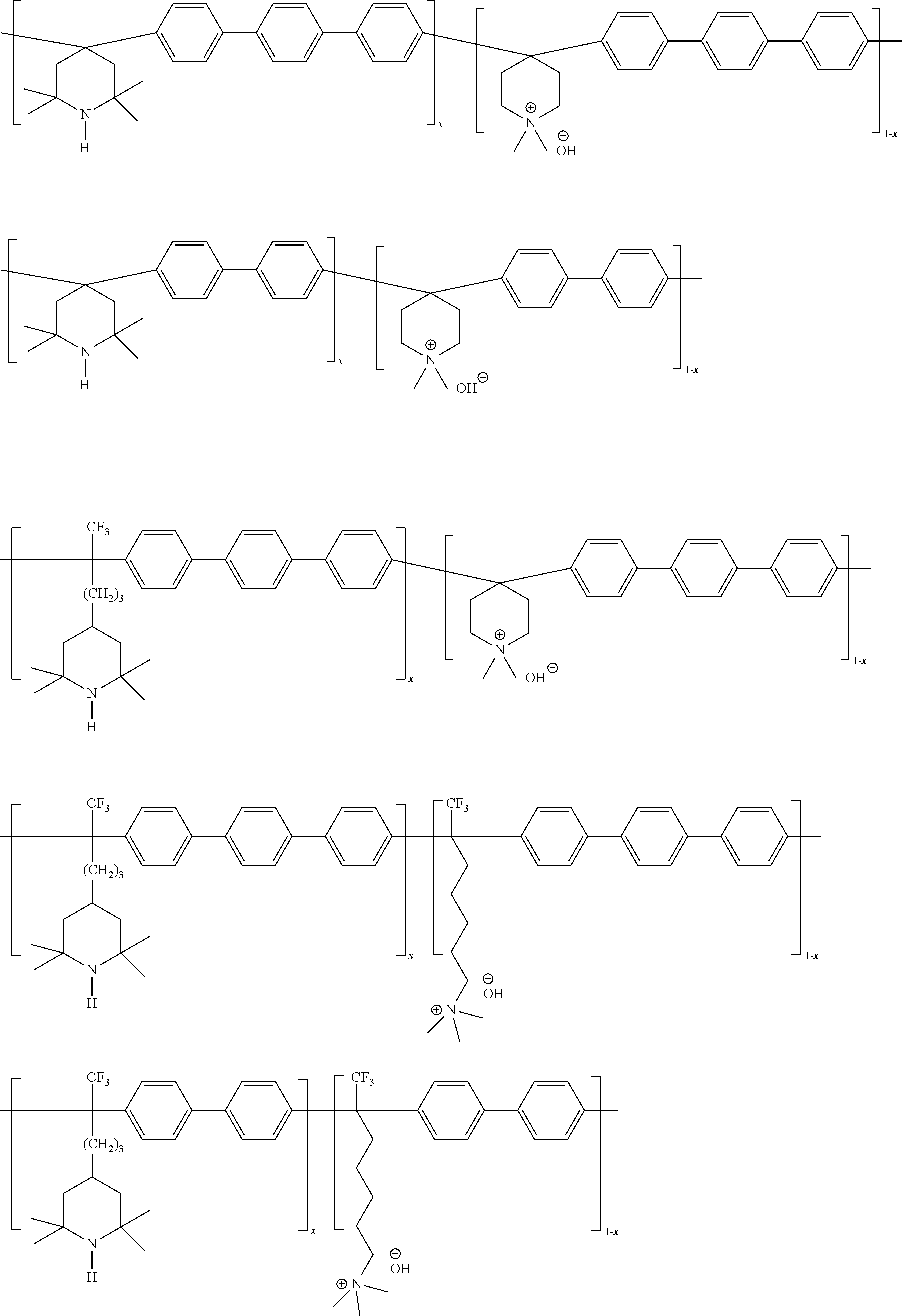

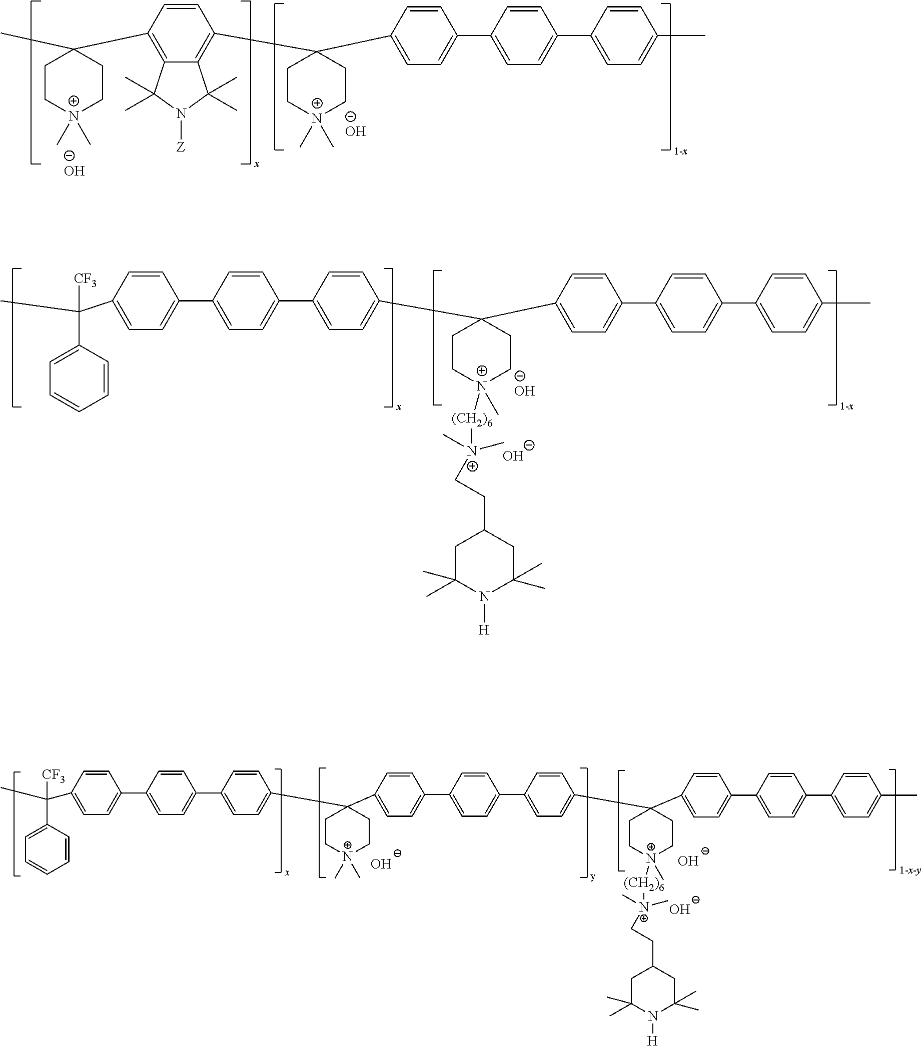

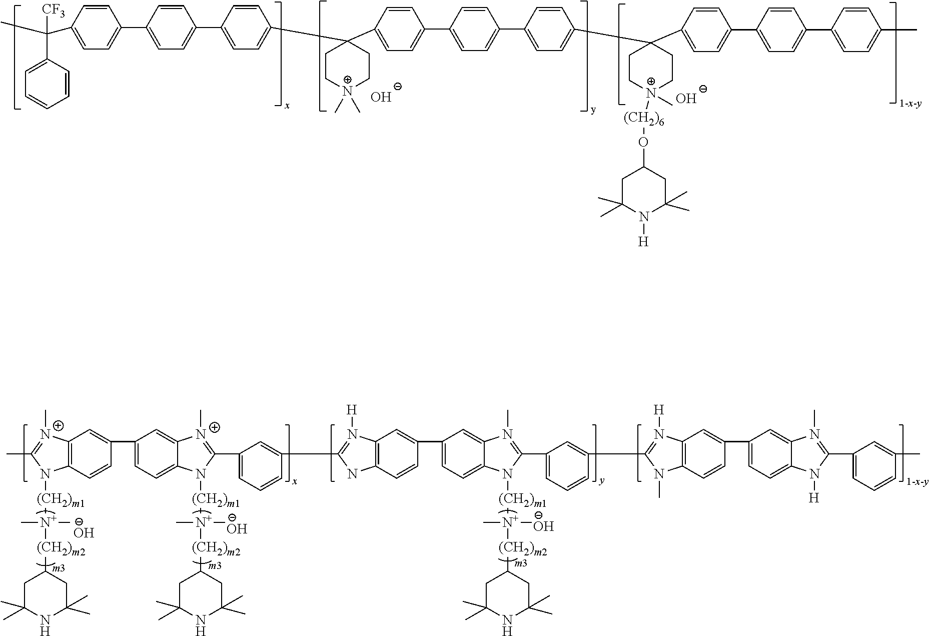

Representative polymers having ORG without ion exchange capacity (e.g., including structural units of formulae (1_{ORG}) or (2_{ORG}) include the following wherein n=5-10000:

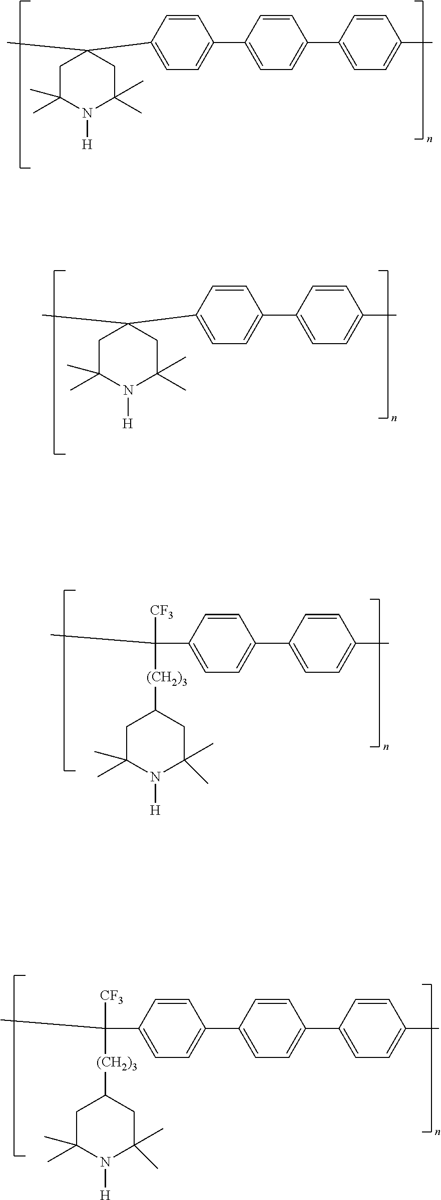

As an eighth aspect of the invention, a polymer is provided for enhancing oxidative resistance. The polymer comprises a reaction product of a mixture comprising:
(i) a polymer having the formula (10) as described above; and
(ii) an oxidation resistant group (ORG)-containing compound having the formula (11_{ORG}) as described above wherein [symbol] , m1-m7, and R₃₅-R₄₆ are as defined above.

Below are examples of additional preferred polymers of formula (10):

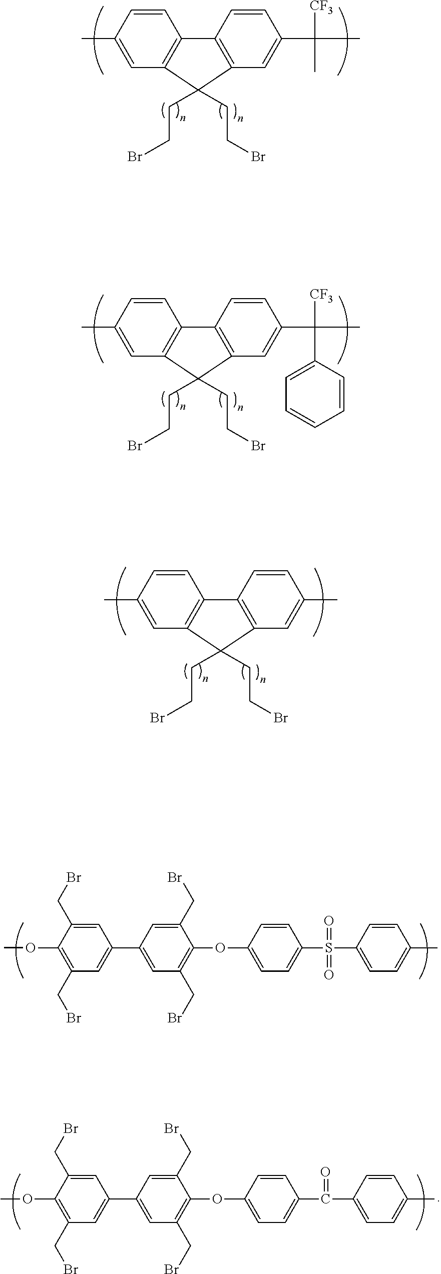

For an example when m7 is 1, m5 and m6 are 0, R₄₃ is amine or hydroxyl, and R₄₄ is a 2,2,6,6-piperidine nitrogen-containing heterocycle wherein a nitrogen of the heterocycle has an oxygen or hydrogen substituent, the (11_{ORG}) monomer has the formula:

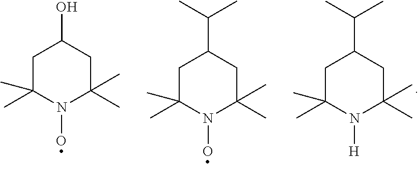

An example of polymer (10) is when m4 is 1, m3 is 2, m2 is 0, and m1 is 1, R₃₇ is an alkyl and R₃₈ is an halide.

Another example when m7 is 1, m5 is 1, m6 is 0, R₄₃ and R₄₀ are alkylene, R₃₉ is amine, and R₄₄ is a 2,2,6,6-piperidine nitrogen-containing heterocycle wherein a nitrogen of the heterocycle has a hydrogen substituent, the (11_{ORG}) monomer has the formula:

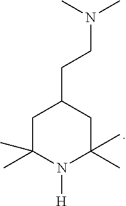

Another example when m7 is 1, m5 is 1, m6 is 1, R₄₀, R₄₁ and R₄₃ are alkylene, R₄₂ is ammonium, R₃₉ is amine, and R₄₄ is a 2,2,6,6-piperidine nitrogen-containing heterocycle wherein a nitrogen of the heterocycle has a hydrogen substituent, the (11_{ORG}) monomer has the formula:

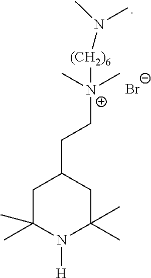

Another example when m7 is 1, m5 is 1, m6 is 1, R₄₀, R₄₁ and R₄₃ are alkylene, R₄₂ is ether, R₃₉ is amine, and R₄₄ is a 2,2,6,6-piperidine nitrogen-containing heterocycle wherein a nitrogen of the heterocycle has an oxygen or hydrogen substituent, the (11_{ORG}) monomer has the formula:

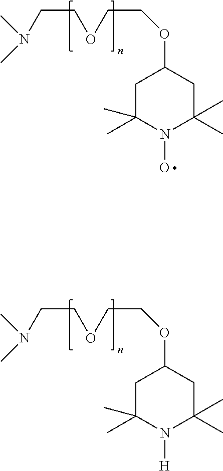

wherein n is 1-12.

A mole fraction of the structural unit of Formula 10 in the polymer can be about equal to the mole fraction of the structural unit of Formula (11_{ORG}) in the polymer, and the ratio of the mole fraction of the structural unit of Formula (11_{ORG}) in the polymer to the mole fraction of the structural unit of Formula 10 in the polymer can be from about 0.01 to 1.

A mole ratio of the sum of the mole fractions of the structural unit of Formula 10 in the polymer to the mole fractions of the structural unit of Formula (11_{ORG}) in the polymer can be from about 0.95:1 to about 1.4:1, and the ratio of the mole fraction of the structural unit of Formula (11_{ORG}) to the mole fraction of the structural unit of Formula 10 can be from about 0.01 to 1.

A mole fraction of the structural unit of Formula (11_{ORG}) in the polymer to the mole fraction of the structural unit of Formula 10 in the polymer can be from about 1:1 to about 1.2:1.

Preferably in the eighth aspect of the invention, m1, m2, m3, m4 and m6 are 0; m5 is 1; R₄₀ is alkylene optionally substituted with halide; R₄₄ is a nitrogen-containing heterocycle wherein a nitrogen of the heterocycle has an oxygen, sulfur or hydrogen substituent; and R₃₉ is an amine.

In another preferred polymer, R₃₈ is an amine, a tertiary phosphine, thiol, hydroxyl, alkenyl or alkynyl; R₃₉ is halide, mesylate, tosylate, azide, alkenyl, alkynyl; and the PAEK derivative structural unit has the formula:

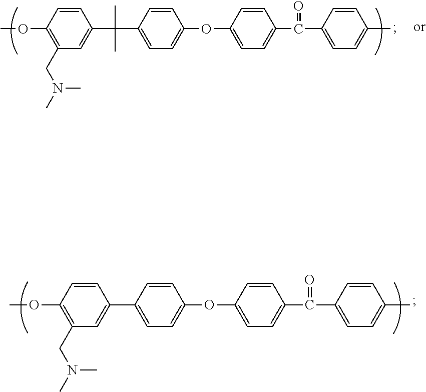

the PSU derivative structural unit has the formula:

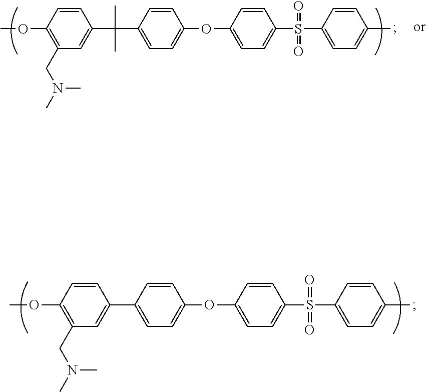

the PS derivative structural unit has the formula:

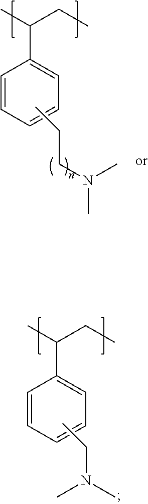

the poly(p-phenylene oxide) derivative structural unit has the formula:

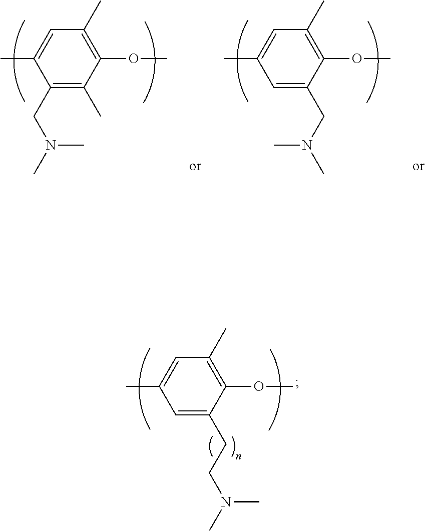

the SEBS derivative structural unit has the formula:

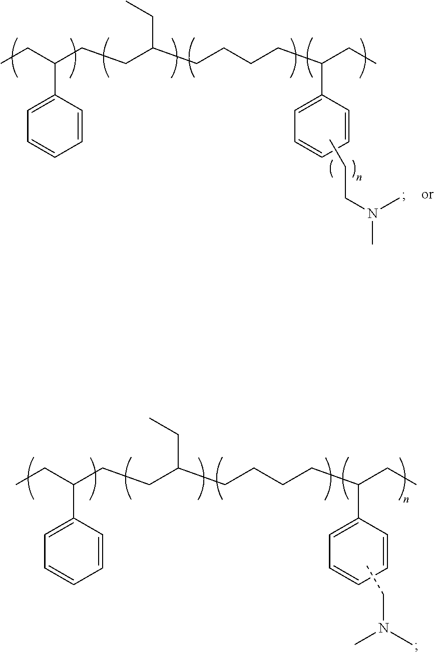

the polyethylene derivative structural unit has the formula:

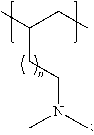

the poly(aryl alkylene) structural unit has the formula:

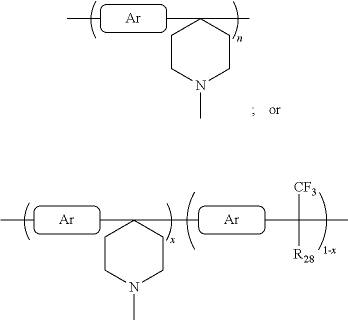

wherein Ar is aryl.

Preferably, m1-m4 are 0; m6 is 0 or 1; m5 and m7 are 1; R₄₁, R₄₂, and R₄₃ are alkylene optionally substituted with halide; R₄₁ is ammonium; R₄₄ is a nitrogen-containing heterocycle wherein a nitrogen of the heterocycle has an oxygen, sulfur or hydrogen substituent; and R₃₉ is halide.

Another example is when m4 is 1, m3 is 2, m2 is 0, and m1 is 1, R₃₇ is an alkyl and R₃₈ is an halide.

Below are the examples of such polymers (10):

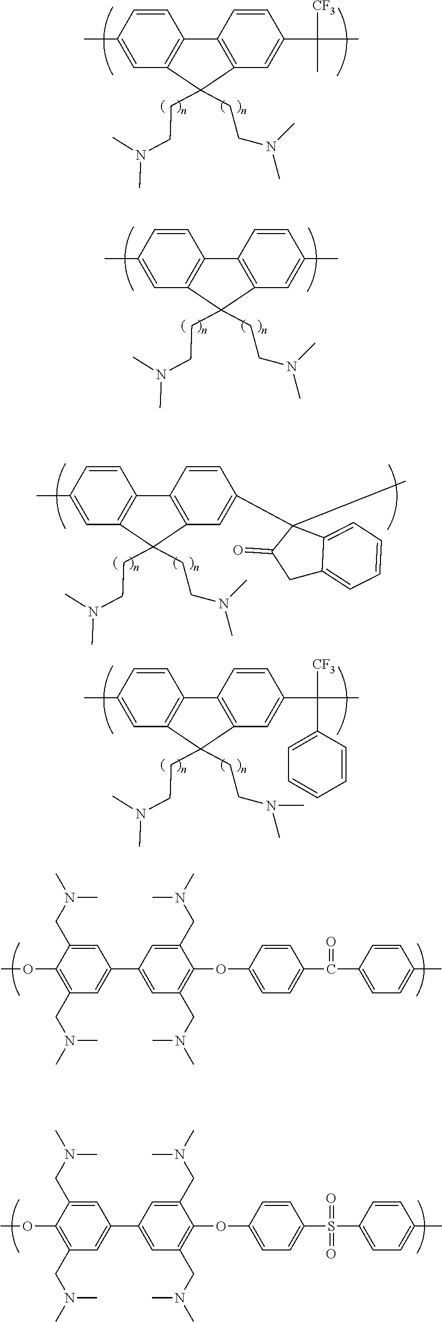

Below are examples of (11_{ORG}) monomers for use in the polymers described herein:

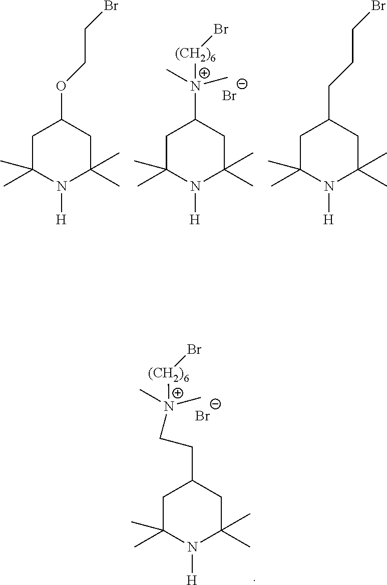

As a ninth aspect of the invention, another polymer is provided for enhancing oxidative resistance. The polymer comprises a product of a mixture comprising:
(i) a polymer having a backbone including a nitrogen-containing heterocyclic ring or a nitrogen-containing heterocyclic ring attached to aryl or a heterocycle; or
a polymer comprising at least two of the structural units of Formulae (3A), (6A), (7A), (8A) and (9A) as described above wherein m, n, n₁, n₂, n3, n4, n5, q, Q, R₅-R₁₃, R₂₀-R₃₄, and X⁻ are as defined above; and
(ii) an ORG-containing compound having the formula (12_{ORG}).

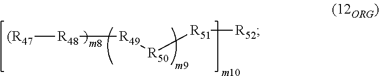

wherein m8-m10, and R₄₇-R₅₄ are as defined above. Below are (12_{ORG}) examples:

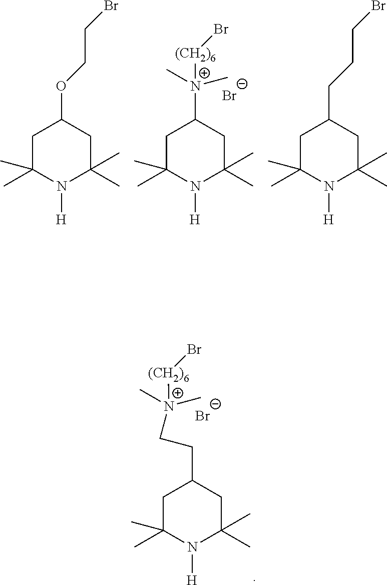

An example of a polymer having a backbone including a nitrogen-containing heterocyclic ring attached to aryl or a heterocycle is as follows:

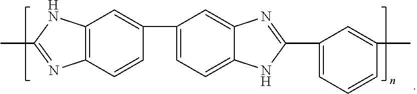

An example of a polymer comprising at least two of the structural units of Formulae (3A), (6A), (7A), (8A) and (9A) is a polymer comprising three of the structural units such as a polymer comprising the structural units of Formulae (3A), (6A) and (8A) such as the following:

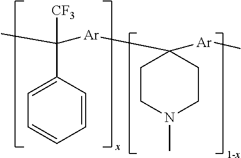

wherein Ar is the structural unit of Formula (3A) and x is 0-0.99.

The polymer of the ninth aspect of the invention can comprise two of the structural units, such as those of Formulae (3A) and (6A), (3A) and (7A), (3A) and (8A), (3A) and (9A), (6A) and (7A), (6A) and (8A), (6A) and (9A), (7A) and (8A), (7A) and (9A), or (8A) and (9A).

The polymer of the ninth aspect of the invention can comprise three of the structural units such as those of Formulae (3A), (6A), and (7A); (3A), (6A) and (8A); (3A), (6A) and (9A); (3A), (7A) and (8A); (3A), (7A) and (9A); (3A), (8A) and (9A); (6A), (7A) and (8A); (6A), (7A) and (9A); (7A), (8A) and (9A); and (8A), (6A) and (9A).

The polymer of the ninth aspect of the invention can comprise four of the structural units such as those of Formulae (3A), (6A), (7A) and (8A); (3A), (6A), (7A) and (9A); (3A), (6A), (8A) and (9A); (3A), (7A), (8A) and (9A); and (6A), (7A), (8A) and (9A).

The polymer of the ninth aspect of the invention can comprise five of the structural units.

A tenth aspect of the invention is a method of making an anion exchange polymer membrane comprising the anion exchange polymer of the seventh aspect of the invention. The method comprises: reacting an ORG monomer that has a trifluoromethyl ketone group, the optional trifluoromethyl ketone monomer, and the aromatic monomer in the presence of an organic solvent and a polymerization catalyst to form a cation-functionalized polymer; dissolving the cation-functionalized polymer in a solvent to form a polymer solution; casting the polymer solution to form a polymer membrane; and exchanging anions of the polymer membrane with hydroxide, bicarbonate, or carbonate ions or a combination thereof to form the anion exchange polymer membrane.

For example, an ORG monomer such as a trifluoromethyl ketone monomer having a pendant TEMPO derivative, a piperidone, an optional trifluoromethyl ketone monomer such as 2,2,2-trifluoroacetophenone or 1,1,1-trifluoroacetone, and an aromatic monomer such as benzene, biphenyl, p-terphenyl, m-terphenyl or p-quaterphenyl can be placed in a stirred container and dissolved or dispersed into an organic solvent. A polymerization catalyst in a solvent can then be added dropwise over up to 60 minutes at −78 to 60° C. Thereafter, the reaction is continued at this temperature for about 1 to about 120 hours. The resulting solution is poured slowly into an aqueous solution of ethanol. The solid obtained is filtered, washed with water and immersed in 1 M K₂CO₃ at room temperature for about 1 to 48 hours. Then the product is filtered, washed with water and dried completely under vacuum. Then the polymer is reacted with quaternization reagents such as methyl iodide to quaternized the piperidine ring. The cation functionalized polymer is then subjected to anion exchange, for example in 1 M KOH for hydroxide exchange, at about 20 to 100° C. for about 12 to 48 hours, followed by washing and immersion in DI water for about 12 to 48 hours under an oxygen-free atmosphere to remove residual KOH.

An eleventh aspect of the invention is a method of making an anion exchange polymer membrane comprising the anion exchange polymer in the seventh aspect of the invention and ORG-containing polymer without anion exchange capacity. The method comprises: reacting an ORG monomer that has trifluoromethyl ketone group, the optional trifluoromethyl ketone monomer, and the aromatic monomer in the presence of an organic solvent and a polymerization catalyst to form an ORG-containing polymer; dissolving the ORG-containing polymer in a solvent with a HEM that optionally bears ORGs to form a polymer solution; casting the polymer solution to form a polymer membrane; and exchanging anions of the polymer membrane with hydroxide, bicarbonate, or carbonate ions or a combination thereof to form the anion exchange polymer membrane.

For example, an ORG monomer such as a trifluoroketone monomer having a pendant TEMPO derivative and an aromatic monomer such as benzene, biphenyl, p-terphenyl, m-terphenyl or p-quaterphenyl can be placed in a stirred container and dissolved or dispersed into an organic solvent. A polymerization catalyst in a solvent can then be added dropwise over up to 60 minutes at −78 to 60° C. Thereafter, the reaction is continued at this temperature for about 1 to about 120 hours. The resulting solution is poured slowly into an aqueous solution of ethanol. The solid obtained is filtered, washed with water and immersed in 1 M K₂CO₃ at room temperature for about 1 to 48 hours. Then the product is filtered, washed with water and dried completely under vacuum to obtain a dry ORG-containing polymer without anion exchange capacity.

An eleventh aspect of the invention is an anion exchange membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and comprising the anion exchange polymer of the seventh aspect of the invention.

The anion exchange polymer can be made into reinforced hydroxide exchange membranes as described below. Such reinforced hydroxide exchange membranes can be prepared by a method which comprises wetting a porous substrate in a liquid to form a wetted substrate; dissolving the polymer in a solvent to form a homogeneous solution; applying the solution onto the wetted substrate to form the reinforced membrane; drying the reinforced membrane; and exchanging anions of the reinforced membrane with hydroxide ions to form the reinforced hydroxide exchange polymer membrane. The solution can be applied to the wetted substrate by any known membrane formation technique such as casting, spraying, or doctor knifing.

The resulting reinforced membrane can be impregnated with the ORG-containing polymer multiple times if desired by wetting the reinforced membrane again and repeating the dissolving, casting and drying steps.

The polymerization catalyst used in forming the polymer can comprise trifluoromethanesulfonic acid, pentafluoroethanesulfonic acid, heptafluoro-1-propanesulfonic acid, trifluoroacetic acid, perfluoropropionic acid, heptafluorobutyric acid, or a combination thereof.

Each of the organic solvents used in the any of the above methods can be independently selected from polar aprotic solvents (e.g., dimethyl sulfoxide, 1-methyl-2-pyrrolidinone, 1-methyl-2-pyrrolidone, 1-methyl-2-pyrrolidone, or dimethylformamide) or other suitable solvents including, but are not limited to, methylene chloride, trifluoroacetic acid, trifluoromethanesulfonic acid, chloroform, 1,1,2,2-tetrachloroethane, dimethylacetamide or a combination thereof.

The solvent in the dissolving step can comprise methanol, ethanol, n-propanol, isopropanol, n-butanol, sec-butanol, tert-butanol, a pentanol, a hexanol, dimethyl sulfoxide, 1-methyl-2-pyrrolidone, dimethylformamide, chloroform, ethyl lactate, tetrahydrofuran, 2-methyltetrahydrofuran, water, phenol, acetone, or a combination thereof.

The liquid used to wet the porous substrate can be a low boiling point solvent such as a lower alcohol (e.g., methanol, ethanol, propanol, isopropanol) and/or water.

Preferably, the liquid is anhydrous ethanol.

Additional aspects of the invention are described below.

An anion exchange membrane such as a hydroxide exchange membrane is also provided. The membrane is configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and comprises any of the ORG-containing polymers as described herein.

A reinforced electrolyte membrane such as a reinforced hydroxide exchange membrane is also provided to increase the mechanical robustness of the anion exchange membrane for stability through numerous wet and dry cycles (relative humidity cycling) in a fuel cell. The membrane is configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and comprises a porous substrate impregnated with any of the ORG-containing polymers as described herein. Methods for preparing reinforced membranes are well known to those of ordinary skill in the art such as those disclosed in U.S. Pat. Nos. RE37,656 and RE37,701, which are incorporated herein by reference for their description of reinforced membrane synthesis and materials.

The porous substrate can comprise a membrane comprised of polytetrafluoroethylene, polypropylene, polyethylene, poly(ether ketone), polyaryletherketone, imidazolium-tethered ORG-containing, imidazole-tethered ORG-containing, polysulfone, perfluoroalkoxyalkane, or a fluorinated ethylene propylene polymer, or other porous polymers known in the art such as the dimensionally stable membrane from Giner for use in preparing reinforced membranes for fuel cells. Such porous substrates are commercially available, for example, from W.L. Gore & Associates.

The porous substrate can have a porous microstructure of polymeric fibrils. Such substrates comprised of polytetrafluoroethylene are commercially available. The porous substrate can comprise a microstructure of nodes interconnected by fibrils.

The interior volume of the porous substrate can be rendered substantially occlusive by impregnation with the ORG-containing polymer as described herein.

The porous substrate can have a thickness from about 1 micron to about 10, 15, 20, 25, 30, 35, 40, 45, 50, 55, 60, 65, 70, 75, 80, 85, 90, 95 or 100 microns. Preferably, the porous substrate has a thickness from about 5 microns to about 30 microns, or from about 7 microns to about 20 microns.

An anion exchange membrane fuel cell, electrolyzer, electrodialyzer, solar hydrogen generator, flow battery, desalinator, sensor, demineralizer, water purifier, waste water treatment system, ion exchanger, or CO₂ separator is also provided, the fuel cell, electrolyzer, electrodialyzer, solar hydrogen generator, flow battery, desalinator, sensor, demineralizer, water purifier, waste water treatment system, ion exchanger, or CO₂ separator comprising the anion exchange polymer.

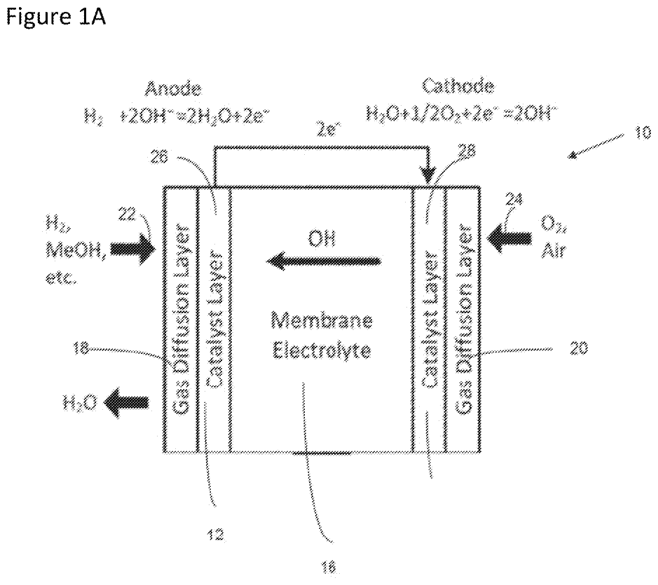

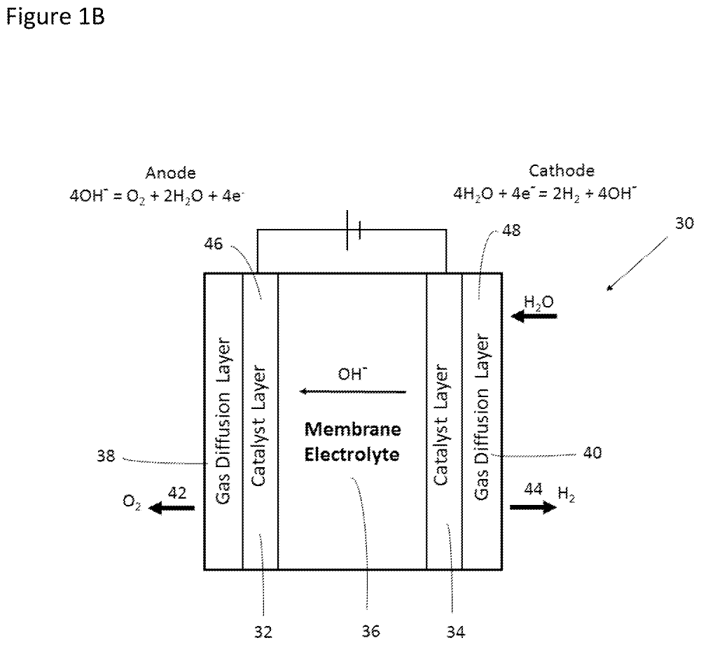

The ORG-containing polymers can be used in HEMFCs such as a typical fuel cell 10 as shown in FIG. 1A. FIG. 1A illustrates a typical fuel cell 10 with an anode portion 12 (illustrated on the left) and a cathode portion 14 (illustrated on the right) which are separated by an electrolyte membrane 16. The electrolyte membrane 16 can be any membrane comprising any of the ORG-containing polymers as described herein, and can be a reinforced membrane. Supporting members are not illustrated. The anode portion carries out an anode half-reaction which oxidizes fuel releasing electrons to an external circuit and producing oxidized products. The cathode portion carries out a cathode half-reaction which reduces an oxidizer consuming electrons from the external circuit. The gas diffusion layers (GDLs) 18 and 20 serve to deliver the fuel 22 and oxidizer 24 uniformly across the respective catalyst layers 26 and 28. Charge neutrality is maintained by a flow of ions from the anode to the cathode for positive ions and from cathode to anode for negative ions. The dimensions illustrated are not representative, as the electrolyte membrane is usually selected to be as thin as possible while maintaining the membrane's structural integrity.

In the case of the illustrated hydroxide exchange membrane fuel cell (HEMFC), the anode half-reaction consumes fuel and OH— ions and produces waste water (as well as carbon dioxide in the case of carbon containing fuels). The cathode half reaction consumes oxygen and produces OH— ions, which flow from the cathode to the anode through the electrolyte membrane. Fuels are limited only by the oxidizing ability of the anode catalyst and typically include hydrogen gas, methanol, ethanol, ethylene glycol, and glycerol. Preferably, the fuel is H2 or methanol. Catalysts are usually platinum (Pt), silver (Ag), or one or more transition metals, e.g., Ni. In the case of a PEMFC, the anode half-reaction consumes fuel and produces H+ ions and electrons. The cathode half reaction consumes oxygen, H+ ions, and electrons and produces waste water, and H+ ions (protons) flow from the anode to the cathode through the electrolyte membrane.

Therefore, it can be appreciated how an electrolyte membrane made from an ORG-containing polymer significantly improves fuel cell performance. First, greater fuel cell efficiency requires low internal resistance, and therefore, electrolyte membranes with greater ionic conductivity (decreased ionic resistance) are preferred. Second, greater power requires greater fuel cell currents, and therefore, electrolyte membranes with greater ion-current carrying capacity are preferred. Also, practical electrolyte membranes resist chemical degradation and are mechanically stable in a fuel cell environment, and also should be readily manufactured.

The ORG-containing polymers can be used in HEMELs such as an electrolyzer 30 as shown in FIG. 1B. FIG. 1B illustrates an electrolyzer 30 with an anode portion 32 (illustrated on the left) and a cathode portion 34 (illustrated on the right) which are separated by an electrolyte membrane 36. The electrolyte membrane 36 can be any membrane comprising any of the ORG-containing polymers as described herein, and can be a reinforced membrane. Supporting members are not illustrated. The anode portion carries out an anode half-reaction which oxidizes ions releasing electrons to an external circuit and producing oxidized products. The cathode portion carries out a cathode half-reaction which reduces an oxidizer consuming electrons from the external circuit. The gas diffusion layers (GDLs) 38 and 40 serve to release the oxidizer 42 and fuel 44 uniformly across the respective catalyst layers 46 and 48. Charge neutrality is maintained by a flow of ions from the anode to the cathode for positive ions and from cathode to anode for negative ions. The dimensions illustrated are not representative, as the electrolyte membrane is usually selected to be as thin as possible while maintaining the membrane's structural integrity.

In the case of the illustrated hydroxide exchange membrane fuel cell (HEMFC), the anode half-reaction consumes OH— ions and produces oxygen. The cathode half reaction consumes water and produces hydrogen and OH— ions, which flow from the cathode to the anode through the electrolyte membrane. Fuels are limited only by the oxidizing ability of the cathode catalyst and typically include hydrogen gas, methanol, ethanol, ethylene glycol, and glycerol. Preferably, the fuel is H₂ or methanol. Catalysts are usually platinum (Pt), silver (Ag), or one or more transition metals, e.g., Ni.

Therefore, it can be appreciated how an electrolyte membrane made from an ORG-containing polymer significantly improves electrolyzer performance. First, greater electrolyzer efficiency requires low internal resistance, and therefore, electrolyte membranes with greater ionic conductivity (decreased ionic resistance) are preferred. Second, greater fuel production requires greater electrolyzer currents, and therefore, electrolyte membranes with greater ion-current carrying capacity are preferred. Also, practical electrolyte membranes resist chemical degradation and are mechanically stable in an electrolyzer environment, and also should be readily manufactured.

Although a principal application for the ORG-containing polymers is for energy conversion such as in use in anion exchange membranes, hydroxide exchange membranes, anion exchange membrane fuel cells, and hydroxide exchange membrane fuel cells, the anion/hydroxide exchange ionomers and membranes can be used for many other purposes such as use in fuel cells (e.g., hydrogen/alcohol/ammonia fuel cells); electrolyzers (e.g., water/carbon dioxide/ammonia electrolyzers), electrodialyzers; ion-exchangers; solar hydrogen generators; desalinators (e.g., desalination of sea/brackish water); demineralizers (e.g., demineralization of water); water purifiers (e.g., ultra-pure water production); waste water treatment systems; concentration of electrolyte solutions in the food, drug, chemical, and biotechnology fields; electrolysis (e.g., chlor-alkali production and H₂/O₂ production); energy storage (e.g., super capacitors, metal air batteries and redox flow batteries); sensors (e.g., pH/RH sensors); and in other applications where an anion-conductive ionomer is advantageous.

Also provided is a reinforced electrolyte membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator. The membrane comprises a porous substrate impregnated with the anion exchange polymer.

Having described the invention in detail, it will be apparent that modifications and variations are possible without departing from the scope of the invention defined in the appended claims.

### EXAMPLES

### Example 1

An oxidation resistant HEM is based on a Menshutkin reaction of poly(aryl piperidone) polymer (PAP) and 2,2,6,6-tetramethylpiperidine multi-quaternary-ammonium side chain (MQN-TMPH) according to the fifth aspect of the invention. Poly(aryl piperidone) polymer with 2,2,6,6-tetramethylpiperidine multi-quaternary-ammonium side chain (PAP-MQN-TMPH) was synthesized by three major steps: (1) Menshutkin reaction of alkyl dihalide (e.g. 1,6-dibromohexane (below) or 1,6-diiodohexane) and an aminated piperidine monomer (e.g., an alkylpiperidine amine such as 2,2,6,6-tetramethylpiperidine-4-amine, or an alkylpiperidine alkylamine such as N,N,2,2,6,6-hexamethylpiperidine-4-amine (below)) to prepare MQN-TMPH, (2) quaternization of PAP with MQN-TMPH and (3) membrane casting and hydroxide ion exchange. The reaction scheme is shown below:

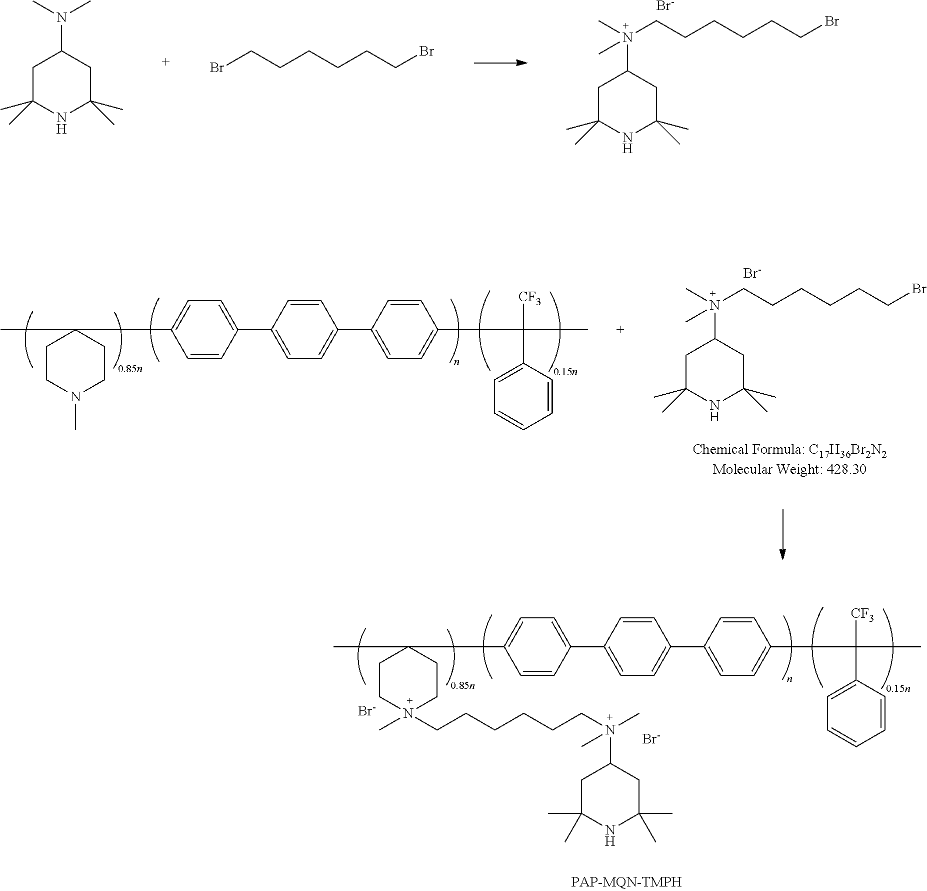

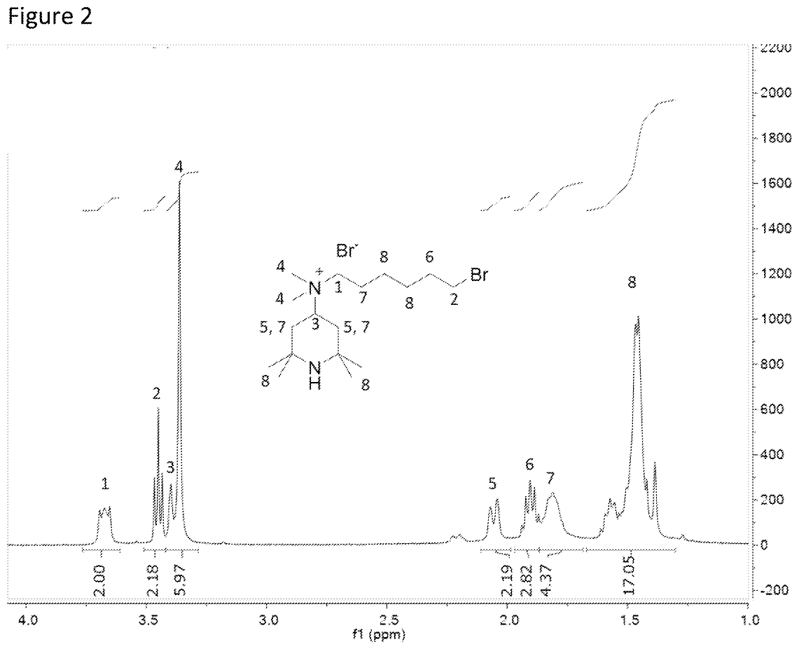

(1) Synthesis of MQN-TMPH. To a 200 ml THE solution of 1,6-dibromohexane (15.4 ml, 0.100 mol, 10 eq.), a mixture of diethyl ether (50 ml) and N,N-2,2,6,6-tetramethylpiperidine-4-dimethylamine (2 g, 0.01 eq.) was added dropwise. The mixture was stirred for 16 h after the addition. A white solid was formed slowly. The white precipitate was filtered and washed with cold diethyl ether. MQN-TMPH (4.37 g, 95% yield) was obtained as a white or light yellow powder after dried over vacuum. 1H NMR (400 MHz, CDCl3) (FIG. 2), δ (ppm)=1.38-1.61 (m, 16H), 1.76-1.86 (m, 4H), 1.86-1.94 (p, 2H), 2.04, 2.07 (d, 2H), 3.36 (s, 6H), 3.39 (s, 1H), 3.45 (t, 2H), 3.67 (t, 2H).

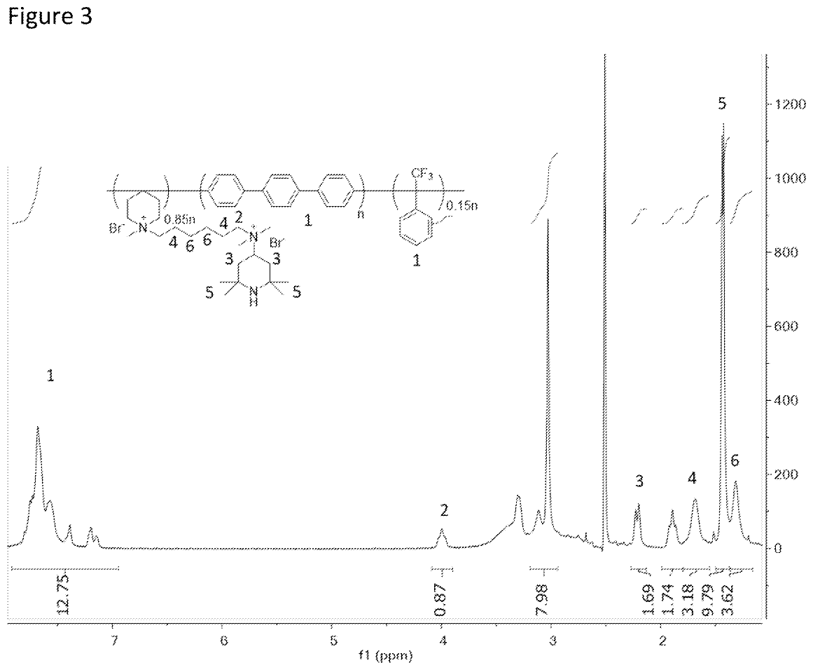

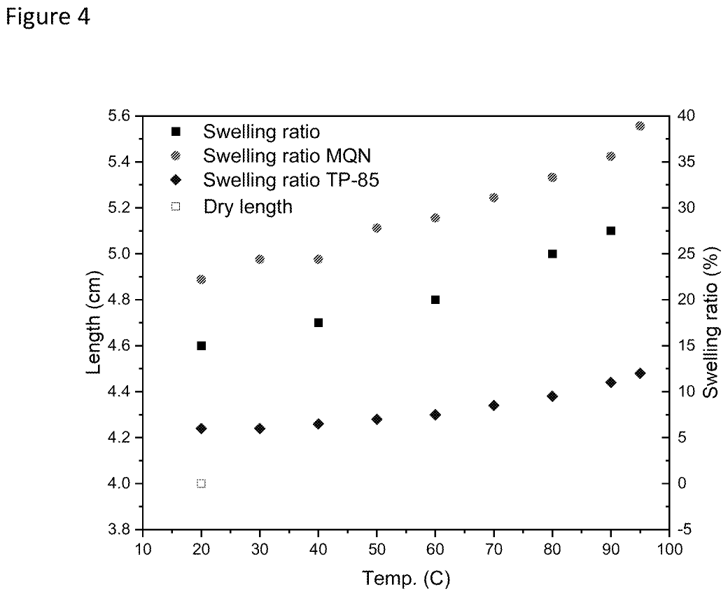

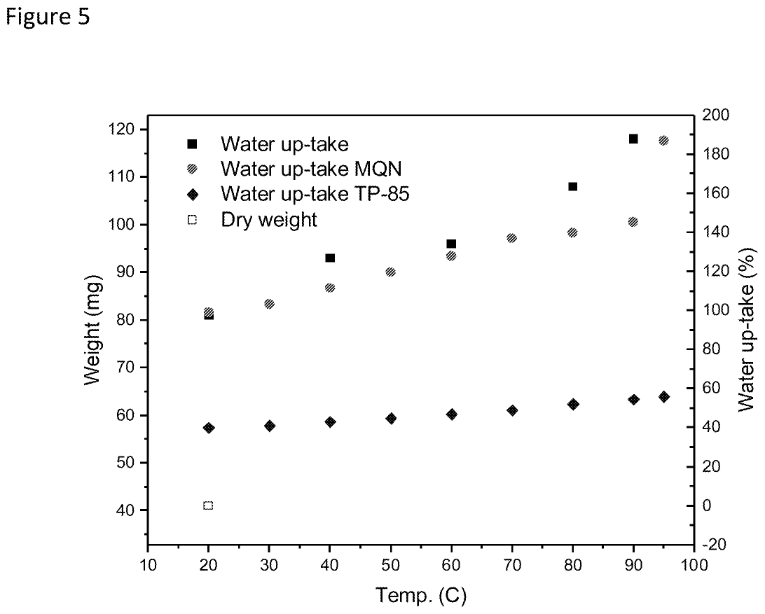

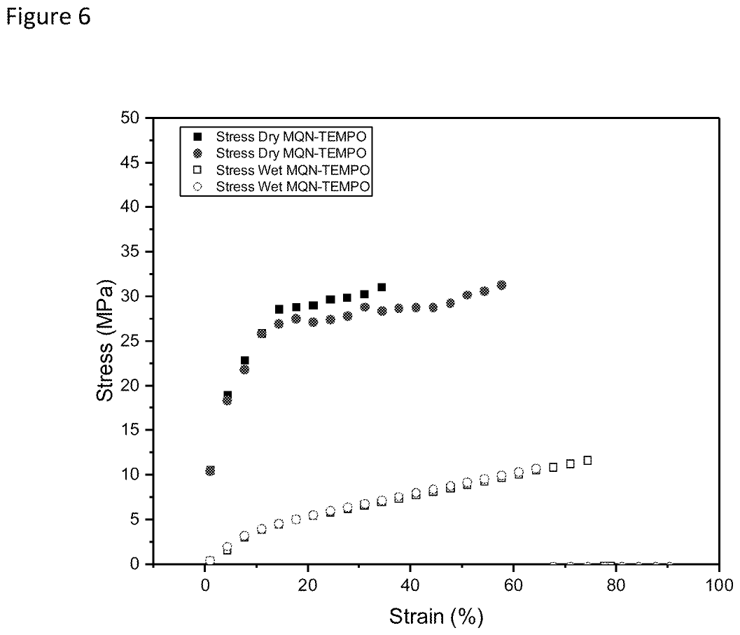

(2) Synthesis of PAP-MQN-TMPH. A mixture of 10 ml N-methyl-4-piperidone (NMP), 1 g PAP-TP-85-N polymer (made as described in Example 10 of WO 2019/068051) and 1.28 g MQN-TMPH (1.2 eq.) were stirred for 120 h at 40° C. The reaction mixture proceeds through a solid-liquid mixture to a clear yellow solution then ends with a light yellow NMP solution with crude PAP-MQN-TEMPH product as a light yellow powder or small particles. The resulted NMP slurry was added 10 m1 acetone, filtered, washed with 3×10 m1 acetone and dried at 80° C. for overnight to obtain the final PAP-MQN-TMPH polymer (2 g, 90% yield, 100% quaternization yield). 1H NMR (400 MHz, DMSO-D6) (FIG. 3), δ (ppm)=7.79-7.16 (Ar, 12.75H), 3.99, 3.10, 3.03, 2.22, 2.19, 1.87, 1.68, 1.41, 1.31.

(3) Membrane casting. 2 g of PAP-MQN-TMPH was dissolved in 10 m1 DMSO at 80° C. The yellow DMSO solution was filtrated through a small piece of medical cotton. The filtrated polymer solution was deposited on a clean glass plate and casted into a thin film with Mayer bar. The film on glass plate was immediately transferred into a 40° C. oven to remove most of the DMSO solvent for 4 h, following a 16 h annealing at 120° C. Afterwards, the glass plate with membrane film was placed into DI water to peel off. The final membrane was obtained after drying under ambient temperature and removing defected edges.

(4) Ion exchange. The membranes (Br form) were immersed into a 1 M NaHCO3 aqueous solution (>30 eq. to repeating units) at 80° C. for 1 h. After each exchange, the NaHCO₃ solution was replaced with fresh solution. This process was repeated 4 times and the bromide/bromine concentration was examined on membrane by X-ray fluorescence spectrometer (XRF) at the end (typically less than 0.1 wt. % bromide/bromine left). OH— exchange can be done using the same method with 1 M NaOH aqueous solution repeated 5 times.

(5) Ionomer preparation. 1 g of PAP-MQN-TMPH was dissolved into a solvent mixture of 9.5 g DI water and 9.5 g n-propanol. The ionomer was obtained by filtering the yellow solution through a small piece of medical cotton.

TABLE 1
PAP-MQN-TMPH Swelling ratio & water up-take

| | Length | Swelling | Weight | Water up- |
|---|---|---|---|---|
| Temp. (° C.) | (cm) | ratio (%) | (mg) | take (%) |
| Ambient dry | 4 | 0% | 41 | 0% |
| 20 | 4.6 | 15% | 81 | 98% |
| 40 | 4.7 | 18% | 93 | 127% |
| 60 | 4.8 | 20% | 96 | 134% |
| 80 | 5 | 25% | 108 | 163% |
| 90 | 5.1 | 28% | 118 | 188% |

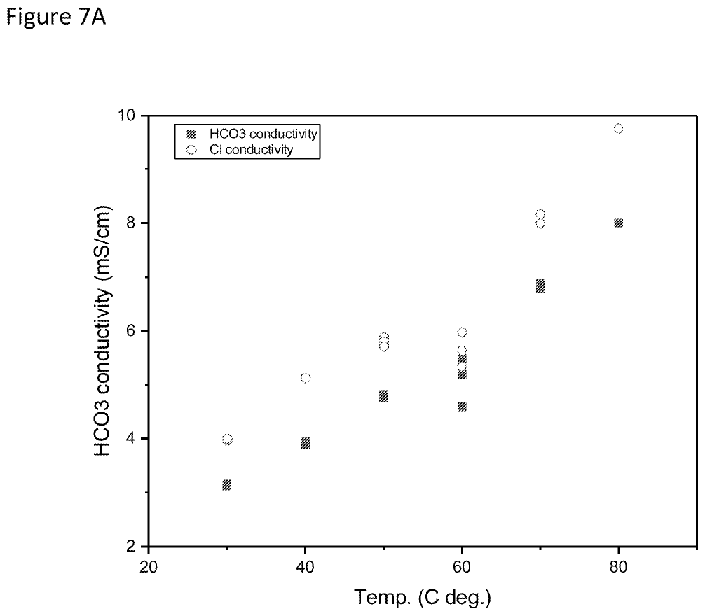

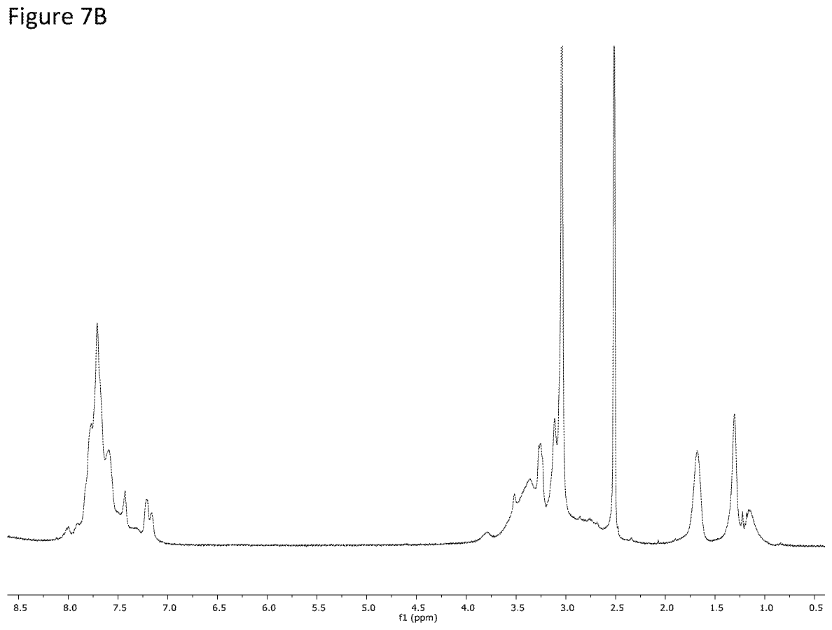

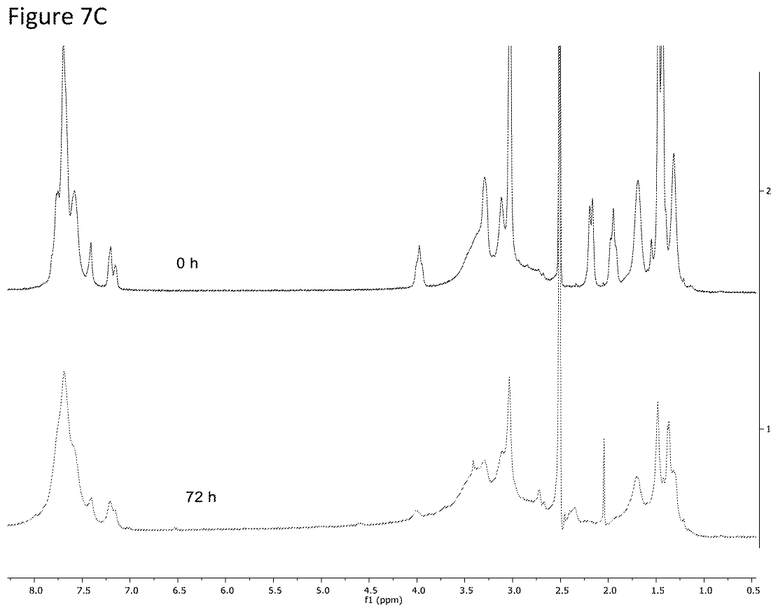

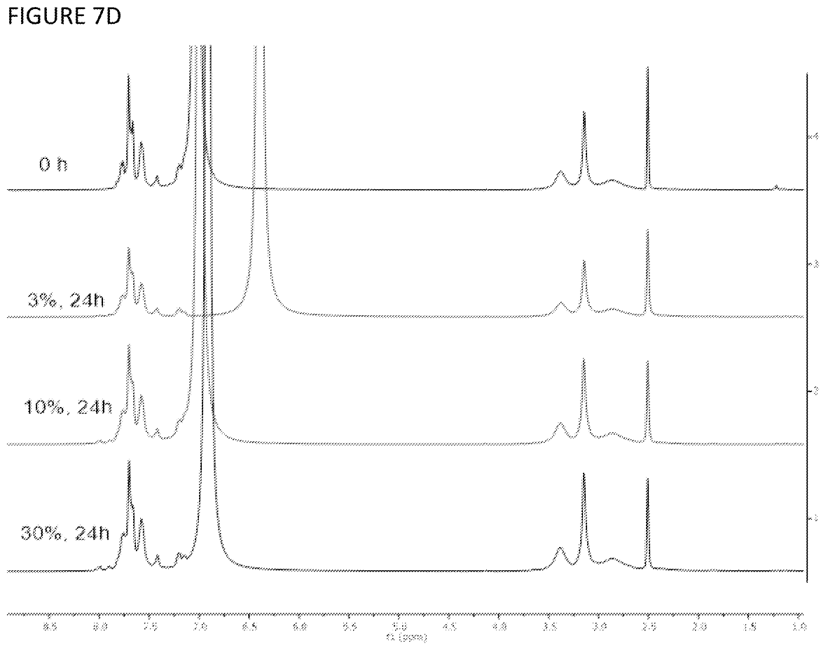

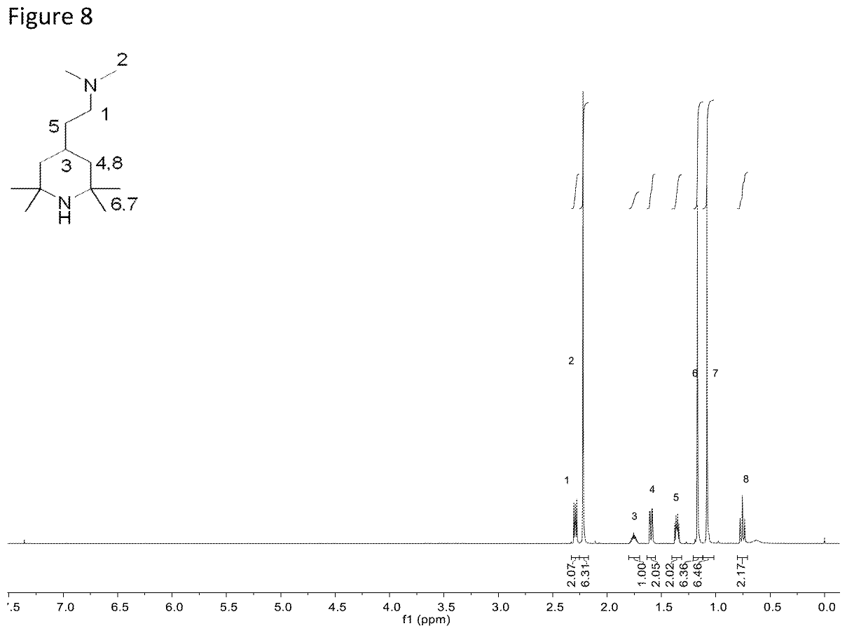

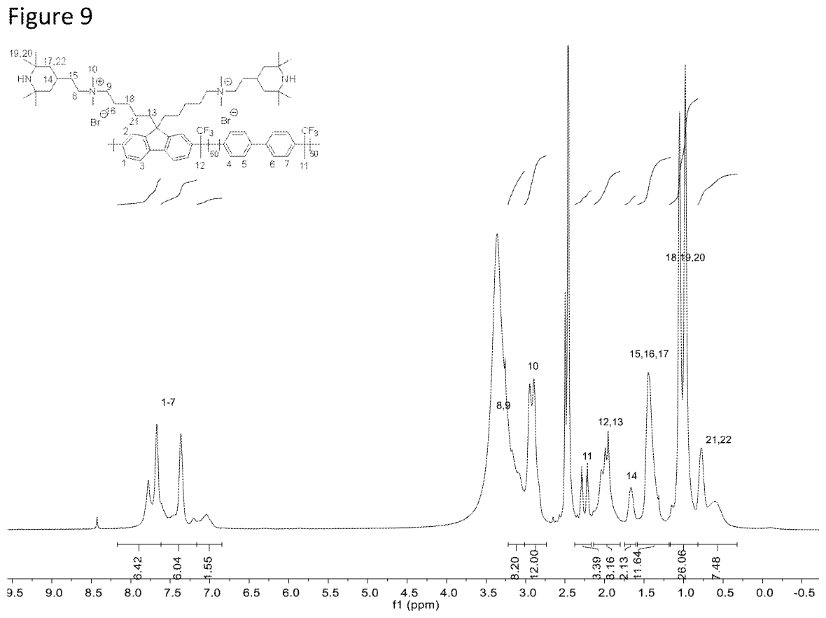

(6) The oxidative stability of PAP-MQN-TMPH. The anion exchange membranes PAP-MQN-TMPH in HCO₃— form were placed in fresh prepared Fenton's reagent (20 ppm FeSO4 in 10% H₂O₂ solution) at room temperature for 72 h. Afterwards, the PAP-MQN-TMPH membrane was still flexible and retained good mechanical properties, whereas PAP-MQN membrane (bearing no TEMPO-like unit) was almost dissolved. 1H NMR data showed that the backbone of PAP-MQN was degraded (new peaks appeared at around 8 ppm), but there was no backbone degradation for PAP-MQN-TMPH (no peak appeared at 8 ppm) after 72 h test. As a comparison, the oxidative stability of PAP-TP-85 (bearing no oxidation resistant group) was tested. The TP85 anion exchange membranes in HCO₃⁻ form was placed in fresh prepared Fenton's reagent (4 ppm FeSO4 in different concentration H₂O₂ solution) at room temperature. PAP-TP-85 membrane was stable in 3% H2O2 Fenton's reagent. However, PAP-TP-85 was unstable in a high concentration H₂O₂ solution. After 24 h, all of the membranes broke into pieces as summarized in Table 2 below. 1H NMR data showed that the backbone of PAP-TP-85 was degraded (new peaks appeared at around 8 ppm) as shown in FIG. 7D.

TABLE 2
Mechanical properties of the TP85 membrane after testing

| H₂O₂ | |
|---|---|
| Concentration | Time (hours) |

| (%) | 8 | 16 | 24 |
|---|---|---|---|
| 3 | Flexible | Flexible | Flexible |
| 10 | Flexible | Slightly | Broken |
| | | brittle | into pieces |
| 20 | Brittle | Brittle | Broken |
| | | | into pieces |
| 30 | Broken | Broken | Broken |
| | into pieces | into pieces | into pieces |

### Example 2

An oxidation resistant HEM is based on a Friedel-Crafts reaction of an aromatic monomer of formula (3) (e.g., terphenyl such as p-terphenyl, m-terphenyl or a mixture of these two monomers), a 2,2,6,6-tetramethyl-4-piperidone monomer of formula (1_{ORG}) (e.g., 2,2,6,6-tetramethyl-4-piperidone) and a piperidone monomer of formula (6) (e.g., 4-methyl-1-piperidone) according to the first and second aspects of the invention. Terphenyl based Poly(aryl 2,2,6,6-tetramethylpiperidone-co-piperidinium) polymer (PATMP-PIP-TP) was synthesized by three major steps: (1) Friedel-Crafts reaction of terphenyl, 2,2,6,6-tetramethylpiperidone and 4-methyl-1-piperidone to prepare PATMP-TP, (2) quaternization of PATMP-TP with methyl halide (e.g. iodomethane) and (3) membrane casting and hydroxide ion exchange. The reaction scheme is shown below:

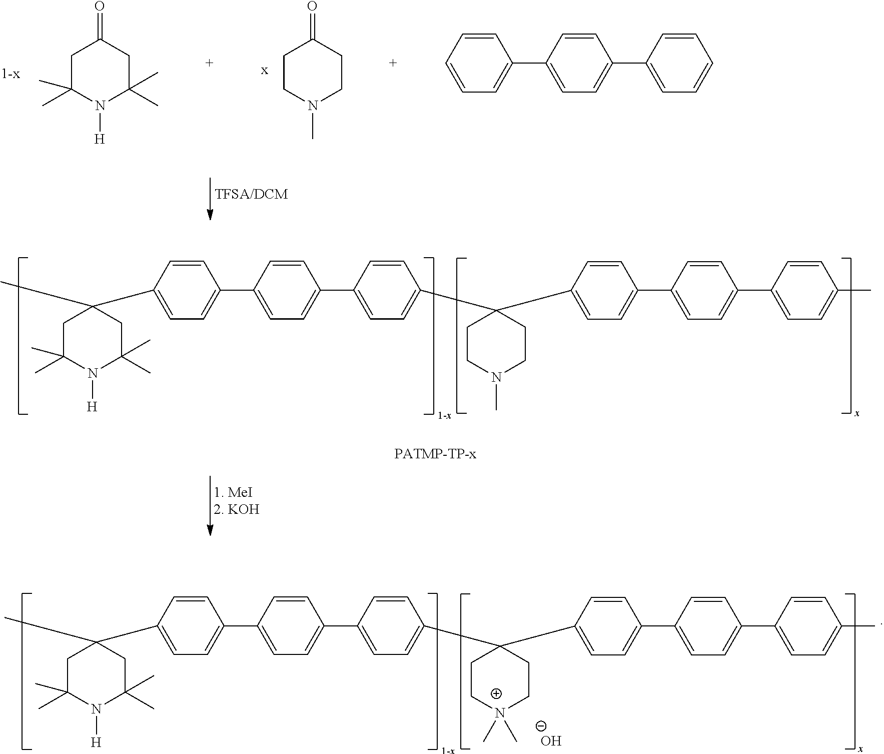

(1) Synthesis of PATMP-TP-60. To a 100 mL three-necked flask equipped with overhead mechanical stirrer, N-methyl-4-piperidone (0.6790 g, 6 mmol), 2,2,6,6-tetramethylpiperidone (0.6210 g, 4 mmol) and p-terphenyl (2.3031 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K₂CO₃ at room temperature for 12 hours. Finally, the white fibrous product was filtered, washed with water and dried completely at 60° C. under vacuum. The yield of the polymer was nearly 100%. 1H NMR (CDCl3, δ, ppm): 7.77-7.19 (m, 12H), 2.51 (2.4H), 2.22 (4H), and 1.25, 1.22 (4.8H).

(2) Quaternization of PATMP-TP-60. To a 50 mL one-necked flask equipped with magnetic bar, the PATMP polymer (1.0 g) was dissolved into DMSO (20 mL). Methyl iodide (1 mL) was added quickly. The solution was stirred over 12 hours at room temperature. The resulting viscous, yellow solution was added dropwise into ether. The yellow solid was filtered, washed with ether and dried completely at 60° C. under vacuum. The yield of the polymer PATMP-TP-60-Mel was almost 100%. 1H NMR (DMSO-d6, δ, ppm): 7.98-7.17 (12H), 3.38 (2.4H), 3.17 (3.6H), 2.85 (4H) and 1.31, 1.28 (4.8H).

(3) Membrane casting. 2 g of PATMP-TP-60-Mel was dissolved in 10 m1 DMSO at 80° C. The yellow DMSO solution was filtrated through a small piece of medical cotton. The filtrated polymer solution was deposited on a clean glass plate and casted into a thin film with Mayer bar. The film on glass plate was immediately transferred into a 40° C. oven to remove most of the DMSO solvent for 4 h, following a 16 h annealing at 120° C. Afterwards, the glass plate with membrane film was placed into DI water to peel off. The final membrane was obtained after drying under ambient temperature and removing defected edges.

(4) Ion Exchange. The membrane in hydroxide form was obtained by ion exchange in 1 M KOH at 25° C. for 24 hours, followed by washing and immersion in DI water for 48 hours under argon to remove residual KOH.

### Example 3

Another oxidation resistant HEM is based on a Friedel-Crafts reaction of an aromatic monomer of formula (3) (e.g., terphenyl such as p-terphenyl, m-terphenyl or a mixture of these two monomers) and a 2,2,6,6-tetramethylpiperidone monomer of formula (1_{ORG}) according to the first and second aspects of the invention. Poly(aryl 2,2,6,6-tetramethylpiperidone) polymer (PATMP-TP-0) was synthesized by Friedel-Crafts reaction of terphenyl and 2,2,6,6-tetramethylpiperidone to prepare PATMP-TP. The reaction scheme is shown below:

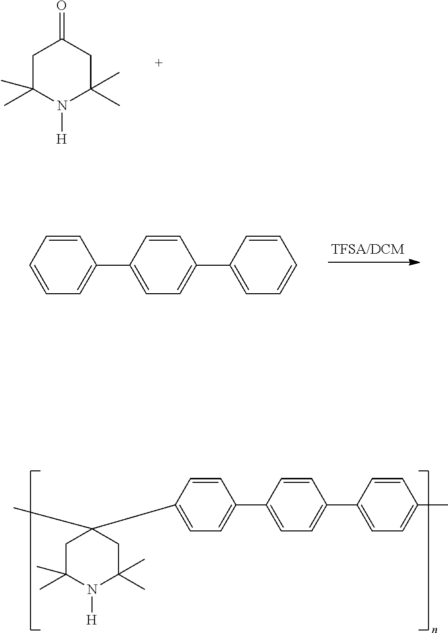

(1) Synthesis of PATMP-TP-0. To a 100 mL three-necked flask equipped with overhead mechanical stirrer, 2,2,6,6-tetramethylpiperidone (1.5524 g, 10 mmol) and p-terphenyl (2.3031 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K₂CO₃ at room temperature for 12 hours. Finally, the white fibrous product was filtered, washed with water and dried completely at 60° C. under vacuum. The yield of the polymer was nearly 100%. 1H NMR (CDCl3, δ, ppm): 7.77-7.19 (m, 12H), 2.22 (4H), and 1.25, 1.22 (12H).

### Example 4

Another oxidation resistant HEM is based on a Friedel-Crafts reaction of an aromatic monomer of formula (3) (e.g., biphenyl), a 2,2,6,6-tetramethylpiperidone monomer of formula (1_{ORG}) and 4-methyl-1-piperidone of formula (6) according to the first and second aspects of the invention. Biphenyl based Poly(aryl 2,2,6,6-tetramethylpiperidone-co-piperidinium) polymer (PATMP-PIP-BP) was synthesized by three major steps: (1) Friedel-Crafts reaction of biphenyl, 2,2,6,6-tetramethylpiperidone and 4-methyl-1-piperidone to prepare PATMP-BP-x, (2) quaternization of PATMP-BP-x with methyl halide (e.g. iodomethane) and (3) membrane casting and hydroxide ion exchange. The reaction scheme is shown below:

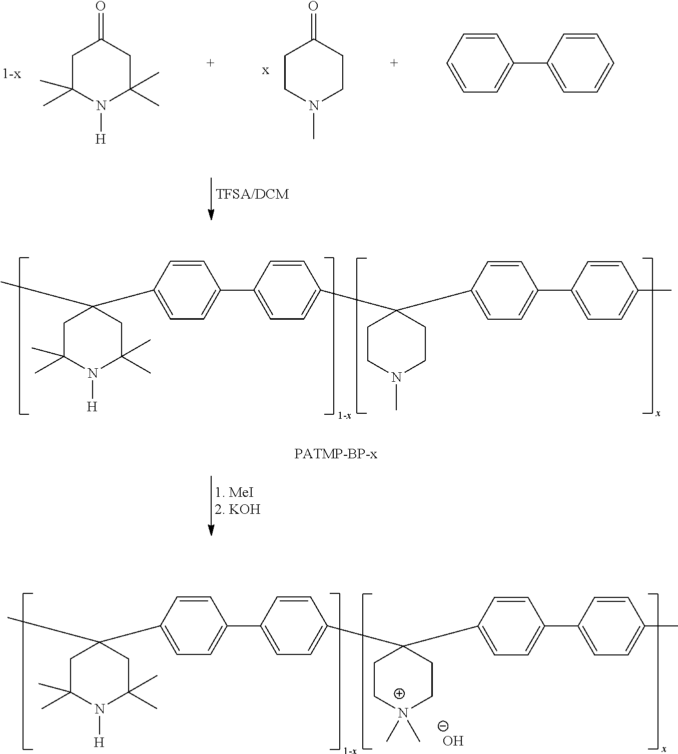

(1) Synthesis of PATMP-BP-60. To a 100 mL three-necked flask equipped with overhead mechanical stirrer, N-methyl-4-piperidone (0.6790 g, 6 mmol), 2,2,6,6-tetramethylpiperidone (0.6210 g, 4 mmol) and biphenyl (1.5421 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K2CO3 at room temperature for 12 hours. Finally, the white fibrous product was filtered, washed with water and dried completely at 60° C. under vacuum. The yield of the polymer was nearly 100%. 1H NMR (CDCl3, δ, ppm): 7.57-7.19 (m, 8H), 2.51 (2.4H), 2.22 (4H), and 1.25, 1.22 (4.8H).

(2) Quaternization of PATMP-BP-60. To a 50 mL one-necked flask equipped with magnetic bar, the PATMP polymer (1.0 g) was dissolved into DMSO (20 mL). Methyl iodide (1 mL) was added quickly. The solution was stirred over 12 hours at room temperature. The resulting viscous, yellow solution was added dropwise into ether. The yellow solid was filtered, washed with ether and dried completely at 60° C. under vacuum. The yield of the polymer PATMP-TP-60-Mel was almost 100%. 1H NMR (DMSO-d6, δ, ppm): 7.77-7.17 (8H), 3.38 (2.4H), 3.17 (3.6H), 2.85 (4H) and 1.31, 1.28 (4.8H).

(3) Membrane casting. 2 g of PATMP-TP-60-Mel was dissolved in 10 m1 DMSO at 80° C. The yellow DMSO solution was filtrated through a small piece of medical cotton. The filtrated polymer solution was deposited on a clean glass plate and casted into a thin film with Mayer bar. The film on glass plate was immediately transferred into a 40° C. oven to remove most of the DMSO solvent for 4 h, following a 16 h annealing at 120° C. Afterwards, the glass plate with membrane film was placed into DI water to peel off. The final membrane was obtained after drying under ambient temperature and removing defected edges.

(4) Ion Exchange. The membrane in hydroxide form was obtained by ion exchange in 1 M KOH at 60° C. for 24 hours, followed by washing and immersion in DI water for 48 hours under argon to remove residual KOH.

### Example 5

Another oxidation resistant HEM is based on a Friedel-Crafts reaction of an aromatic monomer of formula (3) such as biphenyl and a piperidone monomer of formula (1_{ORG}) such as 2,2,6,6-tetramethylpiperidone according to the first and second aspects of the invention. Poly(aryl 2,2,6,6-tetramethylpiperidone) polymer (PATMP-BP-0) was synthesized by Friedel-Crafts reaction of biphenyl and 2,2,6,6-tetramethylpiperidone to prepare PATMP-BP-0. The reaction scheme is shown below:

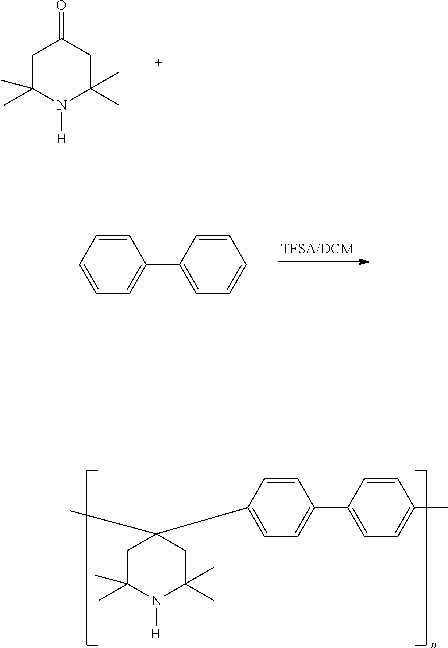

(1) Synthesis of PATMP-BP-0. To a 100 mL three-necked flask equipped with overhead mechanical stirrer, 2,2,6,6-tetramethylpiperidone (1.5524 g, 10 mmol) and biphenyl (1.5421 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K2CO3 at room temperature for 12 hours. Finally, the white fibrous product was filtered, washed with water and dried completely at 60° C. under vacuum. The yield of the polymer was nearly 100%. 1H NMR (CDCl3, δ, ppm): 7.57-7.19 (m, 8H), 2.22 (4H), and 1.25, 1.22 (12H).

### Example 6

Another oxidation resistant HEM is based on a Friedel-Crafts reaction of an aromatic monomer of formula (3) (e.g., terphenyl such as p-terphenyl, m-terphenyl or a mixture of these two monomers), a trifluoromethyl-(tetramethylpiperidinyl)alkan-one monomer of formula (2_{ORG}) such as 1,1,1-trifluoro-5-(2,2,6,6-tetramethylpiperidin-4-yl)pentan-2-one and a piperidone monomer of formula (6) such as 4-methyl-1-piperidone according to the first and second aspects of the invention. Terphenyl based Poly(aryl trifluoromethyl ketone) polymer (PATF-TP-x) was synthesized by three major steps: (1) Friedel-Crafts reaction of terphenyl, 1,1,1-trifluoro-5-(2,2,6,6-tetramethylpiperidin-4-yl)pentan-2-one and 4-methyl-1-piperidone to prepare PATF-TP-x, (2) quaternization of PATF-TP-x with methyl halide (e.g. iodomethane) and (3) membrane casting and hydroxide ion exchange. The reaction scheme is shown below:

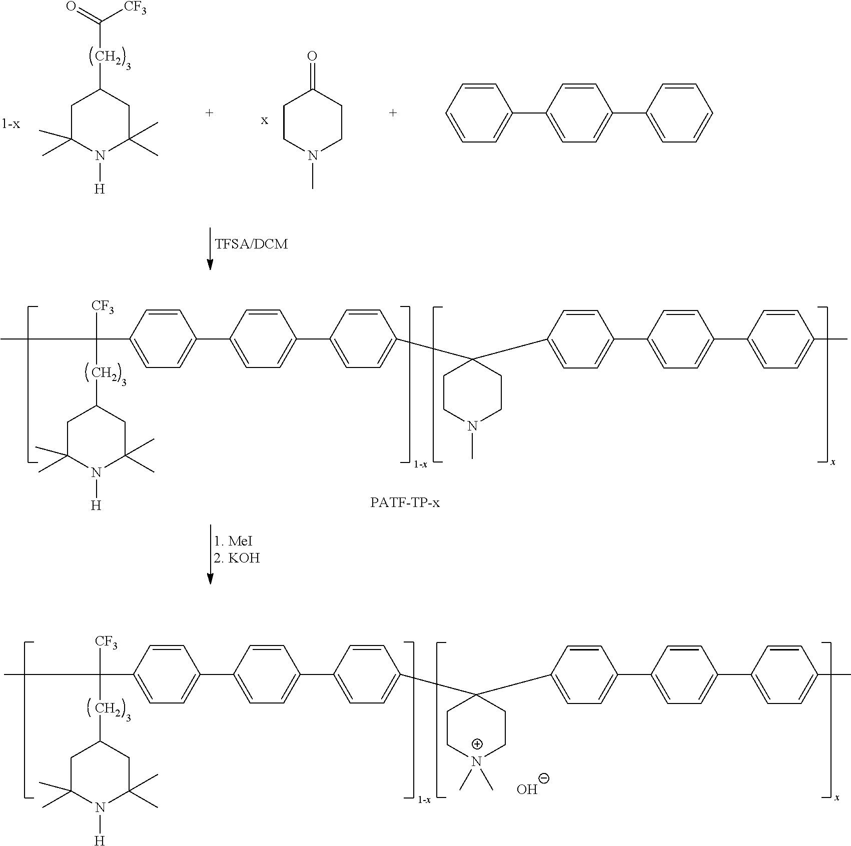

(1) Synthesis of PATF-TP-60. To a 100 mL three-necked flask equipped with overhead mechanical stirrer, N-methyl-4-piperidone (0.6790 g, 6 mmol), 1,1,1-trifluoro-5-(2,2,6,6-tetramethylpiperidin-4-yl)pentan-2-one (1.1174 g, 4 mmol) and p-terphenyl (2.3031 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K2CO3 at room temperature for 12 hours. Finally, the white fibrous product was filtered, washed with water and dried completely at 60° C. under vacuum. The yield of the polymer was nearly 100%. 1H NMR (CDCl3, δ, ppm): 7.77-7.19 (m, 12H), 2.51 (2.4H), 2.22 (4H), 1.48-1.28 (2.8H) and 1.25, 1.22 (4.8H).

(2) Quaternization of PATF-TP-60. To a 50 mL one-necked flask equipped with magnetic bar, the PAT polymer (1.0 g) was dissolved into DMSO (20 mL). Methyl iodide (1 mL) was added quickly. The solution was stirred over 12 hours at room temperature. The resulting viscous, yellow solution was added dropwise into ether. The yellow solid was filtered, washed with ether and dried completely at 60° C. under vacuum. The yield of the polymer PATF-TP-60-Mel was almost 100%. 1H NMR (DMSO-d6, δ, ppm): 7.98-7.17 (12H), 3.38 (2.4H), 3.17 (3.6H), 2.85 (4H), 1.48-1.28 (2.8H) and 1.31, 1.28 (4.8H).

(3) Membrane casting 2 g of PATF-TP-60-Mel was dissolved in 10 m1 DMSO at 80° C. The yellow DMSO solution was filtrated through a small piece of medical cotton. The filtrated polymer solution was deposited on a clean glass plate and casted into a thin film with Mayer bar. The film on glass plate was immediately transferred into a 40° C. oven to remove most of the DMSO solvent for 4 h, following a 16 h annealing at 120° C. Afterwards, the glass plate with membrane film was placed into DI water to peel off. The final membrane was obtained after drying under ambient temperature and removing defected edges.

(4) Ion Exchange. The membrane in hydroxide form was obtained by ion exchange in 1 M KOH at 60° C. for 24 hours, followed by washing and immersion in DI water for 48 hours under argon to remove residual KOH.

### Example 7

Another oxidation resistant HEM is based on a Friedel-Crafts reaction of an aromatic monomer of formula (3) (e.g., terphenyl such as p-terphenyl, m-terphenyl or a mixture of these two monomers) and a trifluoro-(2,2,6,6-tetramethylpiperidinyl)alkan-one monomer of formula (2_{ORG}) (e.g., 1,1,1-trifluoro-5-(2,2,6,6-tetramethylpiperidin-4-yl)pentan-2-one) according to the first and second aspects of the invention. Poly(aryl trifluoromethyl ketone) polymer (PATF-TP-0) was synthesized by Friedel-Crafts reaction of terphenyl and 1,1,1-trifluoro-5-(2,2,6,6-tetramethylpiperidin-4-yl)pentan-2-one to prepare PATMP-TP. The reaction scheme is shown below:

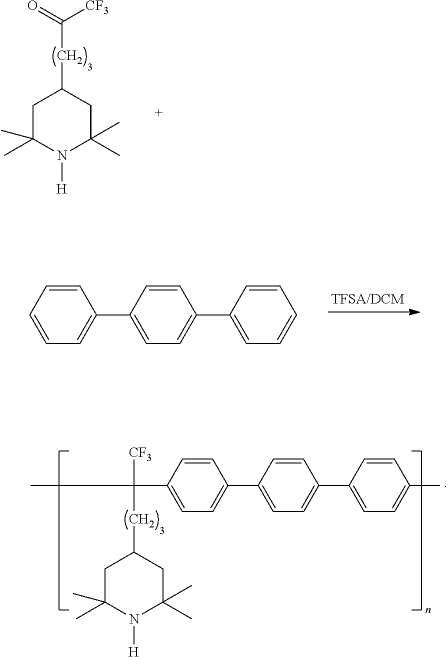

(1) Synthesis of PATF-TP-0. To a 100 mL three-necked flask equipped with overhead mechanical stirrer, 1,1,1-trifluoro-5-(2,2,6,6-tetramethylpiperidin-4-yl)pentan-2-one (2.7935 g, 10 mmol) and p-terphenyl (2.3031 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K2CO3 at room temperature for 12 hours. Finally, the white fibrous product was filtered, washed with water and dried completely at 60° C. under vacuum. The yield of the polymer was nearly 100%. 1H NMR (CDCl3, δ, ppm): 7.77-7.19 (m, 12H), 2.22 (4H), 1.48-1.28 (7H) and 1.25, 1.22 (12H).

### Example 8

Another oxidation resistant HEM is based on a Friedel-Crafts reaction of an aromatic monomer of formula (3) (e.g., terphenyl), a trifluoro-(2,2,6,6-tetramethylpiperidinyl)alkan-one monomer of formula (2_{ORG}) (e.g., 1,1,1-trifluoro-5-(2,2,6,6-tetramethylpiperidin-4-yl)pentan-2-one) and a halogenated trifluoromethyl ketone monomer of formula (9) (e.g., 7-bromo-1, 1,1-trifluoroheptan-2-one) according to the first and second aspects of the invention. Terphenyl based Poly(aryl trifluoromethyl ketone-co-alkylene ammonium) polymer (PATF-AA-TP) was synthesized by three major steps: (1) Friedel-Crafts reaction of terphenyl, 1,1,1-trifluoro-5-(2,2,6,6-tetramethylpiperidin-4-yl)pentan-2-one and 7-bromo-1,1,1-trifluoroheptan-2-one to prepare PATF-AB-TP-x, (2) quaternization of PATF-TP-x with trimethylamine, and (3) membrane casting and hydroxide ion exchange. The reaction scheme is shown below:

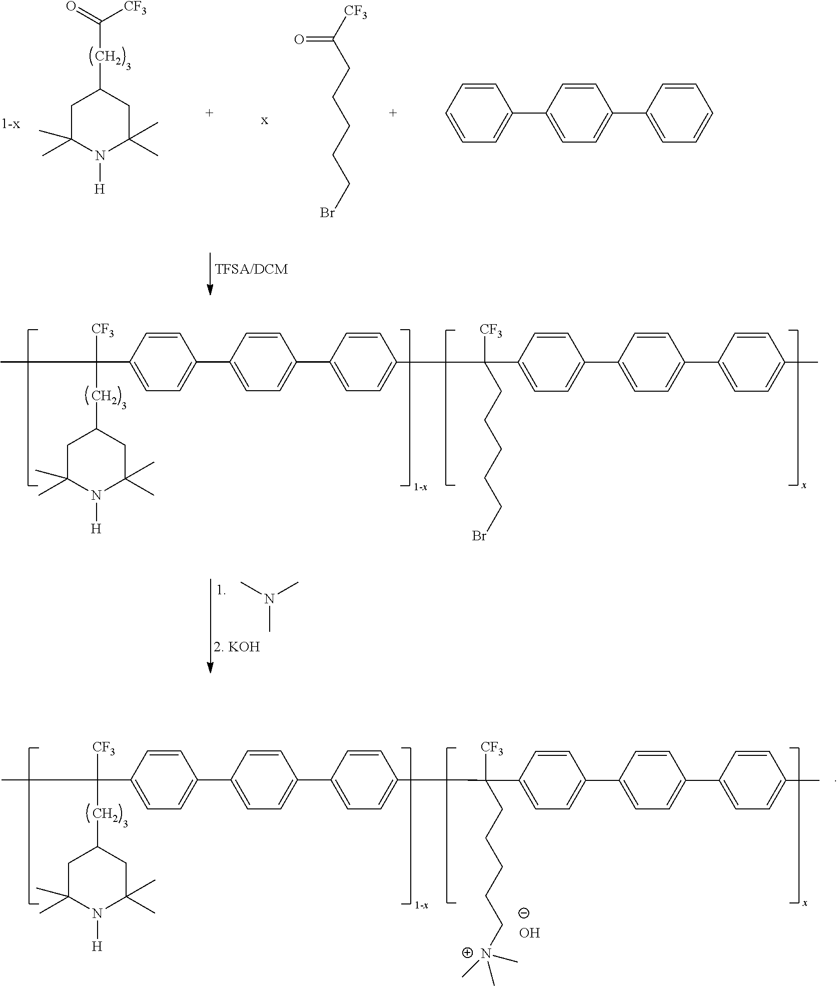

(1) Synthesis of PATF-TP-60. To a 100 mL three-necked flask equipped with overhead mechanical stirrer, 7-bromo-1,1,1-trifluoroheptan-2-one (1.4823 g, 6 mmol), 1,1,1-trifluoro-5-(2,2,6,6-tetramethylpiperidin-4-yl)pentan-2-one (1.1174 g, 4 mmol) and terphenyl (2.3031 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K2CO3 at room temperature for 12 hours. Finally, the white fibrous product was filtered, washed with water and dried completely at 60° C. under vacuum. The yield of the polymer was nearly 100%. 1H NMR (CDCl3, δ, ppm): 7.57-7.19 (m, 12H), 2.51 (2.4H), 2.22 (4H), 1.48-1.28 (2.8H) and 1.25, 1.22 (4.8H).

(2) Quaternization of PATF-TP-60. To a 50 mL one-necked flask equipped with magnetic bar, the PATF polymer (1.0 g) was dissolved into DMSO (20 mL). Trimethylamine (1 mL) was added quickly. The solution was stirred over 12 hours at room temperature. The resulting viscous, yellow solution was added dropwise into ether. The yellow solid was filtered, washed with ether and dried completely at 60° C. under vacuum. The yield of the polymer PATF-BP-60-Mel was almost 100%. 1H NMR (DMSO-d6, δ, ppm): 7.77-7.17 (12H), 3.38 (2.4H), 3.17 (3.6H), 2.85 (4H), 1.48-1.28 (2.8H) and 1.31, 1.28 (4.8H).

(3) Membrane casting 2 g of PATF-TP-60-Mel was dissolved in 10 m1 DMSO at 80° C. The yellow DMSO solution was filtrated through a small piece of medical cotton. The filtrated polymer solution was deposited on a clean glass plate and casted into a thin film with Mayer bar. The film on glass plate was immediately transferred into a 40° C. oven to remove most of the DMSO solvent for 4 h, following a 16 h annealing at 120° C. Afterwards, the glass plate with membrane film was placed into DI water to peel off. The final membrane was obtained after drying under ambient temperature and removing defected edges.

(4) Ion Exchange. The membrane in hydroxide form was obtained by ion exchange in 1 M KOH at 60° C. for 24 hours, followed by washing and immersion in DI water for 48 hours under argon to remove residual KOH.

### Example 9

Another oxidation resistant HEM is based on a Friedel-Crafts reaction of an aromatic monomer of formula (3) (e.g., biphenyl) and a trifluoro-(2,2,6,6-tetramethylpiperidinyl)alkan-2-one monomer of formula (2_{ORG}) (e.g., 1,1,1-trifluoro-5-(2,2,6,6-tetramethylpiperidin-4-yl)pentan-2-one) according to the first and second aspects of the invention. Poly(aryl trifluoromethyl ketone) polymer (PATF-BP-0) was synthesized by Friedel-Crafts reaction of biphenyl and 1,1,1-trifluoro-5-(2,2,6,6-tetramethylpiperidin-4-yl)pentan-2-one to prepare PATF-BP-0. The reaction scheme is shown below:

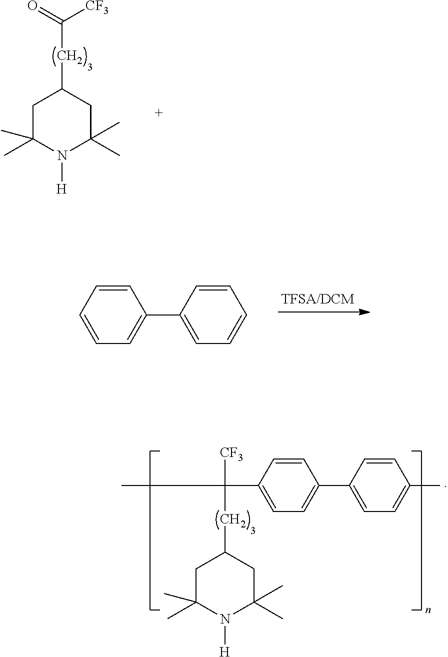

(1) Synthesis of PATMP-BP-0. To a 100 mL three-necked flask equipped with overhead mechanical stirrer, 1,1,1-trifluoro-5-(2,2,6,6-tetramethylpiperidin-4-yl)pentan-2-one (2.7935 g, 10 mmol) and biphenyl (1.5421 g, 10 mmol) were dissolved into methylene chloride (10 mL). Trifluoroacetic acid (TFA) (0.5 mL) and trifluoromethanesulfonic acid (TFSA) (10 mL) were then added dropwise over 30 minutes at 0° C. Thereafter, the reaction was continued at this temperature for 36 hours. The resulting viscous, brown solution was poured slowly into an aqueous solution of ethanol. The white fibrous solid was filtered, washed with water and immersed in 1 M K₂CO₃ at room temperature for 12 hours. Finally, the white fibrous product was filtered, washed with water and dried completely at 60° C. under vacuum. The yield of the polymer was nearly 100%. 1H NMR (CDCl3, δ, ppm): 7.57-7.19 (m, 8H), 2.22 (4H), 1.48-1.28 (2.8H) and 1.25, 1.22 (12H).

### Example 10

Another oxidation resistant poly(aryl trifluoromethyl ketone) polymer is based on 1,1,1-trifluoro-5-(2,2,6,6-tetramethylpiperidin-4-yl)pentan-2-one (formula (2_{ORG})), 7-bromo-1,1,1-trifluoroheptan-2-one (formula (9)), terphenyl (p-terphenyl, m-terphenyl or the mixture of these two monomers of formula (3)) and quaternization with trimethyl amine according to the first and second aspects of the invention. The reaction scheme for the polymer synthesis is shown below:

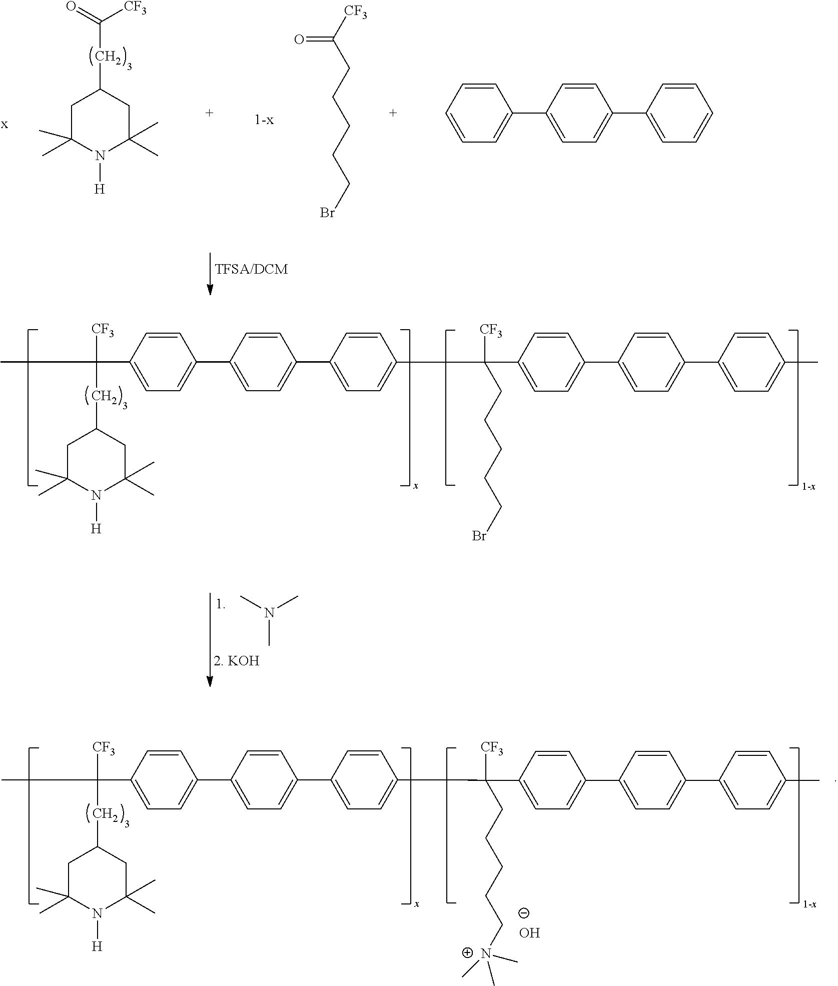

### Example 11

Another oxidation resistant poly(aryl trifluoromethyl ketone) polymer is based on 1,1,1-trifluoro-5-(2,2,6,6-tetramethylpiperidin-4-yl)pentan-2-one (formula (2_{ORG})), 7-bromo-1,1,1-trifluoroheptan-2-one (formula (9)), biphenyl (formula (3))I and trimethyl amine according to the first and second aspects of the invention. The reaction scheme for the polymer synthesis is shown below:

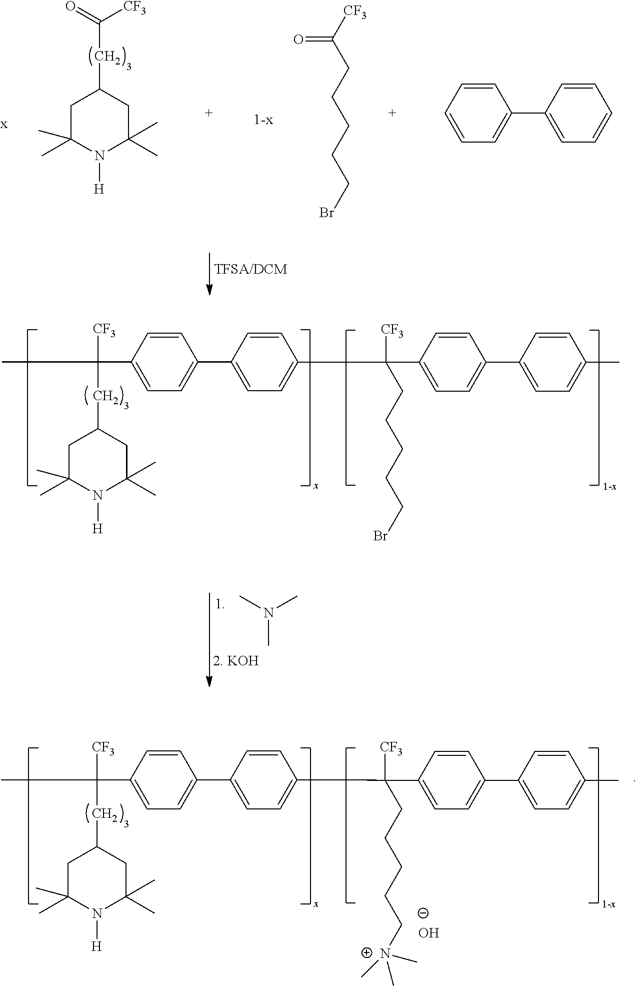

### Example 12

Another oxidation resistant poly(aryl piperidinium) polymer is based on a piperidone monomer of formula (6) (e.g., 4-methyl-1-piperidone), a nitrogen heterocycle-aryl monomer of formula (4_{ORG}) (e.g., 1,1,3,3-tetramethylisoinodline), and an aromatic monomer of formula (3) (e.g., terphenyl) according to the third and fourth aspects of the invention. The reaction scheme for the polymer synthesis is shown below:

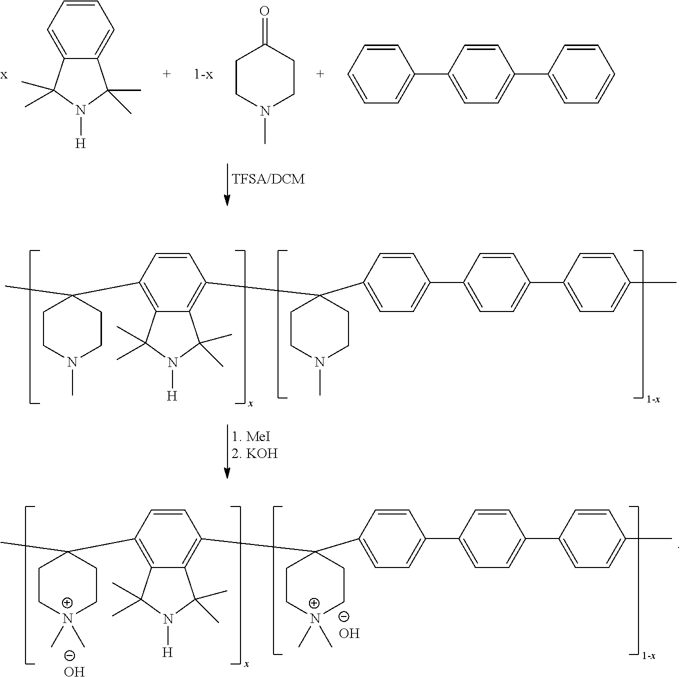

### Example 13

Another oxidation resistant poly(aryl piperidinium) polymer is based on 4-methyl-piperidone, 2,2,2-trifluoroacetophenone, terphenyl and MQN-TMPH-C2 according to the fifth aspect of the invention. The reaction scheme for the polymer synthesis is shown below:

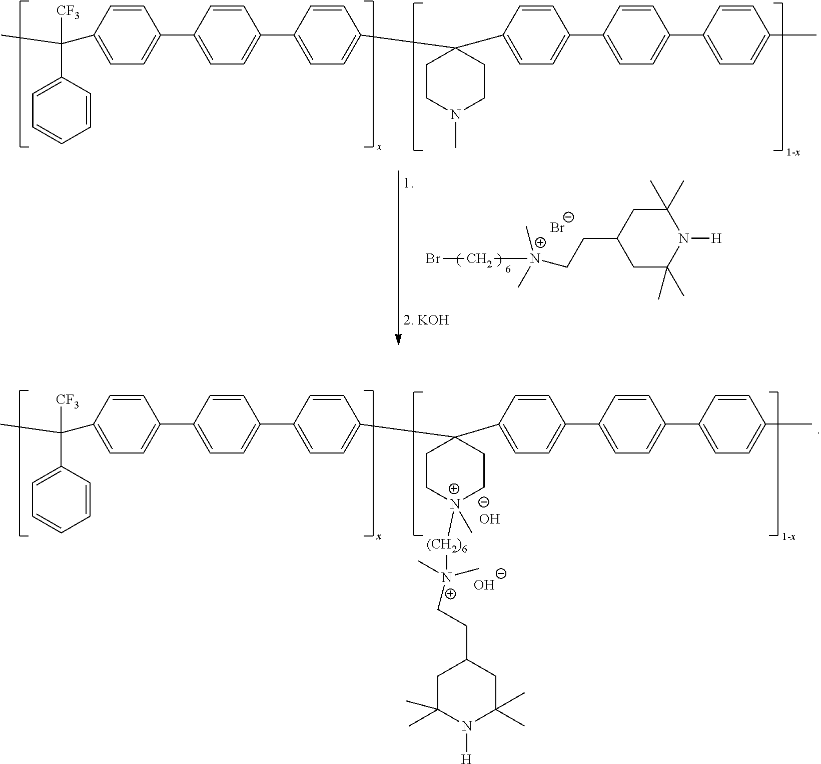

### Example 14

Another oxidation resistant poly(aryl piperidinium) polymer is based on 4-methyl-piperidone, 2,2,2-trifluoroacetophenone, terphenyl, iodomethane and MQN-TMPH-C2 according to the fifth aspect of the invention. The reaction scheme for the polymer synthesis is shown below:

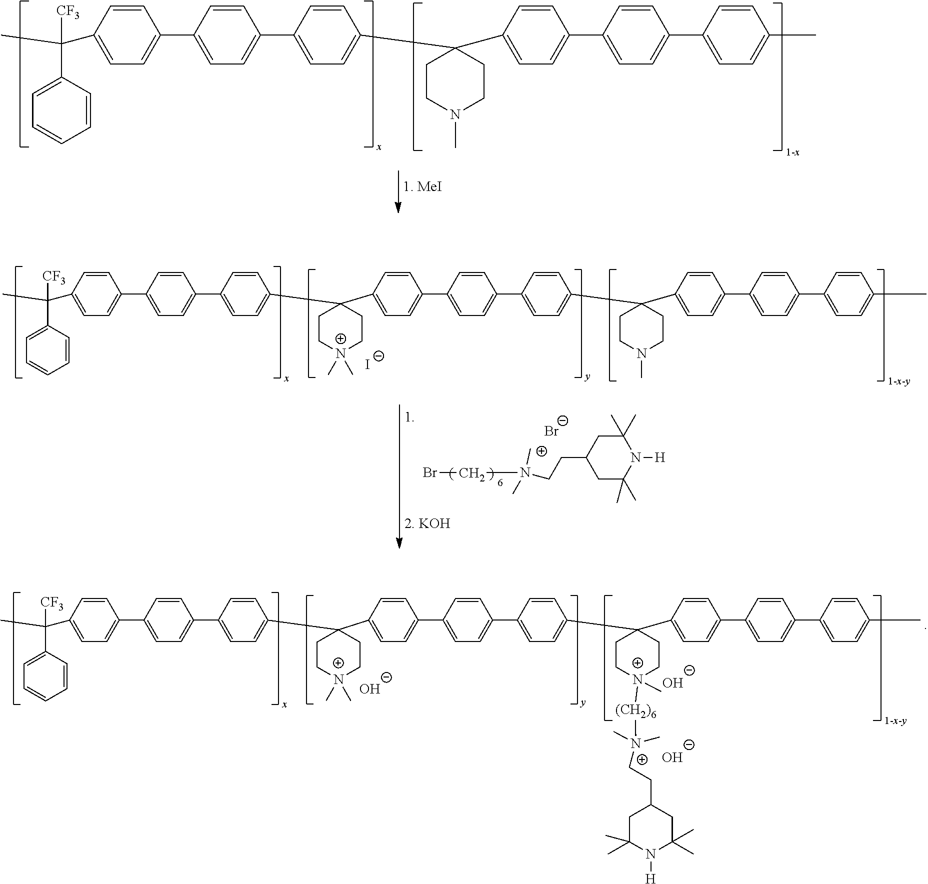

### Example 15

Another oxidation resistant poly(aryl piperidinium) polymer is based on 4-methyl-piperidone, 2,2,2-trifluoroacetophenone, terphenyl, iodomethane and bromohexenyl TMPH ether according to the fifth aspect of the invention.

### Example 16

Another oxidation resistant polybenzimidazole polymer is based on polybenzimidazole, MQN-TMPH, sodium hydride and potassium hydroxide according to the ninth aspect of the invention. The reaction schemes for the polymer syntheses of Examples 15 and 16 are shown below:

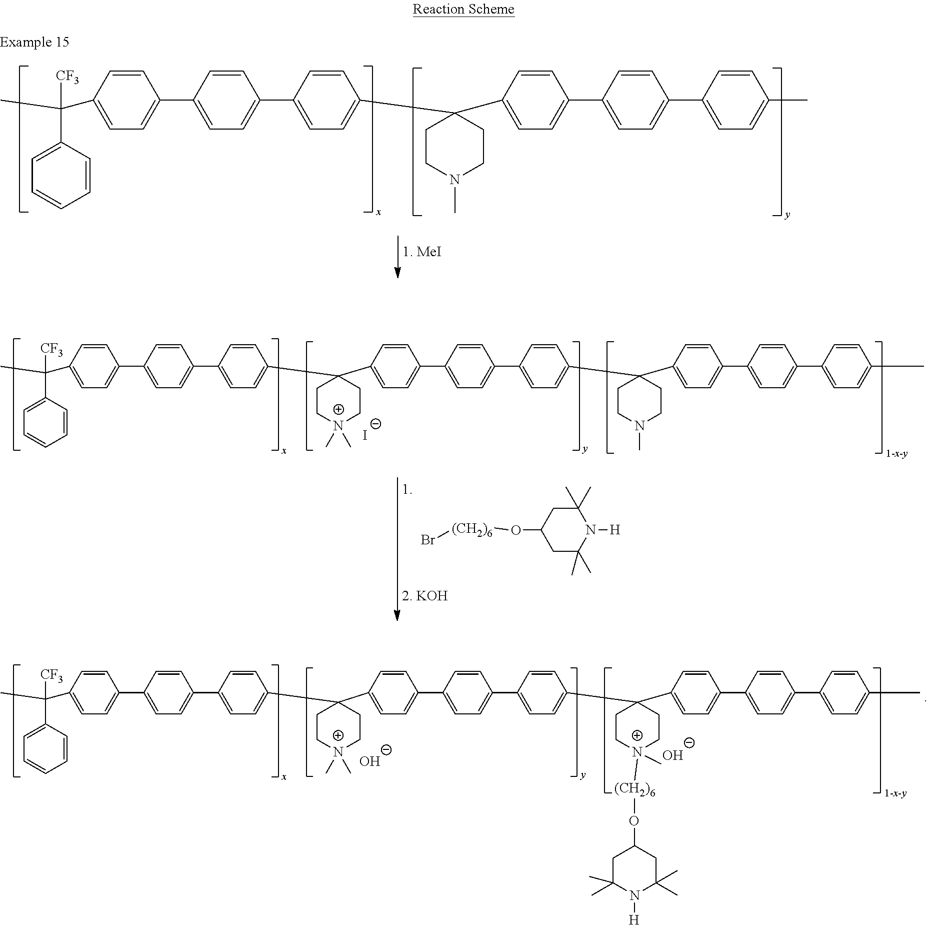

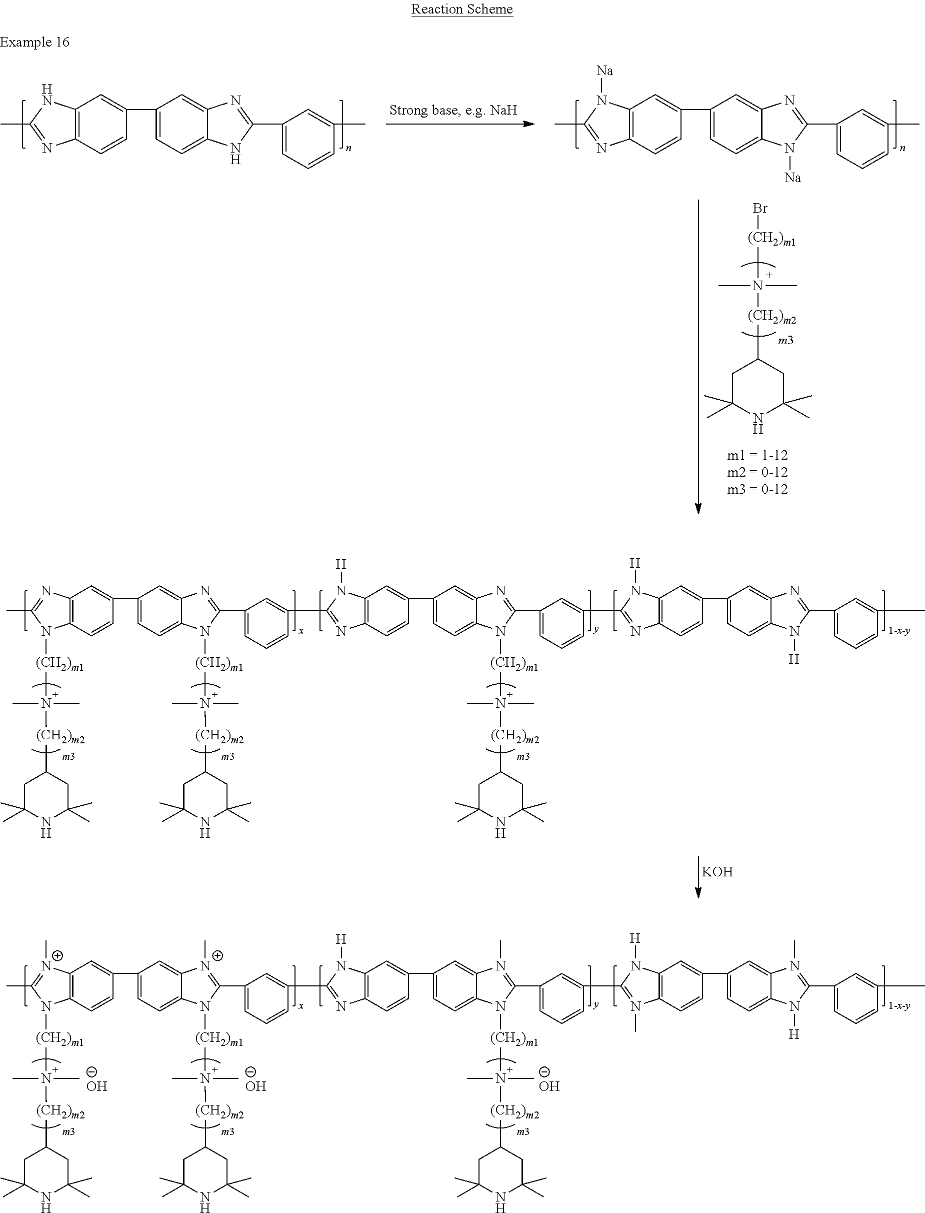

### Example 17

Another oxidation resistant polymer is based on a polyfluorene derivative according to the eighth aspect of the invention. The reaction scheme for the small molecule and polymer synthesis is shown below:

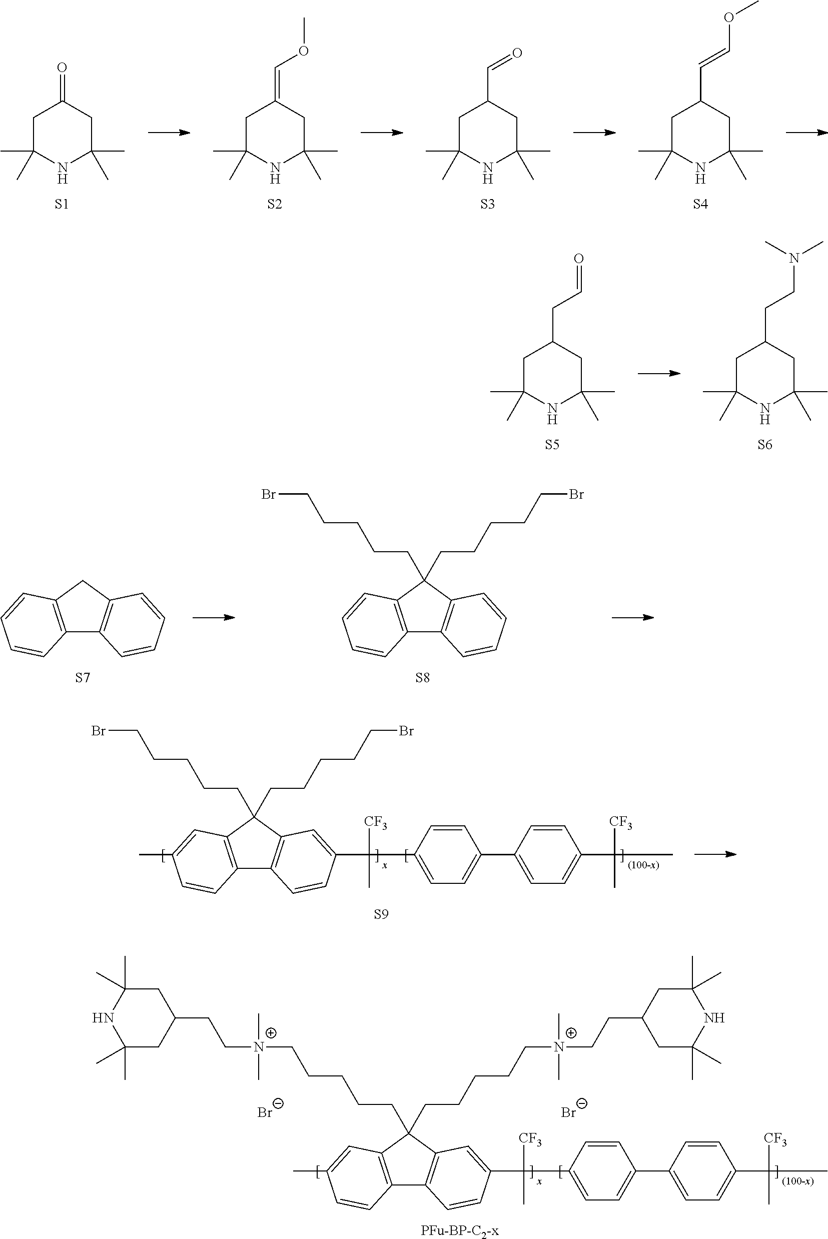

### Synthesis of S3:

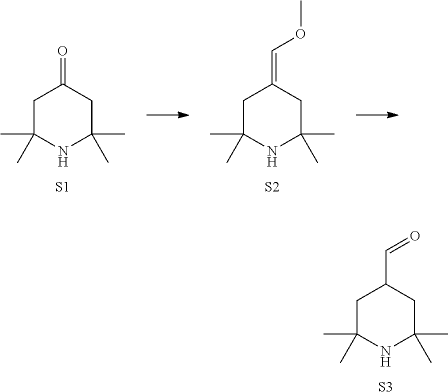

A solution of KOtBu (16 mmol) in THF (10 m1) was added into a solution of (methoxymethyl)triphenylphosphonium chloride (15 mmol) in THF (10 mL) at 0° C. under nitrogen. The solution was stirred for another hour before the solution of S1 (10 mmol) in THF (5 mL) was added dropwise. The mixture was warmed to room temperature and stirred until the S1 was fully consumed. Aqueous HCl (35%, 3 mL) was added to the mixture and the mixture was stirred until S2 was fully consumed. After the solvent was removed under vacuum, the mixture was extracted by dichloromethane (20 mL*3). The combined aqueous extract was basified by NaHCO₃, and extracted by dichloromethane (20 mL*3), the combined organic extracted was washed by water, dried over MgSO₄, and concentrated into a brown solid S3 and used directly for the next step.

### Synthesis of S5:

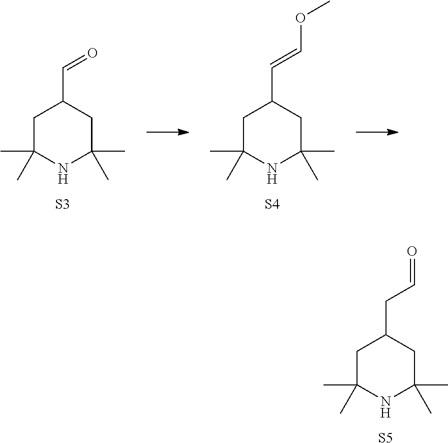

A solution of KOtBu (16 mmol) in THF (10 ml) was added into a solution of (methoxymethyl)triphenylphosphonium chloride (15 mmol) in THF (10 mL) at 0° C. under nitrogen. The solution was stirred for another hour before the solution of S3 (10 mmol) in THF (5 mL) was added dropwise. The mixture was warmed to room temperature and stirred until the S3 was fully consumed. Aqueous HCl (35%, 3 mL) was added to the mixture and the mixture was stirred until S4 was fully consumed. After the solvent was removed under vacuum, the mixture was extracted by dichloromethane (20 mL*3). The combined aqueous extract was basified by NaHCO₃, and extracted by dichloromethane (20 mL*3), the combined organic extracted was washed by water, dried over MgSO₄, and concentrated into a brown liquid S5 and used directly for the next step.

### Synthesis of S6:

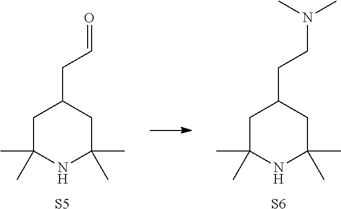

Dimethylamine hydrochloride (21.7 mmol) and KOH (0.47 g) were added into a flask under nitrogen. Methanol (5 mL) was added at 0° C. and the mixture was stirred at room temperature until the base was dissolved. S5 (5.54 mmol) in methanol (2.5 mL) was added and the suspension was heated at 50° C. for 45 min. A solution of sodium cyanoborohydride (21.7 mmol) in methanol (5 mL) was added over 45 min at 50° C. The mixture was stirred for another hour and then cooled to 0° C. KOH (77 mmol) was added. The mixture was stirred until the pellets were dissolved. The mixture was quenched by water. The solvent was removed under vacuum. Then the mixture was extracted by dichloromethane (20 mL*3). The combined organic extract was washed by water (20 mL), saturated NaCl aq. (5 mL), and dried over Na₂SO₄. The solvent was removed under vacuum. And the residue was purified by distillation to provide a colorless oil S6.

### Synthesis of S8:

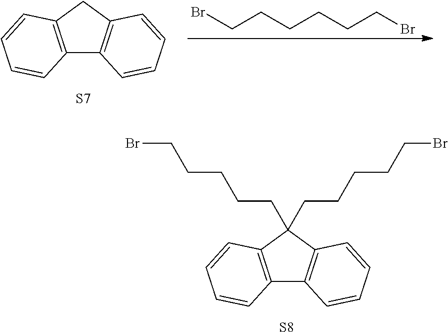

Fluorene (S7, 24 mmol) and tetrabutylammonium bromide (3 mmol) were added to a flask. The flask was deggased for three time. 50% aq. NaOH (20 mL) was added into the flask under nitrogen. 1,5-dibromopentane was added dropwise at 70° C. The mixture was stirred for another 4 h before cooled to room temperature and extracted by dichloromethane (20 mL*3). The combined organic extract was washed by water, dried over MgSO₄. The solvent was removed under vacuum. The crude mixture was purified by column chromatography with hexane as eluent. And the desired white solid product S8 was obtained.

### Synthesis of S9:

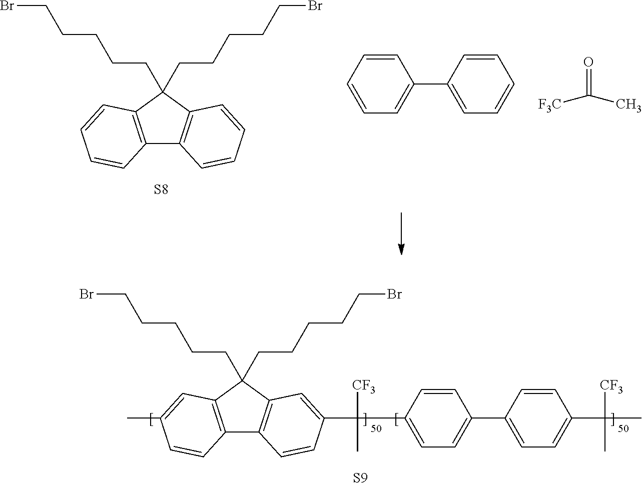

S8 (10 mmol), biphenyl (10 mmol) and 1,1,1-Trifluoroacetone (13 mmol) were dissolved in dichloromethane (mL) in a flask. Trifluoromethanesulfonic acid (mL) was added dropwise at 0° C. The mixture was stirred for 4 h and was poured into ethanol. The white polymer was filtered and dried at room temperature under vacuum overnight.

### Synthesis of S8:

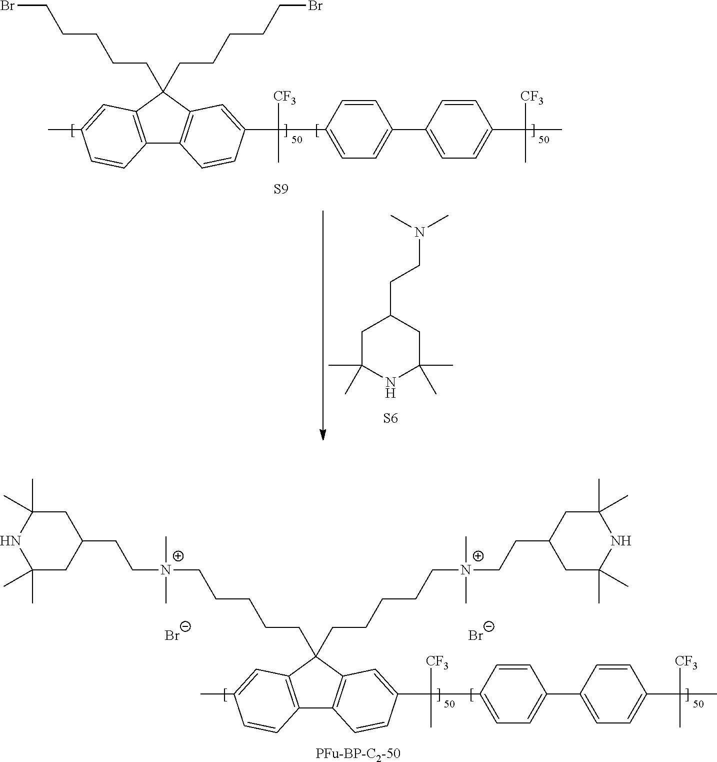

S9 (5 mmol) was dissolved in methylpyrrolidone (20 mL) at room temperature. S6 (50 mmol) was added. The reaction mixture was stirred for 12 h. The mixture was poured into tetrahydrofuran. The white polymer PFu-BP-C2-50 was filtered and dried at room temperature under vacuum overnight.

### The Oxidative Stability of the Pfu-TMA and PFu-BP-C2-TEMPO:

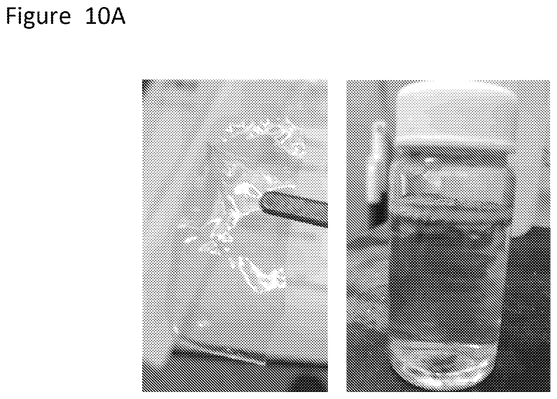

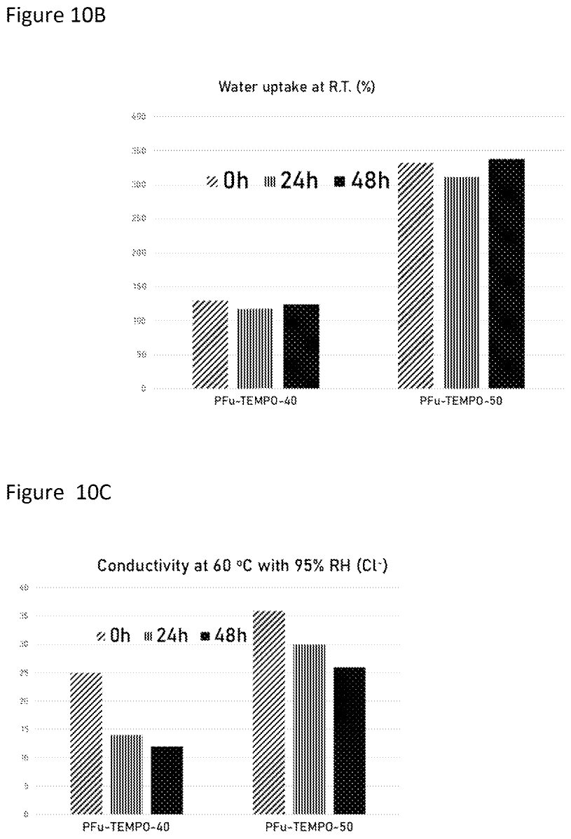

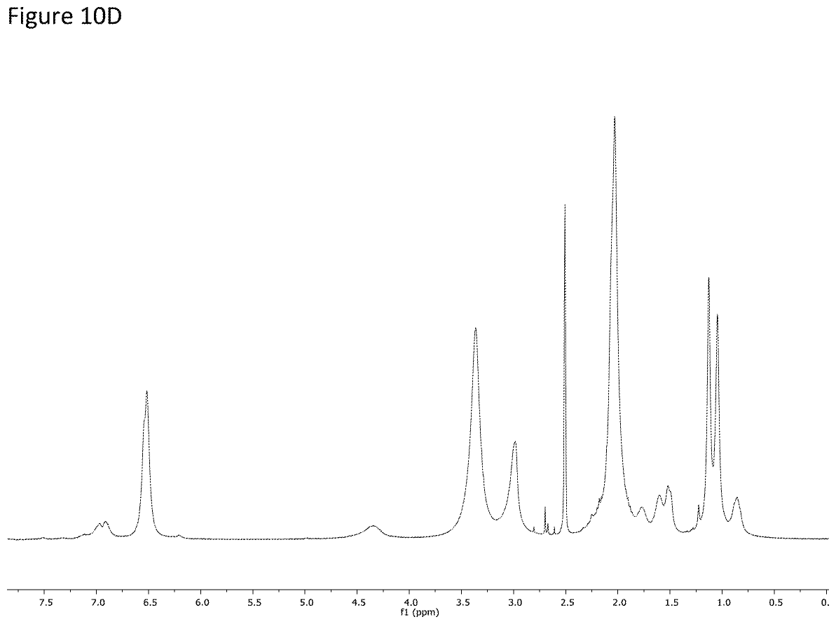

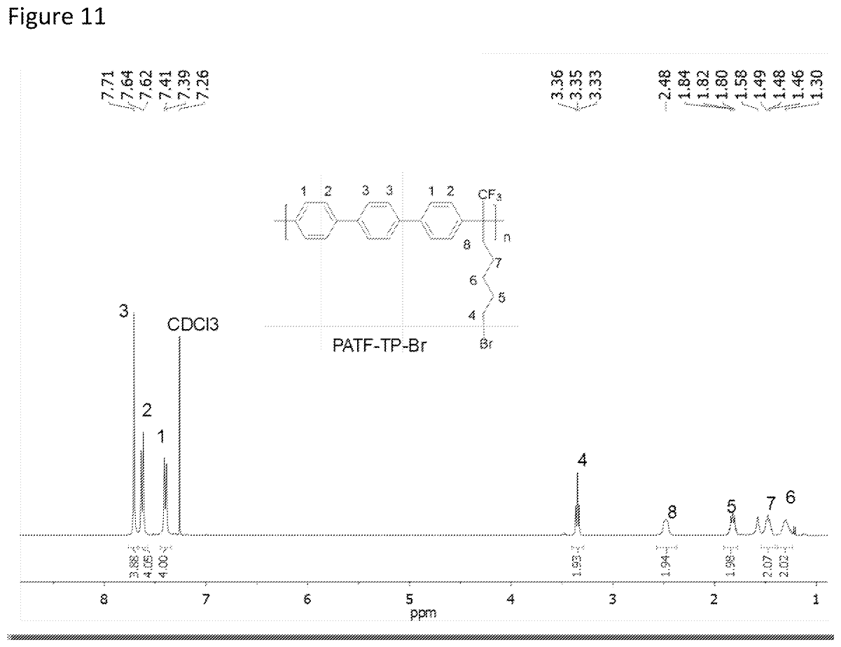

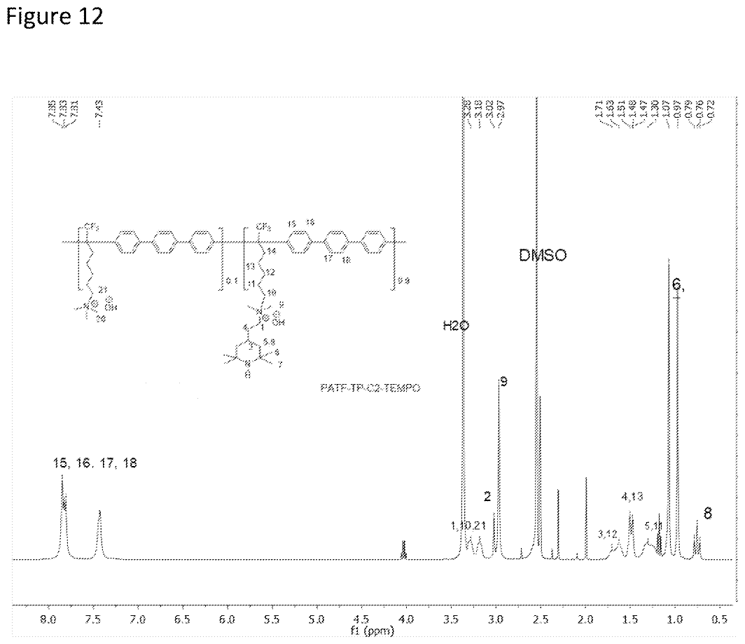

The anion exchange membranes in HCO3⁻ form was contemplated by placing in fresh prepared Fenton's reagent (10 ppm FeSO4 in 10% H₂O₂ solution) at room temperature with 24 h and 48 h. After test, PFu-BP-C2-TEMPO membrane still retained good mechanical properties, whereas PFu-TMA membrane became very brittle and broke into small pieces as shown in FIG. 10A and Table 3. The water uptake of PFu-C2-TEMPO membranes was almost unchanged; however, the conductivity decreased slightly as shown in FIG. 10B and FIG. 10C.

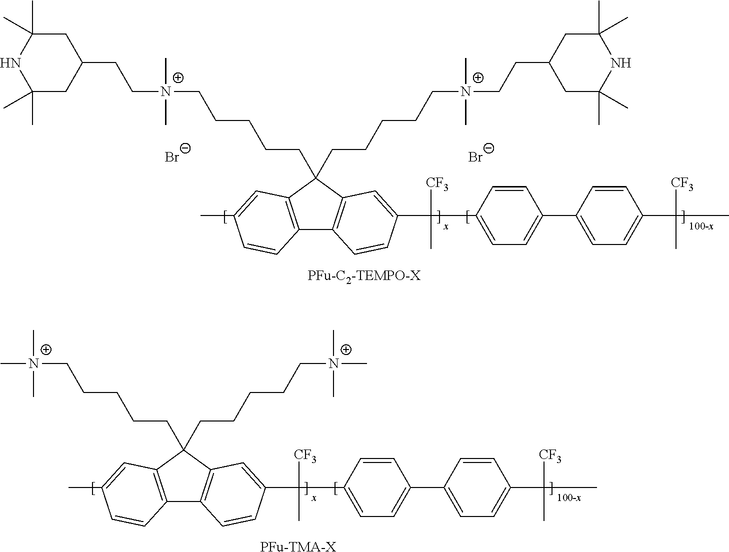

TABLE 3
Membrane stability test in Fenton’s reagent

| | Time (Hours) | | | |
|---|---|---|---|---|
| Membrane | 0 | 24 | 48 | 240 |
| PFu-TMA-40 | Flexible | Brittle | Broken | Dissolved |
| | | | into pieces | |
| PFu-TMA-50 | Flexible | Brittle | Broken | Dissolved |
| | | | into pieces | |
| PFu-C2- | Flexible | Flexible | Flexible | Flexible |
| TEMPO-40 | | | (light yellow) | (light yellow) |
| PFu-C2- | Flexible | Flexible | Flexible | Flexible |
| TEMPO-40 | | | (light yellow) | (light yellow) |

### Example 18

Another example of oxidation resistant HEM is a PPO based polymer, PPO-C2-TEMPO, according to the eighth aspect of the invention. Synthesis is detailed below:

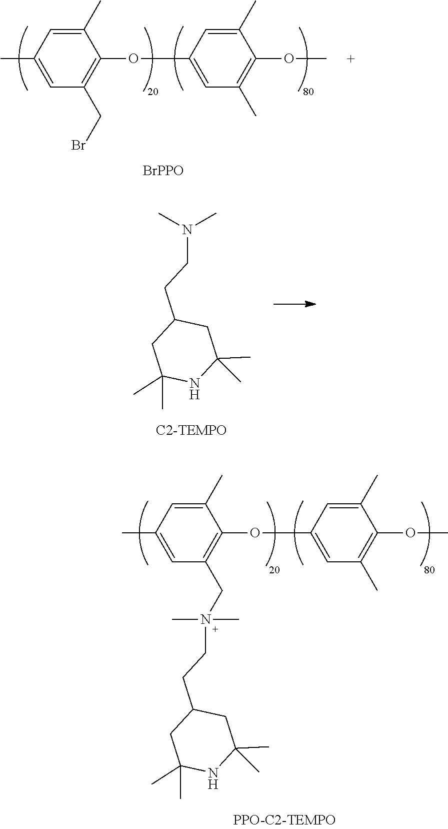

Synthesis of PPO-C2-TEMPO. BrPPO (1 g) was dissolved in methylpyrrolidone (20 mL) at room temperature. C2-TEMPO (0.62 g) was added. The reaction mixture was stirred for 24 h at room temperature. The mixture was poured into tetrahydrofuran. The yellow polymer PPO-C2-TEMPO was filtered and washed by THF three times, then was dried at 60° C. under vacuum 24 h.

### Example 19

Another oxidation resistant HEM is based on a Friedel-Crafts reaction of tert-phenyl, a TEMPO derivative and 7-bromo-1,1,1-trifluoroheptan-2-one. Poly(aryl trifluoromethyl ketone) polymer (PATF-TP-Br) was synthesized by three major steps: (1) Friedel-Crafts reaction of tert-phenyl and 7-bromo-1,1,1-trifluoroheptan-2-one to prepare PATF-TP-Br, (2) quaternization of PATF-TP-Br with C2-TEMPO first, then with trimethyl amine, and (3) hydroxide ion exchange. The reaction scheme is shown below:

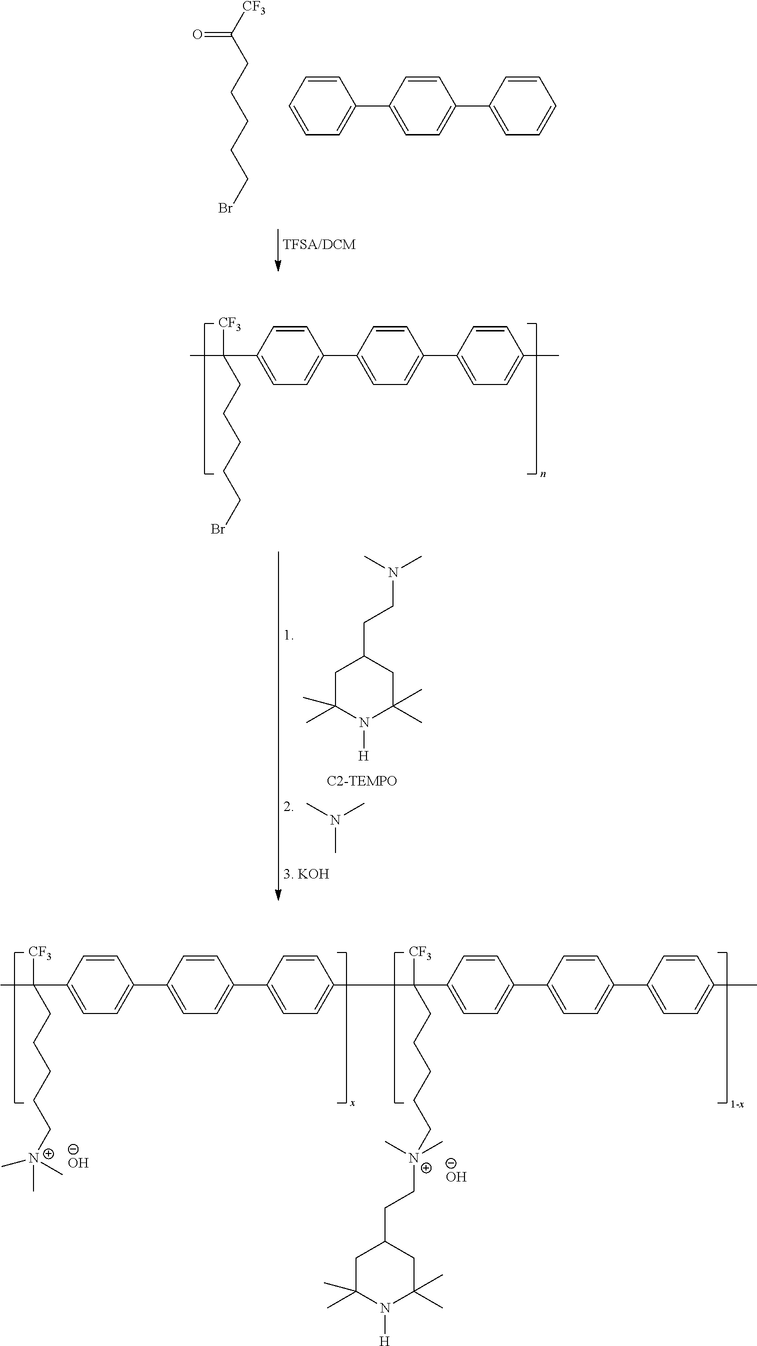

(1) Synthesis of PATF-TP-Br. To a 100 mL three-necked flask equipped with overhead mechanical stirrer, tert-phenyl (25.0 g, 108.6 mmol), and 7-bromo-1,1,1-trifluoroheptan-2-one (26.84 g, 108.6 mmol) were dissolved into methylene chloride (127 mL). Trifluoromethanesulfonic acid (TFSA) (1270 mL) were then added dropwise over 30 minutes at 0° C. Thereafter, the reaction was continued at this temperature for 12 hours. The resulting viscous, brown solution was poured slowly into an aqueous solution of ethanol. The white fibrous solid was filtered, washed with water and immersed in 1 M K2CO3 at room temperature for 12 hours. Finally, the white fibrous product was filtered, washed with water and dried completely at 60° C. under vacuum. The yield of the polymer was nearly 100%. 1H NMR (CDCl3-d3, δ, ppm): 7.71 (4H), 7.62 (4H), 7.40 (4H), 3.35 (2H), 2.48 (2H), 1.82 (2H), 1.48 (2H), 1.30 (2H).

(2) Quaternization of PATF-TP-Br. To a 50 mL one-necked flask equipped with magnetic bar, PATF polymer (1.0 g, 2.18 mmol), C2-TEMPO (481 mg, 2.18 mmol) was dissolved into DMSO (20 mL). After stirring at r.t. for 24 h, trimethyl amine (257.24 mg, 5.3 mmol) was added quickly. The solution was stirred over 12 hours at room temperature. The resulting solution was added dropwise into ether. The yellow solid was filtered, washed with ether and dried completely at 60° C. under vacuum. The yield of the polymer PATF-TP-C2-TEMPO-0.9 was 82%. 1H NMR (DMSO-d6, δ, ppm): 7.85-7.43 (12H), 3.28 (2H), 3.18 (2H), 3.02 (0.98H), 2.97 (5.4H), 1.71-1.63 (3.0H) 1.51-1.48 (3.7H), 1.30 (4H), 1.07-0.97 (11.9H), 0.76 (1.8H).

### Definitions

The substituents associated with the compounds of formulae (1)-(12), (1A)-(9A), (8A-1) and (9A-1) are defined as follows:
[symbol] represents a polymer backbone comprising at least one polyaryletherketone (PAEK) derivative, polysulfone (PSU) derivative, polystyrene (PS) derivative, poly(p-phenylene oxide) derivative, styrene-ethylene-butylene-styrene(SEBS) derivative, polyethylene derivative, poly(norbornene) derivative, or poly(aryl alkylene) derivative structural unit;
A is aryl;
m is 0, 1, 2, 4, 5, 6, 7, 8, 9, or 10;
m1, m2, and m6 are each independently 0, 1, 2, 3, 4, 5, 6, 7, 8, 9, 10, 11 or 12;
m3, m4, m5, and m7 are each independently 0, 1, 2, 3, or 4;
m8 and m10 are each independently 0, 1, 2, 3, or 4;
m9 is each independently 0, 1, 2, 3, 4, 5, 6, 7, 8, 9, 10, 11 or 12;
n is 1, 2, 3, 4, 5, 6, 7 or 8;
n₁ is 1, 2, 3, or 4;
n₂ is 0, 1, 2, 3 or 4;
n3 and n5 are each independently 1, 2, 3, 4, 5, 6, 7, 8, 9 or 10;
n4 is 0, 1, 2, 3, 4, 5, 6, 7, 8, 9 or 10;
q is 0, 1, 2, 3, 4, 5, 6, 7, 8, 9, 10, 11, 12, 13, 14, 15, 16, 17, 18, 19, or 20;
Q is N or P;
R₁, R₁₃, and R₁₈ are each independently alkylene, alkenylene, alkynylene, or arylene, and the alkylene, alkenylene, alkynylene, or arylene are optionally substituted with halide, or R₁₃ is absent;
R₂ and R₁₉ are each independently —NH₂, —NHR₃, —NR₃R₄, —N—O, —N—S or a nitrogen-containing heterocycle wherein a nitrogen of the heterocycle has an oxygen, sulfur or hydrogen substituent;
R₃ and R₄ are each independently, alkyl, alkenyl, alkynyl or aryl, and the alkyl, alkenyl, alkynyl or aryl are optionally substituted with halide;
R₅, R₆, R₇, R₈, R₉, R₁₀, R₁₁, and R₁₂ are each independently hydrogen, halide, alkyl, alkenyl, alkynyl or aryl, and the alkyl, alkenyl, alkynyl or aryl are optionally substituted with halide, and wherein R₆ and R₉ are optionally linked to form a five membered ring optionally substituted with halide or alkyl;
R₁₄ and R₁₅ are each independently hydrogen, halide, alkyl, alkenyl, alkynyl or aryl, and the alkyl, alkenyl, alkynyl or aryl are optionally substituted with halide;
R₁₆ and R₁₇ are independently alkylene optionally substituted with halide or alkyl;
each R₂₀ is independently hydrogen, hydroxyl, halide, alkyl, alkenyl, alkynyl or aryl, and the alkyl, alkenyl, alkynyl or aryl are optionally substituted with halide;
each R₂₁ is independently alkyl, alkenyl, or alkynyl, or a substituent of formula (8A-1):

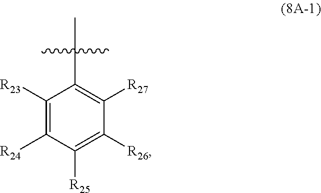

and the alkyl, alkenyl, or alkynyl are optionally substituted with halide;
R₂₂ is a halide, or a quaternary ammonium or phosphonium group or a nitrogen-containing heterocyclic group or a salt thereof, the quaternary ammonium or phosphonium group having the formula (9A-1):

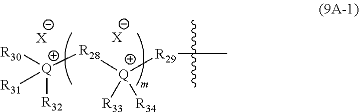

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₃, R₂₄, R₂₅, R₂₆, and R₂₇ are each independently hydrogen, halide, alkyl, alkenyl, alkynyl or aryl, and the alkyl, alkenyl, alkynyl or aryl are optionally substituted with halide;
R₂₈ and R₂₉ are each independently alkylene;
R₃₀, R₃₁, R₃₂, R₃₃, and R₃₄ are each independently alkyl, alkenyl, or alkynyl;
R₃₅, R₃₆, R₃₇, R₄₀, R₄₁, R₄₂, and R₄₃ are each independently alkylene, arylene, alkenylene, alkynylene, ether, thioether, keto, amino, ammonium, or piperidinyl, and the alkylene, arylene, alkenylene or alkynylene are optionally substituted with halide;
R₃₈ is halide, mesylate, tosylate, azide, alkenyl, alkynyl and R₃₉ is an amine, a phosphine, thiol, hydroxyl, alkenyl or alkynyl; or R₃₈ is an amine, a phosphine, thiol, hydroxyl, alkenyl or alkynyl and R₃₉ is halide, mesylate, tosylate, azide, alkenyl, or alkynyl;
R₄₄ is —NH₂, —NHR₄₅, —NR₄₅R₄₆, —N—O, —N—S or a nitrogen-containing heterocycle wherein a nitrogen of the heterocycle has an oxygen, sulfur or hydrogen substituent;
R₄₅ and R₄₆ are each independently, alkyl, alkenyl, alkynyl or aryl, and the alkyl, alkenyl, alkynyl or aryl are optionally substituted with halide;
R₄₇ is halide, mesylate, tosylate, azide, alkenyl, alkynyl;
R₄₈, R₄₉, R₅₀, and R₅₁ are each independently alkylene, arylene, alkenylene, alkynylene, ether, thioether, keto, amino, ammonium, or piperidinyl, and the alkylene, arylene, alkenylene or alkynylene are optionally substituted with halide;
R₅₂ is —NH₂, —NHR₅₃, —NR₅₃R₅₄, —N—O, —N—S or a nitrogen-containing heterocycle wherein a nitrogen of the heterocycle has an oxygen, sulfur or hydrogen substituent; and
R₅₃ and R₅₄ are each independently, alkyl, alkenyl, alkynyl or aryl, and the alkyl, alkenyl, alkynyl or aryl are optionally substituted with halide.
R₅₅, R₅₆, R₅₇ and R₅₈ are each independently hydrogen, halide, alkyl, alkenyl, alkynyl or aryl, and the alkyl, alkenyl, alkynyl or aryl are optionally substituted with halide;
R₅₉ is —(CH₂)ₙ₃-[Q(R₆₀)(R₆₁)—(CH₂)ₙ₄]ₙ₅-R₆₂ or —[(CH₂)ₙ₃—O]ₙ₅-R₆₂;
R₆₀ and R₆₁ are each independently alkyl, alkenyl or alkynyl; and
R₆₂ is a nitrogen-containing heterocycle wherein a nitrogen of the heterocycle has an oxygen, sulfur or hydrogen substituent;
X⁻ is an anion; and
Z is independently hydrogen, hydroxyl, oxygen or sulfur.

The terms anion exchange membranes/ionomers/polymers are used interchangeably with hydroxide exchange membranes/ionomers/polymers.

The term “suitable substituent,” as used herein, is intended to mean a chemically acceptable functional group, preferably a moiety that does not negate the activity of the inventive compounds. Such suitable substituents include, but are not limited to halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C—O)— groups, heterocyclic groups, cycloalkyl groups, amino groups, alkyl—and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

The term “alkyl,” as used herein, refers to a linear, branched or cyclic hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons), and more preferably having 1 to 18 carbon atoms. Alkyl groups include, but are not limited to, methyl, ethyl, n-propyl, isopropyl, n-butyl, iso-butyl, secondary-butyl, and tertiary-butyl. Alkyl groups can be unsubstituted or substituted by one or more suitable substituents.

The term “alkenyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups can be unsubstituted or substituted by one or more suitable substituents, as defined above.

The term “alkynyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon triple bonds. Alkynyl groups include, but are not limited to, ethynyl, propynyl, and butynyl. Alkynyl groups can be unsubstituted or substituted by one or more suitable substituents, as defined above.

The term “aryl” or “ar,” as used herein alone or as part of another group (e.g., aralkyl), means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above. The term “aryl” also includes heteroaryl.

“Arylalkyl” or “aralkyl” means an aryl group attached to the parent molecule through an alkylene group. The number of carbon atoms in the aryl group and the alkylene group is selected such that there is a total of about 6 to about 18 carbon atoms in the arylalkyl group. A preferred arylalkyl group is benzyl.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1]octanyl and bicyclo[5.2.0]nonanyl, etc.); optionally containing 1 or 2 double bonds. Cycloalkyl groups can be unsubstituted or substituted by one or more suitable substituents, preferably 1 to 5 suitable substituents, as defined above.

The term “-ene” as used as a suffix as part of another group denotes a bivalent radical in which a hydrogen atom is removed from each of two terminal carbons of the group, or if the group is cyclic, from each of two different carbon atoms in the ring. For example, alkylene denotes a bivalent alkyl group such as ethylene (—CH₂CH₂—) or isopropylene (—CH₂(CH₃)CH₂—). For clarity, addition of the -ene suffix is not intended to alter the definition of the principal word other than denoting a bivalent radical. Thus, continuing the example above, alkylene denotes an optionally substituted linear saturated bivalent hydrocarbon radical.

The term “ether” as used herein represents a bivalent (i.e., difunctional) group including at least one ether linkage (i.e., —O—).

The term “heteroaryl,” as used herein, refers to a monocyclic, bicyclic, or tricyclic aromatic heterocyclic group containing one or more heteroatoms (e.g., 1 to 3 heteroatoms) selected from O, S and N in the ring(s). Heteroaryl groups include, but are not limited to, pyridyl, pyrazinyl, pyrimidinyl, pyridazinyl, thienyl, furyl, imidazolyl, pyrrolyl, oxazolyl (e.g., 1,3-oxazolyl, 1,2-oxazolyl), thiazolyl (e.g., 1,2-thiazolyl, 1,3-thiazolyl), pyrazolyl, tetrazolyl, triazolyl (e.g., 1,2,3-triazolyl, 1,2,4-triazolyl), oxadiazolyl (e.g., 1,2,3-oxadiazolyl), thiadiazolyl (e.g., 1,3,4-thiadiazolyl), quinolyl, isoquinolyl, benzothienyl, benzofuryl, and indolyl. Heteroaryl groups can be unsubstituted or substituted by one or more suitable substituents, preferably 1 to 5 suitable substituents, as defined above.

The term “hydrocarbon” as used herein describes a compound or radical consisting exclusively of the elements carbon and hydrogen.

The term “substituted” means that in the group in question, at least one hydrogen atom bound to a carbon atom is replaced with one or more substituent groups such as hydroxy (—OH), alkylthio, phosphino, amido (—CON(RA)(RB), wherein RA and RB are independently hydrogen, alkyl, or aryl), amino (—N(RA)(RB), wherein RA and RB are independently hydrogen, alkyl, or aryl), halo (fluoro, chloro, bromo, or iodo), silyl, nitro (—NO₂), an ether (—ORA wherein RA is alkyl or aryl), an ester (—OC(O)RA wherein RA is alkyl or aryl), keto (—C(O)RA wherein RA is alkyl or aryl), heterocyclo, and the like. When the term “substituted” introduces or follows a list of possible substituted groups, it is intended that the term apply to every member of that group. That is, the phrase “optionally substituted alkyl or aryl” is to be interpreted as “optionally substituted alkyl or optionally substituted aryl.” Likewise, the phrase “alkyl or aryl optionally substituted with fluoride” is to be interpreted as “alkyl optionally substituted with fluoride or aryl optionally substituted with fluoride.”

The term “tethered” means that the group in question is bound to the specified polymer backbone. For example, an imidazolium-tethered poly (aryl alkylene) polymer is a polymer having imidazolium groups bound to a poly (aryl alkylene) polymer backbone.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

1. A polymer for providing enhanced oxidative resistance, the polymer comprising structural units of Formulae (1A_{ORG}) and/or (2A_{ORG}), and at least one structural unit of Formulae (3A), (4A_{ORG}) and (5A_{ORG}), wherein the structural units of Formulae (1A_{ORG}), (2A_{ORG}), (3A), (4A_{ORG}) and (5A_{ORG}) have the structures: 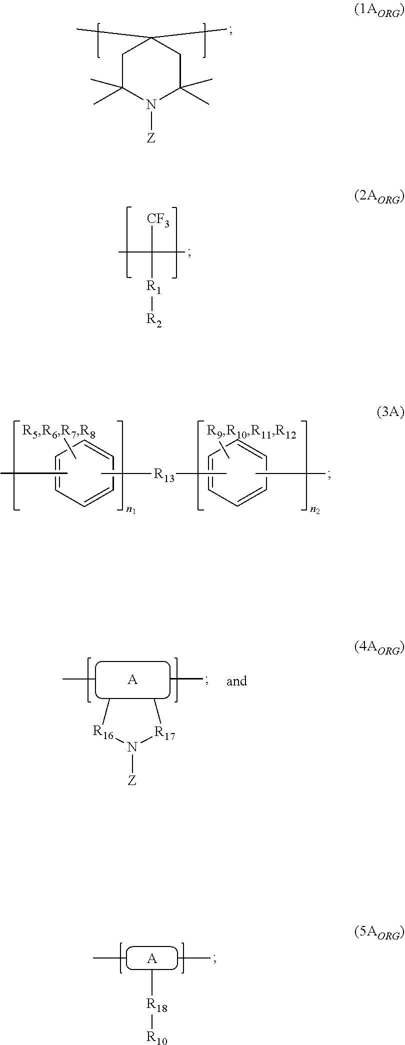
wherein:
A is aryl;
n₁ is 1, 2, 3, or 4;
n₂ is 0, 1, 2, 3 or 4;
R₁, R₁₃, and R₁₈ are each independently alkylene, alkenylene, alkynylene, or arylene, and the alkylene, alkenylene, alkynylene, or arylene are optionally substituted with halide, or R₁₃ is absent;
R₂ and R₁₉ are each independently —NH₂, —NHR₃, —NR₃R₄, —N—O, —N—S or a nitrogen-containing heterocycle wherein a nitrogen of the heterocycle has an oxygen, sulfur or hydrogen substituent;
R₃ and R₄ are each independently alkyl, alkenyl, alkynyl or aryl, and the alkyl, alkenyl, alkynyl or aryl are optionally substituted with halide;
R₅, R₆, R₇, R₈, R₉, R₁₀, R₁₁, and R₁₂ are each independently hydrogen, halide, alkyl, alkenyl, alkynyl or aryl, and the alkyl, alkenyl, alkynyl or aryl are optionally substituted with halide, and wherein R₆ and R₉ are optionally linked to form a five membered ring optionally substituted with halide or alkyl;
R₁₆ and R₁₇ are independently alkylene optionally substituted with halide or alkyl; and
Z is independently hydrogen, hydroxyl, oxygen or sulfur.

2. The polymer of claim 1, wherein:
a sum of the mole fractions of the structural units of Formulae (1A_{ORG}) and (2A_{ORG}) in the polymer can be about equal to the sum of the mole fractions of structural units of Formulae (3A), (4A_{ORG}), and (5A_{ORG}) in the polymer, and the sum of the mole fractions of the structural units of Formulae 1A and 2A in the polymer to the sum of the mole fractions of the structural units of Formulae (3A), (4A_{ORG}) and (5A_{ORG}) in the polymer can be from about 0.01 to 1; or
a mole ratio of a sum of mole fractions of the structural units of Formulae (1A_{ORG}) and (2A_{ORG}) to the sum of mole fractions of the structural units of Formulae (3A), (4A_{ORG}), and (5A_{ORG}) in the polymer can be from about 0.95:1 to about 1.4:1, and the ratio of the sum of the mole fractions of the structural unit of Formulae (1A_{ORG}) and (2A_{ORG}) to the sum of the mole fractions of the structural unit of Formulae (3A), (4A_{ORG}), and (5A_{ORG}) can be from about 0.01 to 1.

3-4. (canceled)

5. The polymer of claim 1, wherein the structural unit (2A_{ORG}) has the formula

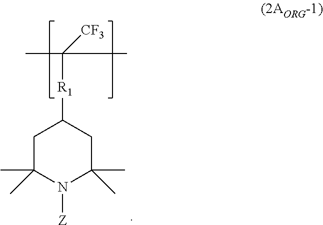

6. The polymer of claim 1, wherein the structural unit (4A_{ORG}) comprises a structural unit having the formula:

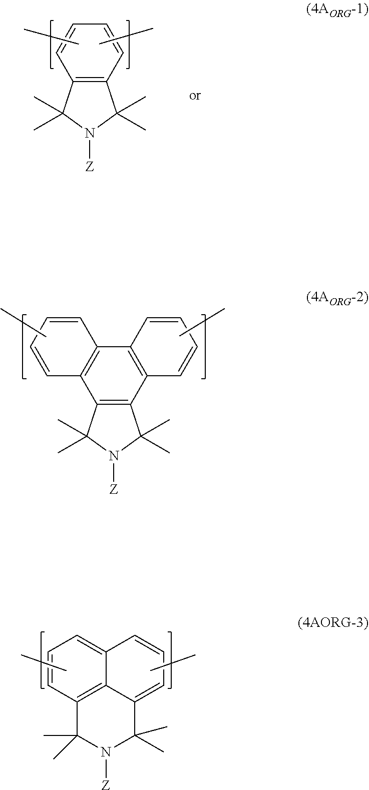

7. (canceled)

8. The polymer of claim 1, wherein the polymer further comprises at least one of the following structural units: 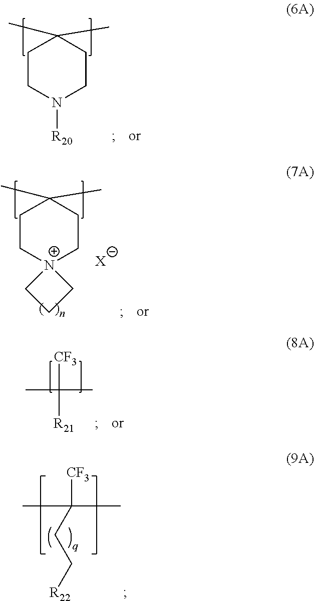
wherein
m is 0, 1, 2, 3, 4, 5, 6, 7, 8, 9, or 10;
n is 1, 2, 3, 4, 5, 6, 7 or 8;
q is 0, 1, 2, 3, 4, 5, 6, 7, 8, 9, 10, 11, 12, 13, 14, 15, 16, 17, 18, 19, or 20;
Q is N or P;
each R₂₀ is independently hydrogen, hydroxyl, halide, alkyl, alkenyl, alkynyl or aryl, and the alkyl, alkenyl, alkynyl or aryl are optionally substituted with halide;
each R₂₁ is independently alkyl, alkenyl, or alkynyl, or a substituent of formula (8A-1): 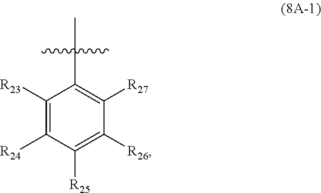
and the alkyl, alkenyl, or alkynyl are optionally substituted with halide;
R₂₂ is a halide, or a quaternary ammonium or phosphonium group or a nitrogen-containing heterocyclic group or a salt thereof, the quaternary ammonium or phosphonium group having the formula (9A-1): 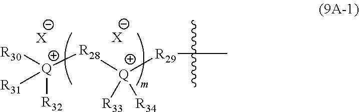
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₃, R₂₄, R₂₅, R₂₆, and R₂₇ are each independently hydrogen, halide, alkyl, alkenyl, alkynyl or aryl, and the alkyl, alkenyl, alkynyl or aryl are optionally substituted with halide;
R₂₈ and R₂₉ are each independently alkylene;
R₃₀, R₃₁, R₃₂, R₃₃, and R₃₄ are each independently alkyl, alkenyl, or alkynyl; and
X⁻ is an anion.

9. A polymer for providing enhanced oxidative resistance, the polymer comprising a reaction product of a polymerization mixture comprising:
(i) a piperidone monomer having the formula: 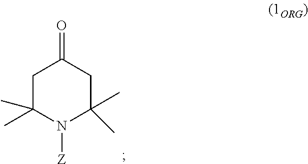
and/or
a trifluoromethyl ketone monomer having the formula 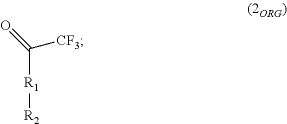
and
(ii) at least one aromatic monomer comprising:
a phenyl-based monomer having the formula: 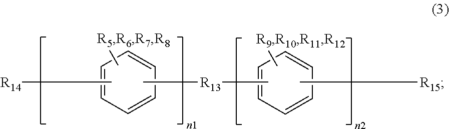
or
a nitrogen heterocycle-aryl monomer having the formula: 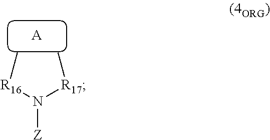
or
an aryl monomer having a nitrogen-containing substituent and having the formula: 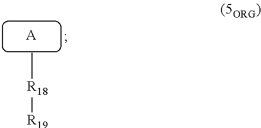
wherein:
A is aryl;
n₁ is 1, 2, 3, or 4;
n₂ is 0, 1, 2, 3 or 4;
R₁, R₁₃, and R₁₈ are each independently alkylene, alkenylene, alkynylene, or arylene, and the alkylene, alkenylene, alkynylene, or arylene are optionally substituted with halide, or R₁₃ is absent;
R₂ and R₁₉ are each independently —NH₂, —NHR₃, —NR₃R₄, —N—O, —N—S or a nitrogen-containing heterocycle wherein a nitrogen of the heterocycle has an oxygen, sulfur or hydrogen substituent;
R₃ and R₄ are each independently alkyl, alkenyl, alkynyl or aryl, and the alkyl, alkenyl, alkynyl or aryl are optionally substituted with halide;
R₅, R₆, R₇, R₈, R₉, R₁₀, R₁₁, R₁₂, R₁₄, and R₁₅ are each independently hydrogen, halide, alkyl, alkenyl, alkynyl or aryl, and the alkyl, alkenyl, alkynyl or aryl are optionally substituted with halide, and wherein R₆ and R₉ are optionally linked to form a five membered ring optionally substituted with halide or alkyl;
R₁₆ and R₁₇ are independently alkylene optionally substituted with halide or alkyl; and
Z is independently hydrogen, hydroxyl, oxygen or sulfur.

10. The polymer of claim 9, wherein the trifluoromethyl ketone monomer (2_{ORG}) has the formula:

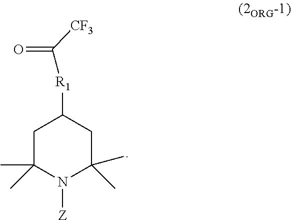

11. The polymer of claim 9, wherein the nitrogen heterocycle-aryl monomer (4_{ORG}) comprises:
an isoindoline monomer having the formula: 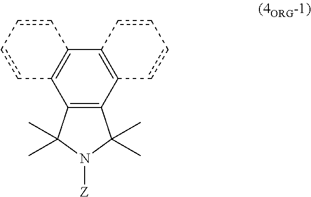
wherein the dibenzo rings are optionally present; or
a benzo[de]isoquinoline monomer having the formula:

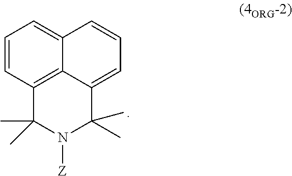

12. (canceled)

13. The polymer of claim 9, wherein the polymerization mixture further comprises at least one of the following monomers:
a piperidone monomer or salt or hydrate thereof having the formula: 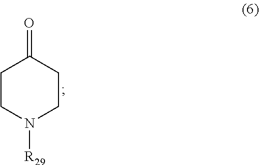
or
an azoniaspiro salt monomer having the formula: 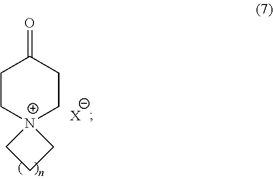
or
a trifluoromethyl ketone monomer having the formula: 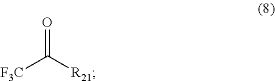
or
a halogenated trifluoromethyl ketone monomer having the formula: 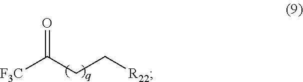
wherein:
m is 0, 1, 2, 3, 4, 5, 6, 7, 8, 9, or 10;
n is 1, 2, 3, 4, 5, 6, 7 or 8;
q is 0, 1, 2, 3, 4, 5, 6, 7, 8, 9, 10, 11, 12, 13, 14, 15, 16, 17, 18, 19, or 20;
Q is N or P;
each R₂₀ is independently hydrogen, hydroxyl, halide, alkyl, alkenyl, alkynyl or aryl, and the alkyl, alkenyl, alkynyl or aryl are optionally substituted with halide;
each R₂₁ is independently alkyl, alkenyl, or alkynyl, or a substituent of formula (8A-1): 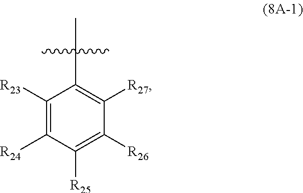
and the alkyl, alkenyl, or alkynyl are optionally substituted with halide;
R₂₂ is a halide, or a quaternary ammonium or phosphonium group or a nitrogen-containing heterocyclic group or a salt thereof, the quaternary ammonium or phosphonium group having the formula (9A-1): 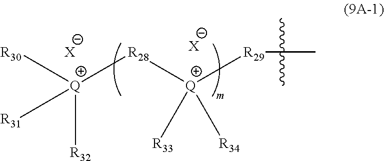
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₃, R₂₄, R₂₅, R₂₆, and R₂₇ are each independently hydrogen, halide, alkyl, alkenyl, alkynyl or aryl, and the alkyl, alkenyl, alkynyl or aryl are optionally substituted with halide;
R₂₈ and R₂₉ are each independently alkylene;
R₃₀, R₃₁, R₃₂, R₃₃, and R₃₄ are each independently alkyl, alkenyl, or alkynyl; and
X⁻ is an anion.

14. A polymer for providing enhanced oxidative resistance, the polymer comprising structural units of Formulae (4A_{ORG}) and/or (5A_{ORG}), and at least one of Formulae (1A_{ORG}), (2A_{ORG}), (6A), (7A), (8A) and (9A), wherein the structural units of Formulae (1A_{ORG}), (2A_{ORG}), (4A_{ORG}, (5A_{ORG}, (6A), (7A), (8A) and (9A) have the structures: 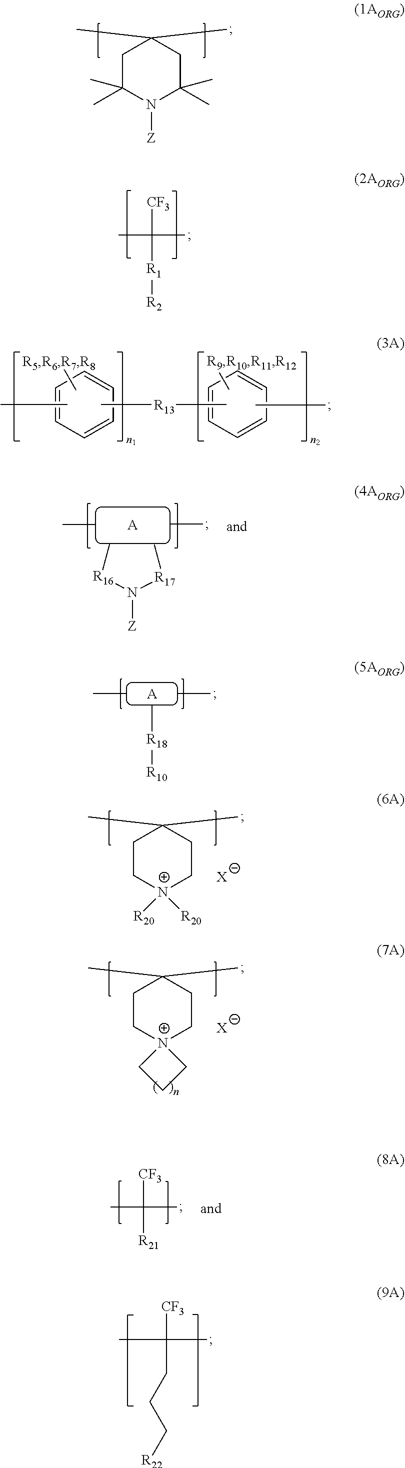
wherein:
A is aryl;
m is 0, 1, 2, 3, 4, 5, 6, 7, 8, 9, or 10;
n is 1, 2, 3, 4, 5, 6, 7 or 8;
q is 0, 1, 2, 3, 4, 5, 6, 7, 8, 9, 10, 11, 12, 13, 14, 15, 16, 17, 18, 19, or 20;
Q is N or P;
R₁ and R₁₈ are each independently alkylene, alkenylene, alkynylene, or arylene, and the alkylene, alkenylene, alkynylene, or arylene are optionally substituted with halide, or R₁₃ is absent;
R₂ and R₁₉ are each independently —NH₂, —NHR₃, —NR₃R₄, —N—O, —N—S or a nitrogen-containing heterocycle wherein a nitrogen of the heterocycle has an oxygen, sulfur or hydrogen substituent;
R₃ and R₄ are each independently alkyl, alkenyl, alkynyl or aryl, and the alkyl, alkenyl, alkynyl or aryl are optionally substituted with halide;
R₁₆ and R₁₇ are independently alkylene optionally substituted with halide or alkyl;
each R₂₀ is independently hydrogen, hydroxyl, halide, alkyl, alkenyl, alkynyl or aryl, and the alkyl, alkenyl, alkynyl or aryl are optionally substituted with halide;
each R₂₁ is independently alkyl, alkenyl, or alkynyl, or a substituent of formula (8A-1): 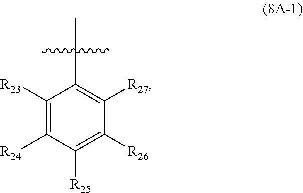
and the alkyl, alkenyl, or alkynyl are optionally substituted with halide;
R₂₂ is a halide, or a quaternary ammonium or phosphonium group or a nitrogen-containing heterocyclic group or a salt thereof, the quaternary ammonium or phosphonium group having the formula (9A-1): 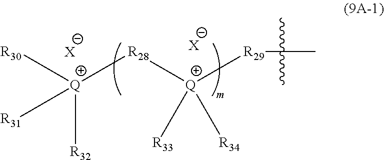
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₃, R₂₄, R₂₅, R₂₆, and R₂₇ are each independently hydrogen, halide, alkyl, alkenyl, alkynyl or aryl, and the alkyl, alkenyl, alkynyl or aryl are optionally substituted with halide;
R₂₈ and R₂₉ are each independently alkylene;
R₃₀, R₃₁, R₃₂, R₃₃, and R₃₄ are each independently alkyl, alkenyl, or alkynyl;
X⁻ is an anion; and
Z is independently hydrogen, hydroxyl, oxygen or sulfur.

15.-21. (canceled)

22. A polymer for providing enhanced oxidative resistance, the polymer comprising a reaction product of a polymerization mixture comprising:
(i) a nitrogen heterocycle-aryl monomer having the formula: 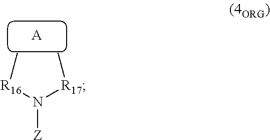
and/or
an aryl monomer having a nitrogen-containing substituent and having the formula: 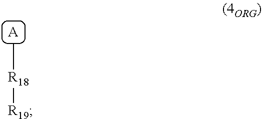
and
(ii) at least one of the following monomers:
a piperidone monomer having the formula: 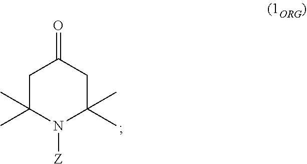
a trifluoromethyl ketone monomer having the formula 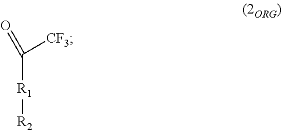
a piperidone monomer or salt or hydrate thereof having the formula: 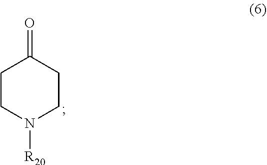
an azoniaspiro salt monomer having the formula: 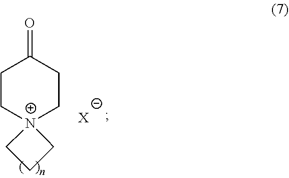
a trifluoromethyl ketone monomer having the formula: 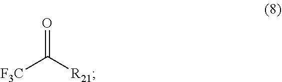
a halogenated trifluoromethyl ketone monomer having the formula: 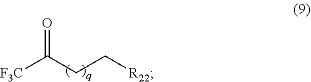
wherein:
A is aryl;
m is 0, 1, 2, 3, 4, 5, 6, 7, 8, 9, or 10;
n is 1, 2, 3, 4, 5, 6, 7 or 8;
q is 0, 1, 2, 3, 4, 5, 6, 7, 8, 9, 10, 11, 12, 13, 14, 15, 16, 17, 18, 19, or 20;
Q is N or P;
R₁ and R₁₈ are each independently alkylene, alkenylene, alkynylene, or arylene, and the alkylene, alkenylene, alkynylene, or arylene are optionally substituted with halide, or R₁₃ is absent;
R₂ and R₁₉ are each independently —NH₂, —NHR₃, —NR₃R₄, —N—O, —N—S or a nitrogen-containing heterocycle wherein a nitrogen of the heterocycle has an oxygen, sulfur or hydrogen substituent;
R₃ and R₄ are each independently alkyl, alkenyl, alkynyl or aryl, and the alkyl, alkenyl, alkynyl or aryl are optionally substituted with halide;
R₁₆ and R₁₇ are independently alkylene optionally substituted with halide or alkyl;
each R₂₀ is independently hydrogen, hydroxyl, halide, alkyl, alkenyl, alkynyl or aryl, and the alkyl, alkenyl, alkynyl or aryl are optionally substituted with halide;
each R₂₁ is independently alkyl, alkenyl, or alkynyl, or a substituent of formula (8A-1): 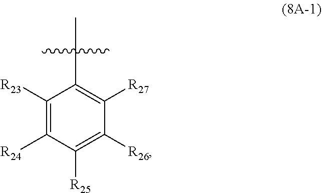
and the alkyl, alkenyl, or alkynyl are optionally substituted with halide;
R₂₂ is a halide, or a quaternary ammonium or phosphonium group or a nitrogen-containing heterocyclic group or a salt thereof, the quaternary ammonium or phosphonium group having the formula (9A-1): 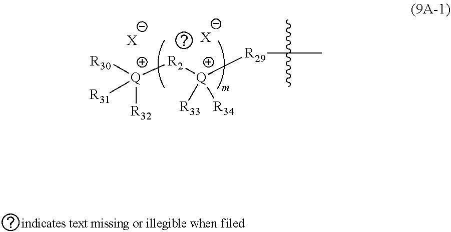
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₃, R₂₄, R₂₅, R₂₆, and R₂₇ are each independently hydrogen, halide, alkyl, alkenyl, alkynyl or aryl, and the alkyl, alkenyl, alkynyl or aryl are optionally substituted with halide;
R₂₈ and R₂₉ are each independently alkylene;
R₃₀, R₃₁, R₃₂, R₃₃, and R₃₄ are each independently alkyl, alkenyl, or alkynyl;
X⁻ is an anion; and
Z is independently hydrogen, hydroxyl, oxygen or sulfur.

23.-26. (canceled)

27. A polymer for providing enhanced oxidative resistance, the polymer comprising a reaction product of a mixture comprising:
(i) a polymer having the formula: 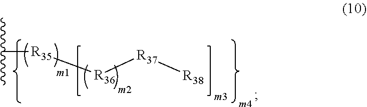
and
(ii) an oxidation resistant group (ORG)-containing compound having the formula: 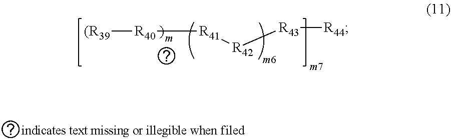
wherein: [symbol]
represents a polymer backbone comprising at least one polyaryletherketone (PAEK) derivative, polysulfone (PSU) derivative, polystyrene (PS) derivative, poly(p-phenylene oxide) derivative, styrene-ethylene-butylene-styrene(SEBS) derivative, polyethylene derivative, poly(norbornene) derivative, a polycyclic aromatic derivative, or poly(aryl alkylene) derivative structural unit;
m1, m2, and m6 are each independently 0, 1, 2, 3, 4, 5, 6, 7, 8, 9, 10, 11 or 12;
m3, m4, m5, and m7 are each independently 0, 1, 2, 3, or 4;
R₃₅, R₃₆, R₃₇, R₄₀, R₄₁, R₄₂, and R₄₃ are each independently alkylene, arylene, alkenylene, alkynylene, ether, thioether, keto, amino, ammonium, or piperidinyl, and the alkylene, arylene, alkenylene or alkynylene are optionally substituted with halide;
R₃₈ is halide, mesylate, tosylate, azide, alkenyl, alkynyl and R₃₉ is an amine, a phosphine, thiol, hydroxyl, alkenyl or alkynyl; or R₃₈ is an amine, a phosphine, thiol, hydroxyl, alkenyl or alkynyl and R₃₉ is halide, mesylate, tosylate, azide, alkenyl, or alkynyl;
R₄₄ is —NH₂, —NHR₄₅, —NR₄₅R₄₆, —N—O, —N—S or a nitrogen-containing heterocycle wherein a nitrogen of the heterocycle has an oxygen, sulfur or hydrogen substituent; and
R₄₅ and R₄₆ are each independently alkyl, alkenyl, alkynyl or aryl, and the alkyl, alkenyl, alkynyl or aryl are optionally substituted with halide.

28.-34. (canceled)

35. A polymer for providing enhanced oxidative resistance, the polymer comprising a product of a mixture comprising:
(i) a polymer having a backbone including a nitrogen-containing heterocyclic ring or a nitrogen-containing heterocyclic ring attached to aryl or a heterocycle; or
a polymer comprising at least two of structural units of Formulae (3A), (6A), (7A), (8A) and (9A) having the formulae: 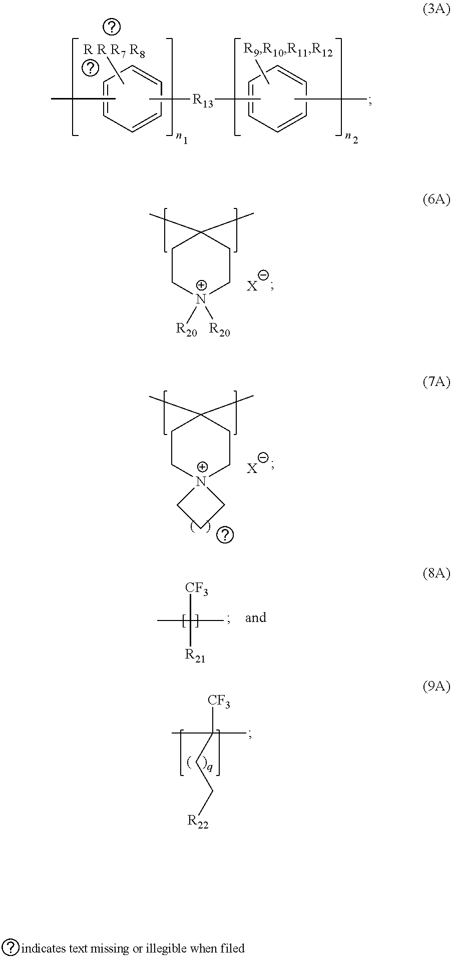
and
(ii) an ORG-containing compound having the formula (12): 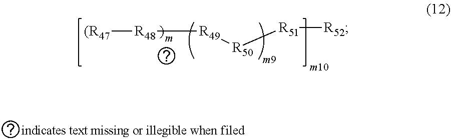
wherein
m is 0, 1, 2, 4, 5, 6, 7, 8, 9, or 10;
m8 and m10 are each independently 0, 1, 2, 3, or 4;
m9 is each independently 0, 1, 2, 3, 4, 5, 6, 7, 8, 9, 10, 11 or 12;
n is 1, 2, 3, 4, 5, 6, 7 or 8;
n₁ is 1, 2, 3, or 4;
n₂ is 0, 1, 2, 3 or 4;
n3 and n5 are each independently 1, 2, 3, 4, 5, 6, 7, 8, 9 or 10;
n4 is 0, 1, 2, 3, 4, 5, 6, 7, 8, 9 or 10;
q is 0, 1, 2, 3, 4, 5, 6, 7, 8, 9, 10, 11, 12, 13, 14, 15, 16, 17, 18, 19, or 20;
Q is N or P;
R₅, R₆, R₇, R₈, R₉, R₁₀, R₁₁, and R₁₂ are each independently hydrogen, halide, alkyl, alkenyl, alkynyl or aryl, and the alkyl, alkenyl, alkynyl or aryl are optionally substituted with halide, and wherein R₆ and R₉ are optionally linked to form a five membered ring optionally substituted with halide or alkyl;
R₁₃ is absent or is alkylene, alkenylene, alkynylene, or arylene, and the alkylene, alkenylene, alkynylene, or arylene are optionally substituted with halide;
each R₂₀ is independently hydrogen, hydroxyl, halide, alkyl, alkenyl, alkynyl or aryl, and the alkyl, alkenyl, alkynyl or aryl are optionally substituted with halide;
each R₂₁ is independently alkyl, alkenyl, or alkynyl, or a substituent of formula (8A-1): 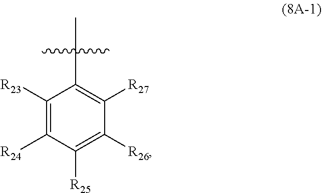
and the alkyl, alkenyl, or alkynyl are optionally substituted with halide;
R₂₂ is a halide, or a quaternary ammonium or phosphonium group or a nitrogen-containing heterocyclic group or a salt thereof, the quaternary ammonium or phosphonium group having the formula (9A-1): 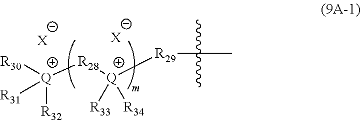
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₃, R₂₄, R₂₅, R₂₆, and R₂₇ are each independently hydrogen, halide, alkyl, alkenyl, alkynyl or aryl, and the alkyl, alkenyl, alkynyl or aryl are optionally substituted with halide;
R₂₈ and R₂₉ are each independently alkylene;
R₃₀, R₃₁, R₃₂, R₃₃, and R₃₄ are each independently alkyl, alkenyl, or alkynyl;
R₄₇ is halide, mesylate, tosylate, azide, alkenyl, or alkynyl;
R₄₈, R₄₉, R₅₀, and R₅₁ are each independently alkylene, arylene, alkenylene, alkynylene, ether, thioether, keto, amino, ammonium, or piperidinyl, and the alkylene, arylene, alkenylene or alkynylene are optionally substituted with halide;
R₅₂ is —NH₂, —NHR₅₃, —NR₅₃R₅₄, —N—O, —N—S or a nitrogen-containing heterocycle wherein a nitrogen of the heterocycle has an oxygen, sulfur or hydrogen substituent;
R₅₃ and R₅₄ are each independently alkyl, alkenyl, alkynyl or aryl, and the alkyl, alkenyl, alkynyl or aryl are optionally substituted with halide; and
X⁻ is an anion.

36. An anion exchange polymer comprising a reaction product of an alkylating agent and the polymer of claim 1.

37. An anion exchange polymer comprising a reaction product of an amine and the polymer of claim 1.

38. An anion exchange polymer comprising a reaction product of a base and the polymer of claim 1.

39. The polymer of claim 38, wherein the base comprises a hydroxide-. bicarbonate-, or carbonate-containing base.

40. The polymer of claim 39, wherein the hydroxide-containing base comprises sodium hydroxide or potassium hydroxide; the bicarbonate-containing base comprises sodium bicarbonate or potassium bicarbonate; or the carbonate-containing base comprises sodium carbonate or potassium carbonate.

41.-51. (canceled)

52. A polymer for providing enhanced oxidative resistance, the polymer comprising structural units of Formulae (6A_{ORG}) and (3A): 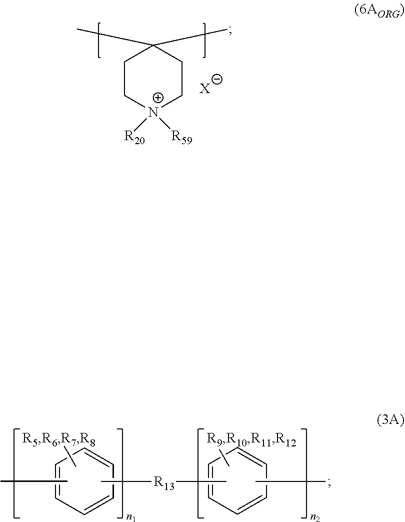
wherein:
n₁ is 1, 2, 3, or 4;
n₂ is 0, 1, 2, 3 or 4;
n3 and n5 are each independently 1, 2, 3, 4, 5, 6, 7, 8, 9, or 10;
n4 is 0, 1, 2, 3, 4, 5, 6, 7, 8, 9 or 10;
Q is N or P;
R₅, R₆, R₇, R₈, R₉, R₁₀, R₁₁, and R₁₂ are each independently hydrogen, halide, alkyl, alkenyl, alkynyl or aryl, and the alkyl, alkenyl, alkynyl or aryl are optionally substituted with halide, and wherein R₆ and R₉ are optionally linked to form a five membered ring optionally substituted with halide or alkyl;
R₁₃ are each independently alkylene, alkenylene, alkynylene, or arylene, and the alkylene, alkenylene, alkynylene, or arylene are optionally substituted with halide, or R₁₃ is absent.
each R₂₀ is independently hydrogen, hydroxyl, halide, alkyl, alkenyl, alkynyl or aryl, and the alkyl, alkenyl, alkynyl or aryl are optionally substituted with halide;
R₅₉ is —(CH₂)ₙ₃-[Q(R₆₀)(R₆₁)—(CH₂)ₙ₄]ₙ₅-R₆₂ or —[(CH₂)ₙ₃—O]ₙ₅-R₆₂;
R₆₀ and R₆₁ are each independently alkyl, alkenyl or alkynyl;
R₆₂ is a nitrogen-containing heterocycle wherein a nitrogen of the heterocycle has an oxygen, sulfur or hydrogen substituent; and
X⁻ is an anion.
